(19) United States
(12) Patent Application Publication
(10) Pub. No.: US 2019/0268317 A1
(43) Pub. Date: Aug. 29, 2019

(54) Cyber Security System

(71) Applicant: Cyber 2.0 (2015) LTD., Tel Aviv (IL)

(72) Inventor: Erez Kaplan Haelion, Rehovot (IL)

(21) Appl. No.: 16/396,714

(22) Filed: Apr. 28, 2019

Related U.S. Application Data
(63) Continuation-in-part of application No. 15/800,965, filed on Nov. 1, 2017, now Pat. No. 10,313,318.
Application No. 15/800,965 is a continuation of application No. 15/304,052, filed on Oct. 13, 2016, now Pat. No. 9,838,368.
Application No. 15/304,052 is a continuation-in-part of application No. 15/980,719, filed on May 15, 2018, now Pat. No. 10,333,956.
Application No. 15/980,719 is a continuation of application No. 15/705,215, filed on Sep. 14, 2017, now Pat. No. 9,985,981.
Application No. 15/705,215 is a continuation of application No. 15/390,755, filed on Dec. 27, 2016, now Pat. No. 9,794,277.
Application No. 15/390,755 is a continuation-in-part of application No. 15/445,930, filed on Feb. 28, 2017.
Application No. 15/445,930 is a continuation-in-part of application No. 16/042,505, filed on Jul. 23, 2018.
Application No. 16/042,505 is a continuation-in-part of application No. 15/464,403, filed on Mar. 21, 2017.
Application No. 15/464,403 is a continuation-in-part of application No. 15/707,866, filed on Sep. 18, 2017.
Application No. 15/707,866 is a continuation-in-part of application No. 15/937,380, filed on Mar. 27, 2018.
Application No. 15/937,380 is a continuation-in-part of application No. 15/396,177, filed on Dec. 30, 2016.
(60) Provisional application No. 62/273,530, filed on Dec. 31, 2015.
(60) Provisional application No. 62/273,499, filed on Dec. 31, 2015.

(51) Int. Cl. H04L 29/06

(52) U.S. Cl. CPC H04L 63/061; H04L 63/0435; H04L 63/0407; H04L 63/145; H04L 63/068

(57) ABSTRACT

System, product and method for connectivity-based scrambling is disclosed. Port scrambling mode is selected based on connectivity to a network. In one mode, ports of authorized outgoing communications are scrambled, while ports of unauthorized outgoing communications remain unscrambled. In another mode, ports of unauthorized outgoing communications are scrambled, while ports of authorized outgoing communications remain unscrambled. In some cases, under the first mode, ports of all incoming communications are descrambled, while in the second mode, ports of all incoming communications remain unscrambled.

### CROSS-REFERENCE TO RELATED APPLICATION

This application is a continuation-in-part application and claims the benefit of U.S. patent application Ser. No. 15/800,965 filed Nov. 1, 2017, entitled “PORT SCRAMBLING FOR COMPUTER NETWORKS” which is a continuation of and claims the benefit of U.S. patent application Ser. No. 15/304,052, filed Oct. 13, 2016, now U.S. Pat. No. 9,838,368 which is a National Stage Entry of PCT Application No. PCT/IL2016/050931, filed Aug. 25, 2016, entitled “PORT SCRAMBLING FOR COMPUTER NETWORKS”; U.S. patent application Ser. No. 15/980,719 filed May 15, 2018, entitled “DETECTION OF INVALID PORT ACCESSES IN PORT-SCRAMBLING-BASED NETWORKS” which is a continuation of and claims the benefit of U.S. patent application Ser. No. 15/705,215, now U.S. Pat. No. 9,985,981, filed Sep. 14, 2017, which is a continuation of U.S. patent application Ser. No. 15/390,755, now U.S. Pat. No. 9,794,277, filed Dec. 27, 2016, which is a non-provisional of U.S. Provisional Application No. 62/273,530 filed Dec. 31, 2015, entitled “MONITORING TRAFFIC IN A COMPUTER NETWORK”; U.S. patent application Ser. No. 15/396,717 filed Jan. 2, 2017, entitled “INCREMENTALLY POLYMORPHING CODE FOR ENHANCED RESISTANCE TO REVERSE ENGINEERING” which is claims the benefit of U.S. Provisional Application No. 62/273,499 filed Dec. 31, 2015, entitled “SELF POLYMORPHING EVOLVING CODE TECHNOLOGY ENHANCED RESISTANCE”; U.S. patent application Ser. No. 15/445,930 filed Feb. 11, 2017, entitled “PORT-SCRAMBLING-BASED NETWORKS”; U.S. patent application Ser. No. 16/042,505 filed Jul. 23, 2018, entitled “PORT SCRAMBLING USAGE IN HETEROGENEOUS NETWORKS”; U.S. patent application Ser. No. 15/464,403 filed Mar. 21, 2017, entitled “PREVENTING UNAUTHORIZED OUTGOING COMMUNICATIONS”; U.S. patent application Ser. No. 15/707,866 filed Sep. 18, 2017, entitled “AUTOMATIC SECURITY CONFIGURATION”; and U.S. patent application Ser. No. 15/937,380 filed Mar. 27, 2018, entitled “CONNECTIVITY-BASED PORT SCRAMBLING” all of which are hereby incorporated by reference in its entirety without giving rise to disavowment.

### TECHNICAL FIELD

The present disclosure relates to computer network security in general, and to port scrambling based security, in particular.

### BACKGROUND

Computer networks are prevalent among many enterprises and organizations. Typically, a network environment comprises a plurality of computerized devices interconnected to one another and sharing resources, such as, for example, through common access to one or more servers connected to the network. In many cases, some or even all of the devices in the network environment are simultaneously connected also to one or more external networks, such as the World Wide Web. As a result, any of the devices in the internal network environment are made much more susceptible to various security threats and attacks, in particular the proliferation of self-propagating malicious codes, also commonly known as “viruses” or “worms”. Once a device in the network becomes compromised, the infection can spread quickly to the remaining devices, causing irreparable harm.

The Bring Your Own Device (BYOD) policy has become widespread among organizations. Under the BYOD policy, employees bring personally owned devices, such as laptops, tablets, smart phones, and the like, to their workplace and use such privately-owned devices to access privileged company information and applications. Under BYOD, the same device is used in different settings—the organizational one and in private settings, such as in the home of the employee.

### BRIEF SUMMARY

One exemplary embodiment of the disclosed subject matter is a computer program product comprising a non-transitory computer readable medium retaining program instructions, wherein said computer program product comprising: a connectivity module configured to determine connectivity of a computer executing the computer program product to a network managed by a server; a port scrambling mode selector configured to select a port scrambling mode based on connectivity determination by said connectivity module, wherein a first mode is selected in response being connected to the network, wherein a second mode is selected in response to being disconnected from the network; a port scrambler configured to compute a second port based on a first port, wherein the port scrambler utilizes a transformation function; an outgoing communication message handler configured to identify an outgoing packet transmitted by a program via the first port and selectively invoke said port scrambler to cause the outgoing packet to be transmitted via the second port, wherein in the first mode, said outgoing communication message handler is configured to invoke said port scrambler in response to the program being listed in a list of authorized programs, whereby, when the computer is connected to the network, outgoing communications issued by authorized programs are sent via scrambled ports and outgoing communications issued by non-authorized programs are sent via original ports; and wherein in the second mode, said outgoing communication message handler is configured to invoke said port scrambler in response to the program not being listed in the list of authorized programs, whereby, when the computer is not connected to the network, outgoing communications issued by authorized programs are sent via original ports and outgoing communications issued by non-authorized programs are sent via scrambled ports.

Optionally, the network comprises a plurality of computers, wherein each of the plurality of computer retains a shared secret parameter that is used by the transformation function in the first mode, wherein each of the plurality of computers is configured to apply an inverse of the transformation function on the second port and using the shared secret parameter, to obtain the first port.

Optionally, the network comprises a plurality of computers, wherein the plurality of computers comprise a first portion and a second portion, wherein the first portion is configured to permanently operate in the first mode, wherein the second portion is configured to operate in the first mode in response to detecting connectivity to the network.

Optionally, the list of authorized programs is received from the server.

Optionally, the network is an organizational network, wherein the list of authorized programs is an implementation of organizational policy, whereby enforcing the organizational policy when the computer is connected to the organizational network in a first manner and enforcing the organizational policy when the computer is connected to another network in a second manner.

Optionally, the computer is a mobile computer configured to be alternately utilized within an organizational network and within a home network, wherein the network is the organizational network, wherein said port scrambling mode selector is configured to select the first mode when the computer is connected to the organizational network, wherein said port scrambling mode selector is configured to select the second mode when the computer is connected to the home network.

Optionally, said port scrambler is configured to apply the transformation function using an encryption key distributed by the server, wherein the encryption key is modified periodically and distributed to devices connected to the network, whereby port scrambling in the first mode is performed using an up-to-date encryption key, whereby port scrambling in the second mode is performed using a potentially out-of-date encryption key.

Optionally, the server is configured to maintain the list and update computers connected to the network.

Optionally, the computer program product may comprise a port descrambler configured to compute a fourth port based on a third port, wherein the port descrambling module utilizes an inverse transformation of the transformation function.

Optionally, the computer program product may comprise an incoming communication message handler configured to identify an incoming packet received via the third port.

Optionally, in the first mode, said incoming communication message handler is configured to invoke said port descrambler to cause the incoming packet to be handled through the third port, whereby, when the computer is connected to the network, incoming communications are received via descrambled ports.

Optionally, wherein in the second mode, said incoming communication message handler is configured to avoid invoking said port descrambler, whereby, when the computer is not connected to the network, incoming communications are received via their original ports.

One exemplary embodiment of the disclosed subject matter is a computer program product comprising a non-transitory computer readable medium retaining program instructions, wherein said computer program product comprising: a connectivity module configured to determine connectivity of a computer executing the computer program product to a network managed by a server; a port scrambling mode selector configured to select a port scrambling mode based on connectivity determination by said connectivity module, wherein a first mode is selected in response being connected to the network, wherein a second mode is selected in response to being disconnected from the network; a port descrambler configured to compute a first port based on a second port, wherein the port descrambler utilizes an inverse transformation of a transformation function, wherein the transformation function is utilized by port scramblers invoked on computers connected to the network; an incoming communication message handler configured to identify an incoming packet received via the second port and selectively invoke said port descrambler, based on the port scrambling mode determined by said port scrambling mode selector, to cause the incoming packet to be handled via the first port, wherein said incoming communication message handler is configured to invoke said port descrambler in the first mode, whereby, when the computer is connected to the network, incoming communications are handled via descrambled ports; and wherein said incoming communication message handler is configured to avoid invocation of said port descrambler in the second mode, whereby, when the computer is disconnected from the network, incoming communications are handler via original ports.

Optionally, a plurality of computers that are connected to the network are configured to scramble ports of authorized communication packets and avoid scrambling ports of unauthorized communication packets, wherein the plurality of computers are configured to scramble ports using the transformation function.

Optionally, the plurality of computers are configured to scramble the ports using the transformation function and based on a list of authorized programs, wherein said port descrambler is configured to utilize the list of authorized program when applying the inverse transformation.

Optionally, the plurality of computers are configured to scramble the ports using the transformation function, based on a list of authorized programs and based on a shared encryption key that is modified periodically, wherein the computer is configured to retrieve the shared encryption key from the network when connected thereto.

Optionally, the server is configured to distribute the shared encryption key to devices connected to the network.

Yet another exemplary embodiment of the disclosed subject matter is a system comprising: a server managing a network; a plurality of devices that are connected to the network, wherein each of the plurality of devices comprise a port scrambling agent, wherein the port scrambling agent is configured to scramble ports of outgoing communications that are transmitted by authorized programs, wherein the port scrambling agent is configured to descramble ports of incoming communications; a computer that is selectively connectable to the network; wherein the computer comprising a mode-based port scrambling agent, wherein the mode-based port scrambling agent is configured to determine a port scrambling mode based on connectivity to the network, wherein said mode-based port scrambling agent is configured to determine a first mode when the computer is connected to the network, wherein said mode-based port scrambling agent is configured to determine a second mode when the computer is disconnected from the network; wherein in the first mode, the mode-based port scrambling agent is configured to: (1) scramble ports of outgoing communications that are transmitted by authorized programs, (2) allow transmission of outgoing communications by unauthorized programs via original ports, and (3) descramble ports of incoming communications; and wherein in the second mode, the mode-based port scrambling agent is configured to: (1) scramble ports of outgoing communications that are transmitted by unauthorized programs; (2) allow transmission of outgoing communications by authorized programs via original ports; and (3) avoid descrambling ports of incoming communications.

Optionally, said mode-based port scrambling agent is configured to determine network connectivity based on connectivity to the server.

Optionally, the server is configured to periodically distribute a shared encryption key to devices connected to the network, wherein said port scrambling agents and mode-based port scrambling agent are configured to utilize the shared encryption key in performing scrambling or descrambling of ports, whereby the mode-based port scrambling agent may not have available thereto an up-to-date shared encryption key when disconnected from the network.

Optionally, the server is configured to distribute a list of authorized programs, whereby organization policy of authorized programs is enforced on mobile devices that are operated when connected to other networks.

Optionally, said port scrambling agents and mode-based port scrambling agent are configured to utilize the list of authorized programs when scrambling or descrambling ports.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a computer network in which the disclosed subject matter is used, in accordance with some exemplary embodiments of the subject matter;

FIG. 2 shows a block diagram of a system, in accordance with some exemplary embodiments of the disclosed subject matter;

FIGS. 3A and 3B show flowchart diagrams of a method, in accordance with some exemplary embodiments of the disclosed subject matter;

FIG. 4 shows a computer network in which the disclosed subject matter is used, in accordance with some exemplary embodiments of the subject matter;

FIG. 5 shows a block diagram of a system, in accordance with some exemplary embodiments of the disclosed subject matter;

FIGS. 6A and 6B show flowchart diagrams of a method, in accordance with some exemplary embodiments of the disclosed subject matter

FIG. 7 shows a flowchart diagram of a method, in accordance with some exemplary embodiments of the disclosed subject matter;

FIG. 8A-8C show flowchart diagrams of a method, in accordance with some exemplary embodiments of the disclosed subject matter;

FIG. 9 shows a block diagram of an apparatus comprised in a computerized environment schematically illustrated, in accordance with some exemplary embodiments of the disclosed subject matter;

FIG. 10 shows a flowchart diagram schematically illustrating operating mode and principles of utilizing the disclosed subject matter to frustrate hacking attempts, in accordance with some exemplary embodiments of the disclosed subject matter;

FIGS. 11A and 11B show computerized environments in which the disclosed subject matter is used, in accordance with some exemplary embodiments of the subject matter;

FIG. 12 shows a block diagram of a computing device, in accordance with some exemplary embodiments of the disclosed subject matter;

FIGS. 13A and 13B show flowchart diagrams of methods, in accordance with some exemplary embodiments of the disclosed subject matter;

FIG. 14A shows a schematic illustration of a computer network, in accordance with some exemplary embodiments of the subject matter;

FIG. 14B shows a schematic illustration of a computer network in which the disclosed subject matter is used, in accordance with some exemplary embodiments of the subject matter;

FIGS. 15A-15B show block diagrams of systems, in accordance with some exemplary embodiments of the disclosed subject matter;

FIGS. 16A-16B show flowchart diagrams of methods, in accordance with some exemplary embodiments of the disclosed subject matter;

FIGS. 17A-17B show schematic illustrations of graphs, in accordance with some exemplary embodiments of the disclosed subject matter

FIGS. 18A-18C show flowchart diagrams of a method, in accordance with some exemplary embodiments of the disclosed subject matter;

FIG. 19 shows a block diagram of an apparatus, in accordance with some exemplary embodiments of the disclosed subject matter;

FIG. 20 shows a schematic illustration of an organizational network, in accordance with some exemplary embodiments of the disclosed subject matter;

FIGS. 21A-21D show flowchart diagrams of methods, in accordance with some exemplary embodiments of the disclosed subject matter;

FIG. 22 shows a flowchart diagram of a method, in accordance with some exemplary embodiments of the disclosed subject matter;

FIG. 23 shows a block diagram of an apparatus, in accordance with some exemplary embodiments of the disclosed subject matter;

FIG. 24A shows a computer network in which the disclosed subject matter is used, in accordance with some exemplary embodiments of the subject matter;

FIG. 24B shows a computer network in which the disclosed subject matter is used, in accordance with some exemplary embodiments of the subject matter;

FIGS. 25A-25C show block diagrams of systems, in accordance with some exemplary embodiments of the disclosed subject matter; and

FIGS. 26A and 26B show flowchart diagrams of a method, in accordance with some exemplary embodiments of the disclosed subject matter.

### DETAILED DESCRIPTION

One technical problem dealt with by the disclosed subject matter is to provide for secure communication in a computer network.

Another technical problem dealt with by the disclosed subject matter is to prevent spreading of malicious code within a computer network.

Yet another technical problem is to detect malicious activity within a computer network.

A “port” is a logical construct associated with a service or process residing on a computing platform and serves as an endpoint for different types of network communication. In some exemplary embodiments, a port is identified for each host address and communication protocol by a 16-bit number, thus a port number ranges from 0 to 65535. Generally, port numbers appear in network packets and map to specific processes or resources on the destination device that can handle or are expecting those packets. Some resources are preconfigured to listen to only certain predefined port numbers and ignore traffic associated with other ports. Typical network protocols that heavily rely on port numbers to map to resources include Transmission Control Protocol (TCP) and User Datagram Protocol (UDP). Some port numbers or port number ranges may be reserved for standard services, such as the “well-known ports” ranging from 0 to 1023 used by TCP and UDP. For example, services running the Hypertext Transfer Protocol (HTTP) protocol typically listen on port 80.

One technical solution is to selectively scramble port numbers towards which outgoing communications are directed at the transmitting end and descramble port numbers at which incoming communications are received. The scrambling is performed only for port numbers associated with approved application programs. The scrambling and descrambling are performed using one or more secret parameters shared among the network devices. The one or more secret parameters preferably include a time-varying component to decrease likelihood of an attacker “guessing” the target port number by port scanning.

In some exemplary embodiments, a server may monitor traffic within the network to detect traffic for which ports are not scrambled. Such traffic may be generated by software components that are not authorized and are potentially malicious. The server may monitor such traffic, analyze it and determine whether the activity is malicious or not.

One technical effect of utilizing the disclosed subject matter is to allow detection of attacks or outbreaks by identifying access attempts at regular port numbers. Furthermore, attempts to access ports that are not a scrambled version of any useful ports may also be indicative of potential unauthorized activity as authorized activity is constrained to be directed solely at scrambled ports.

Another technical effect is to prevent outspread of malicious activity that relies on human engineering. Even in case a human user is manipulated to allow access to a malicious user or code (e.g., pressing a harmful link or executing a malware sent via e-mail), malicious activity is likely to be contained in the infected device and not be spread to other devices.

Yet another technical problem dealt with by the disclosed subject matter is to provide for enhanced protection against reverse engineering of computing platforms, computer programs, network communication protocols, algorithms, or likewise computing resources, reverse engineering thereof is likely to be performed for malicious purposes.

Yet another technical solution is to use an incremental modification technique for updating computer program code or other similar computing resource used thereby for processing, whereby allowing for specific segments of the code to polymorph and evolve in order to prevent reverse code engineering from working effectively. In some exemplary embodiments, instances of the program may be in communication with one another in a secure manner, such as by performing port scrambling during communication, using encrypted communication, or the like. Such secure communication may rely on the instances utilizing a shared algorithm (e.g., for scrambling/descrambling, encrypting/decrypting, or the like). A central server may periodically send random changes to the shared algorithm. The changes may indicate a modification to the algorithm (and not a replacement version). The modification may not be merely semantic or related to control flow but rather may provide for a different computed output. For example, if the algorithm requires a computation of a formula, the formula may be changed by adding a constant value, by subtracting a constant value, by multiplying the value by a constant, by exponentiation of the value by a constant, by dividing or taking a modulus of the formula by a constant, or the like. In some exemplary embodiments, the change may be a random change so as not to be foreseen. Potentially, different instances of the system may create a different version of the algorithm in view of the random changes thereto. In some further exemplary embodiments, the change may be performed periodically within a time period that is considered as too short to allow a hacker to reverse engineer the software during it, such as, for example, at every hour, every four hours, every day, or the like.

Yet another technical effect of utilizing the disclosed subject matter is to prevent from a hacked version of an algorithm from being effectively used, such that, in case that reverse engineering is applied and the algorithm is extracted—it will not work on the protected system—since it is potentially already changed. If an attacker tries to listen and capture the changes in the algorithm, such attacker will only receive the deltas sent to the algorithm, and since the original algorithm the attacker employs is not the shared (modified) algorithm—the attacker will still remain with the wrong algorithm that is incompatible with the other instances in the system.

Yet another technical problem dealt with by the disclosed subject matter is protecting databases from reverse engineering. It will be appreciated that in order to inject false data or receive data from a database, an assailant needs to know in advance the structure of the database before the attack.

Yet another technical solution in accordance with the disclosed subject matter is that a central server periodically sends changes to the order, structure and/or name of the fields in a database tables. In some cases, some changes may create or destroy dummy fields in the database tables, change ordering of these fields, names of these fields, or the like. Based on the modification of the database, access commands within the application may also be modified according to the changes made.

Yet another technical effect of utilizing the disclosed subject matter, similarly as above, is that if a reverse engineering procedure is applied and the database structure is extracted—it will not work on the protected system—since it was changed in the meantime. If an attacker tries to listen and capture the changes in the database, he will only receive the delta in the current structure and not the correct structure—and he will still remain with the wrong access string to the database.

In some exemplary embodiments, the database may be updated periodically to only some of the instances of the software, such as based on geographical location, organizational association, locale information, IP or information of the device executing the instance, demographic information of the user, or the like. Additionally or alternatively, the instances may be sorted into groups and each group may be updated together and independently of the other groups. In some exemplary embodiments, a group may be determined based on a random or a pseudo-random characterization of the instance, such as an id. As a result, successful hacking to one instance of the group may not be useful to exploit or target an instance of another group.

In some exemplary embodiments, the database may be updated based on a determination of the instance itself and without relying on an instruction from a server. In case the instance updates itself independently there may not be a need to a central mechanism for synchronizing the update instructions.

Yet another technical problem dealt with by the disclosed subject matter is to provide a counter measure against reverse engineering of any arbitrary software entity at hand, e.g. an application program.

Yet another technical solution in accordance with the disclosed subject matter is that a central server periodically sends changes to a given structure of various code blocks in the application program. In some exemplary embodiments, one or more keys may be introduced into different locations within the program code, preferably selected at random. Based on randomized deltas given from the server, the one or more keys may change their locations. Additionally or alternatively, the keys themselves may be changed using deltas received from the server. The application program may be configured to check whether the keys embedded therein in the aforesaid manner are valid keys, e.g. by computing a checksum, hash, or likewise function thereof, and comparing the result to a value that may be provided by the server, preferably in an online manner, such as in a challenge-response testing. The check may be performed either continuously or prior to predetermined sections, e.g. read/write operations, sections where confidential data is obtainable, sections where network communication is performed, or the like. In some exemplary embodiments, a key checker function used in performing the check may employ a formula, which may in itself be subjected to periodic updates using delta changes supplied by the server. It will be appreciated that in some exemplary embodiments the application program may have to be subject to a pre-processing step, such as a re-design, code wrapping or decorating, or any likewise code functionality enhancement mechanism, in order to utilize, and benefit from, the disclosed subject matter and additional security layer whereby provided.

Yet another technical effect of utilizing the disclosed subject matter, similarly as above, is that if a reverse engineering or hacking attempt is made and the application program is thereby compromised—a hacked instance of the application program will stop working—since the application program was changed and thus the hacked instance no longer matches it. If an attacker tries to listen and capture the changes, the attacker will only receive the delta in the current structure and not the correct structure—and therefore will not possess the correct verification to the application program for running it properly.

Yet another technical problem dealt with by the disclosed subject matter is to provide for communication within a sub-network of a computer network. In some exemplary embodiments, a portion of devices of the plurality of devices comprised by the computer network may desire to communicate as a sub-network. In some exemplary embodiments, it may be desired to communicate within the sub-network without allowing a third party to listen in. For that, the portion of devices may be required to communicate in a way not susceptible to eavesdropping or interception.

In some exemplary embodiments, computer network may comprise a plurality of computerized devices interconnected to one another and sharing resources, such as, for example, through common access to one or more servers connected to the computer network. In many cases, some or even all of the devices in the computer network may be simultaneously connected also to one or more external networks, such as the World Wide Web. As a result, any of the devices in the computer network may be made much more susceptible to various security threats and attacks, in particular the proliferation of self-propagating malicious codes. Once a device in the computer network becomes compromised, the infection may be spread quickly to the remaining devices, causing potentially irreparable harm.

Yet another technical problem is to allow for the creation of ad-hoc sub-networks. The creation of the sub-network may be desired to be possible without requiring complex configurations. Additionally or alternatively, the sub-network may be dynamically updated by adding or removing computers thereof, migrating computers from one sub-network to another, or the like. In some exemplary embodiments, the creation of a sub-network similar to VLAN without requiring complex configurations may be desired. However, VLAN may prevent the computer to communicate with a computer outside the VLAN, while such a constraint may be undesirable.

Yet another technical solution is to scramble port identifiers towards which outgoing communications are directed at the transmitting end and descramble port numbers at the receiving ends in which the incoming communications are received.

In some exemplary embodiments, a certificate may be shared among the portion of devices of the sub-network. The scrambling and the descrambling may be performed correctly only by devices sharing the certificate. The certificate may preferably include a time-varying component to decrease likelihood of an attacker obtaining and reusing a certificate. In some exemplary embodiments, the time-varying component may be distributed by a server maintaining the sub-network or by another leader device. Additionally or alternatively, the certificate may be a static encryption key.

In some exemplary embodiments, the certificate may be generated based on user-provided credentials, such as a password. As a result, the certificate may be shared among different devices without the need to distribute the certificate over the network.

In some exemplary embodiments, the scrambling may be performed by applying a transformation function on an identifier of the port of an outgoing communication planned to be transmitted, to obtain an identifier of a scrambled port. The transformation function may depend on the certificate. On the other hand, the descrambling may be performed by applying a reverse transformation function on an identifier of the port of an incoming communication, to obtain an identifier of a descrambled port. The reverse transformation function may also depend on the certificate and may be a reverse function of the transformation function used for the scrambling. The device may transmit outgoing communications via the scrambled ports instead of the original ports and process incoming communications as if received via the descrambled ports instead of the original ports.

In case that a communication is transmitted from a source device to a destination device both sharing the same certificate, the source device may scramble the identifier of the original port towards which the communication is transmitted using the transformation function associated with the certificate; and transmit the communication via the scrambled port. While the destination source may descramble the identifier of the scrambled port at which the communication is received using the respective reverse transformation function, to obtain the original port and process the communication as if received via the original port. Accordingly, the source device and the destination device may be enable to correctly communicate.

In case that one of the source device or the destination device is not a member of the portion of devices desiring to securely communicate, and don not retain the certificate; the communication may not be correctly processed as it may be transmitted and/or processed via a scrambled port.

In some exemplary embodiments, scrambling and descrambling may be performed in a selective manner.

In some exemplary embodiments, the scrambling and the descrambling may not be performed on server communications. For example, communications to and from a Dynamic Host Configuration Protocol (DHCP) server may not be scrambled, so as to allow the DHCP server to manage the Internet Protocol (IP) addresses of computers both included in and excluded from the sub-network. As another example, a communication to and from an email server may not be scrambled, thereby allowing the sub-network devices to correctly communicate with the email server which is outside the sub-network, and serves computers that are both in and out of the sub-network.

Additionally or alternatively, the scrambling and the descrambling may not be performed for communications associated with approved application programs. Approved application programs may be configured to communicate with other devices outside the sub-network. For example, the approved application programs may be an Internet browser, an email client program, or the like. By avoiding scrambling, the applications are enabled to communicate correctly with devices outside the sub-network, such as a web server and an email server. In some exemplary embodiments, the determination whether or not to scramble the communication may be based directly on the identity of the issuing or receiving application and whether such application is an approved application program. Additionally or alternatively, the scrambling decision may be based indirectly on the identity of such applications, such as based on the relevant port in which the communication is received or through which the communication is transmitted.

In some exemplary embodiments, two devices that do not share the same certificate may be allowed to communicate nonetheless. In some exemplary embodiments, the communication therebetween may be performed without scrambling and descrambling the ports. Each of the two devices may retain the Internet Protocol (IP) address of the other device, and transmit or process communications associated with the IP address without scrambling or descrambling their ports. Additionally or alternatively, the two device may retain a second certificate indicating such a direct communication. The two device may transmit and process communication therebetween by respectively scrambling and descrambling the ports of the communications using the second certificate as a basis for the port scrambling and descrambling.

Yet another technical effect of utilizing the disclosed subject matter is to provide for a relatively efficient manner of creating a sub-network that has properties similar to a VLAN but does not share its disadvantages. In some exemplary embodiments, the sub-network in accordance with the disclosed subject matter is created ad-hoc without the need of any IT professional and potentially based on relatively simple configurations. Additionally or alternatively, the sub-network may be of devices in a same LAN or connected to different LANs which are connected to one another (e.g., via a WAN, via the Internet).

Yet another technical effect may be to provide for a selective port scrambling that allows a computer to continue functioning correctly in a network in which only a portion of the devices employ port scrambling.

Yet another technical effect may be enabling a single DHCP server to manage IP addresses of a network, where the network comprises portions of two or more sub-networks, each of which is based on a different port scrambling (e.g., port scrambling based on different certificates). Similarly, other servers are enabled to continue functioning correctly with respect to different sub-networks, and potentially with respect to devices that do not invoke any port scrambling.

Yet another technical effect may be to enable the use of port-scrambling without a central server and without distribution over the network of the shared certificate. As a result, the certificate may be less prone to be compromised.

Yet another technical problem dealt with by the disclosed subject matter is to allow for inclusion in a secured network of devices being either unable to or prohibited from executing third-party application programs, thus having software security solutions effectively unavailable for usage thereby. Various devices provided with network connectivity may have a limited functionality by design, due to being limited in size and/or energy supply, and as result thereof also having limited computing and storage resources. Such devices include, for example, many IoT appliances commercially available, wireless sensors, firewalls, and the like. Typically in those devices all operational logic is hard coded in their hardware or firmware and cannot be augmented by software installation or update. Additionally or alternatively, for some devices, due to critical nature of tasks or facilities entrusted therewith, it may be undesired to allow installation or running of application software thereon, even if there are no technical limitations precluding it. This may be the case, for example, in the case of OT devices and the like.

Yet another technical problem dealt with by the disclosed subject matter is to improve performance of security measures utilized in network communication, such as firewall devices or the like.

Secure communication in computer networks may be provided through use of port scrambling, such as disclosed in U.S. Pat. No. 9,838,368, entitled “PORT SCRAMBLING FOR COMPUTER NETWORKS”, issued on Dec. 5, 2017, which is hereby incorporated by reference in its entirety for all purposes without giving rise to disavowment. Port scrambling may be performed selectively for outgoing communications that are authorized, while port descrambling being performed for all ingoing communications. As a result, a descrambled port that did not originate from a scrambled, legitimate port assigned for authorized communications, is considered improper and communications received therein may be dropped without further processing and/or reported to a monitoring entity. However, a software agent implementing such port scrambling and descrambling techniques cannot be deployed on devices wherein general purpose processing is impossible or forbidden.

Yet another technical solution is to apply port scrambling on incoming communications directed towards a network of computerized devices in which secure communication is implemented by selectively scrambling ports of authorized communications being transmitted and descrambling ports of all communications received, and apply port descrambling on outgoing communications emanating from the network and directed to a destination outside of the network. Port scrambling of incoming communications and port descrambling of outgoing communications may be performed by a gateway apparatus being in connection with the network and to which one or more devices of a limited or restricted functionality may be connected. Each of the computerized devices of the network and the gateway apparatus may scramble and descramble ports by applying a transformation function and an inverse thereof, respectively. The transformation function and its inverse may utilize one or more shared parameters, which may be retained by the computerized devices of the network and the gateway apparatus, and which may comprise at least one secret parameter, such that mimicking the scrambling of ports by an attacker may be infeasible. The network may comprise a server, configured for distributing to devices of the network and the gateway apparatus the one or more shared parameters, which may be periodically replaced or updated so as to prevent discovery thereof by an attacker through reverse engineering of accumulated network traffic. The network may be configured to utilize a list of authorized programs for determining whether to perform port scrambling, which list may be utilized by the transformation function and inverse thereof as one of the shared parameters. The gateway apparatus may allow for any type of a limited or restricted functionality device, such as an IoT device, a firewall device, an OT device, or the like, to be connected thereto and thereby securely communicate with devices of the network. The network and the limited device may be comprised in a same local area network (LAN), such as an organizational network of a business enterprise or the like. The gateway apparatus may be a network bridge or likewise device adapted for analyzing a network communication and determining whether to forward or discard it according to its intended destination. The gateway apparatus may be configured to analyze communications either at a data link layer or at a network layer. In some exemplary embodiments, the limited device being connected to the gateway apparatus may be a firewall device being configured to drop communications directed at an improper port without further performing content analysis thereof, wherein the gateway apparatus may descramble ports of all outgoing communications, thus ports of unauthorized, potentially malicious communications that are not scrambled by the network are rendered as improper ports and, as a result, those potentially malicious communications may get discarded by the firewall device, whereby an overall amount of traffic and processing effort may be reduced. In some exemplary embodiments, the gateway apparatus may be utilized to connect the network with another network wherein port scrambling may not be employed, and allow for communication exchange between the two networks. The gateway apparatus may be further configured for performing security analysis of incoming communication directed to the network from the other network.

Yet another technical effect of utilizing the disclosed subject matter is to allow secure communication with a device having a limited or restricted functionality precluding it from executing a software agent for port scrambling. The device may be connected to a network of computerized devices that are not subject to such limitations or restrictions and exchange communications therewith, whereby an overall secure, heterogeneous network may be formed.

Yet another technical effect of utilizing the disclosed subject matter is to improve filtering of network traffic, by causing unauthorized outgoing communications to be directed at improper ports and get discarded as a result. In some exemplary embodiments, such discarding may be performed without analysis of the content of the outgoing communication and may increase the processing capacity of outgoing communications, such as the processing capacity of a firewall. In some cases, improved processing capacity of the firewall may increase effective bandwidth of the network, as the firewall may process each outgoing and incoming message. In some cases, the disclosed subject matter may improve the effective upload bandwidth to and/or the effective download bandwidth from the Internet or other external networks by about 50%, about 80%, about 100% or even higher.

Yet another technical effect of utilizing the disclosed subject matter is to allow communication between a first network secured by port scrambling and a second network using different security measures or none, without compromising or relinquishing security of the first network.

Yet another technical problem dealt with by the disclosed subject matter is to prevent unauthorized software entities from transmitting outgoing communications from within a computerized network. The outgoing communication may be directed to another computer within the same network or directed outside the network, such as outside a Local Area Network (LAN) and to a web-server connectable to the LAN via the Internet.

In some exemplary embodiments, the software entity transmitting the outgoing communication may be an authorized entity that is generally authorized to transmit outgoing communications. However, the transmitting software entity may be affected by other software entities or a cascade of software entities, that one or more of them may be malicious or unauthorized. The other software entities may affect the transmitting entity by performing a direct Inter-Process Communication (IPC) with the transmitting software entity, stimulating the transmitting software entity by invoking it directly, or the like. Additionally or alternatively, the other software entities may affect the transmitting software entity indirectly, such as by performing indirect IPC with the transmitting software entity (e.g. performing IPC with another software entity that affects the transmitting software entity, directly or indirectly).

In some exemplary embodiments, IPC may comprise programming interfaces that coordinate activities among different program processes that can run concurrently in an operating system. In some exemplary embodiments, software entities may use IPC to share data, communicate, invoking other process, or the like. IPC methods may include pipes, semaphores, shared memory, sockets, signals, invoking of Application Programming Interfaces (APIs) of processes, invoking functions in dynamically-loaded libraries or other dynamically-loadable code, or the like. In some exemplary embodiments, an invocation of a process by another process is also considered as an IPC. For example, if a first process invokes a second process, such as utilizes its API or causes the second process to be created and executed, the first process may be considered as performing an IPC with the second process. As an example, a first software entity may request data from a second software entity by an IPC; and the second software entity may respond to first software entity's request, by an additional IPC. As another example, processes on different computers on the same network may utilize sockets as a method of IPC. Sockets may be a data stream sent over a network interface, either to a different process on the same computer or to another computer on the network. As yet another example of IPC, a process may send messages to another process via a message queue.

In some exemplary embodiments, a malicious software entity may be unauthorized to transmit outgoing communications from within the computerized network. The malicious software entity may attempt to bypass this limitation by causing an authorized software entity to transmit an outgoing communication. The malicious software entity may influence the authorized software entity by accessing resources of the authorized software entity, sending a message to the authorized software entity, modifying parts of the memory of the authorized software entity, or the like. In some exemplary embodiments, the malicious software entity may perform IPC with the transmitting software entity directly to influence it to send an outgoing communication.

Additionally or alternatively, the malicious software entity may cause a chain of IPC communications between a plurality of software entities. At the end of the chain may be a transmitting software entity that is influenced to transmit an outgoing communication, as desired by the malicious software entity. It will be noted that malicious software entity may cause a transmission of a communication that otherwise would not have been transmitted. Additionally or alternatively, the malicious software entity may make use of an outgoing communication that was about to be sent regardless of the malicious software entity, by adding to its payload desired information, by modifying the payload and metadata of the outgoing communication, or using similar techniques.

Additionally or alternatively, a non-malicious software entity that is usually authorized to transmit outgoing communications, may be exploited by malicious parties to affect the (other) transmitting software entity and cause it to transmit a malicious communication. As an example, a macro-executing application may be exploited by a malicious party to execute a malicious macro. Executing the malicious macro may cause the macro-executing application to perform an IPC with a transmitting software entity and cause it to transmit an affected outgoing communication. The affected outgoing communication may be harmful to the computing device, the computer system, the network, or otherwise serve to purposes of malicious software entity and its owner.

Yet another technical solution is to prevent outgoing communications from being transmitted, if an unauthorized software entity has performed, directly or indirectly, an IPC with the software entity that transmitted the communication. In some exemplary embodiments, in response to an attempt to transmit an outgoing communication by a transmitting software entity, a list of software entities which have performed IPC, directly or indirectly, with the transmitting software entity may be obtained. The list may comprise each software entity that performed a direct IPC with the transmitting software entity or another software entity in the list. As a result, the list may comprise each software entity that had the potential to affect the transmitting software entity to cause it to transmit the outgoing communication. Each software entity in the list of software entities may be checked to determine if it is an unauthorized software entity. In case an unauthorized software entity is detected in the list of software entities, the outgoing communication may be blocked and prevented from being transmitted.

In some exemplary embodiments, IPC between software entities may be monitored. In some exemplary embodiments, each transfer of data among processes may be monitored. Non-limiting examples of monitored IPC may be files transferred between processes, messages sent from one process to another, commands transferred from one process to another, data streams, or the like. As another non-limiting example, Dynamic-Link Libraries (DLL) may be monitored. DLL may be a dynamically-loadable code that can be loaded on the fly and linked to another process to be used thereby. A DLL may be monitored by monitoring files with an extension of .dll, .ocx (for libraries containing ActiveX controls), .drv (for legacy system drivers), or the like. Loading and linking a DLL to a process may be considered as a form of bi-directional IPC. Similarly, invoking functions or methods in a DLL by another process is also considered a bi-directional IPC.

Additionally or alternatively, loading of processes executing the software entities may be monitored. Monitoring the loading of processes may comprise monitoring executable files loaded from files systems to a memory of the computing device, load requests to a server, or the like. Upon loading of a new process, IPCs associated with the newly loaded process may be monitored.

In some exemplary embodiments, the system may be monitored and a communication graph may be maintained. The communication graph may represent IPC communications between software entities in the system. The communication graph may be a directed graph. A node of the communication graph may represent a software entity. A directed edge in the communication graph connecting between a first node and a second node, may represent an IPC initiated by a first software entity represented by the first node towards a second software entity represented by the second node. The direction of the edge may indicate that the entity associated with the outgoing node had the potential to affect the entity associated with the incoming node.

In some exemplary embodiments, when a load of a process is detected, a node may be added to the communication graph. The node may represent the software entity executed by the newly loaded process. Additionally or alternatively, for each monitored IPC, an edge may be added to the communication graph, with the respective nodes, in case they do not already exist in the communication graph. The respective nodes may represent the two software entities that communicate by the IPC represented by the edge.

In some exemplary embodiments, the communication graph may be analyzed to obtain a list of software entities having the potential to affect a target software entity. In some exemplary embodiments, the target software entity is the transmitting software entity.

In some exemplary embodiments, in order to obtain the list, a Cone Of Influence (COI) may be determined from a node representing the transmitting software entity. The COI may comprise only nodes that have a path to the node representing the transmitting software entity (i.e. nodes representing software entities that have performed a direct or an indirect IPC with the transmitting software entity). The list may comprise each software entity associated with a node in the COI of the transmitting software entity. In some exemplary embodiments, the COI may be determined by performing a backward traversal of the graph starting from the node representing the transmitting software entity. The COI may be the subset of the nodes reachable by the backward traversal.

In some exemplary embodiments, each software entity in the list of software entities may be checked to determine authorization. In some exemplary embodiments, each software entity may be checked to determine whether is a member of an authorized programs list (e.g., white list). Additionally or alternatively, each software entity may be checked to determine whether is a member of an unauthorized programs list (e.g., black list). In some exemplary embodiments, other methods to determine authorization may exist, such as based on credentials of the software entity, based on the software entity comprising identifiable malicious code, based on similarity analysis between the examined software entity and known authorized or unauthorized entities, or the like.

It will be noted that the authorization property of a software entity may be relative to its position within the cascade of software entities that participate in or have the potential to affect. The same software entity may be considered authorized when transmitting the outgoing communication and unauthorized when influencing another transmitting software entity, or vice versa.

In some exemplary embodiments, the unauthorized programs list may comprise programs that are authorized to transmit outgoing communication, but are unauthorized to affect a transmitting software entity. As an example, consider an Internet browser, a Macro-executing application or similar interpreters configured to execute third-party code. In case the Internet browser executes malicious code, it may be configured to influence, directly or indirectly, another software entity and cause it to transmit an outgoing communication. As another example, a MICROSOFT™ WORD™ software entity may execute macros that may be defined by the document it loads. A macro attack may exploit vulnerabilities in the WORD™ software entity and cause the indirect transmittal of the outgoing communication. Hence, if such a software entity is identified in the list of software entities in the COI of the transmitting software entity, a potential attack may be identified and the outgoing communication may be blocked.

In case an unauthorized software entity is detected, the outgoing communication may be blocked and prevented from being transmitted. As a result, a potential malicious outgoing communication may be prevented. In some cases, however, false positive blockage is performed and non-malicious outgoing communication may be blocked. Additional analysis of the outgoing communication may be employed to ensure that the blocked outgoing communication is indeed malicious, such as deep inspection of the payload, or the like.

Yet another technical effect of utilizing the disclosed subject matter is to protect from malicious software entities that are executed within a computer in a network. By preventing the malicious software entity to transmit outgoing communications, its malicious activity may be partially or totally mitigated. For example, the malicious software entity may not be able to utilize vulnerabilities in other software entities executed in the computer to transmit communications on its behalf. The outgoing communications may be communications used for malicious data leak. In some exemplary embodiments, a malicious software entity may exploit the process of communication, to release confidential or private information to untrusted parties. Additionally or alternatively, the outgoing communication may be transmitted to a remote controlling device, such as operated by a malicious user, who can manually direct the malicious software entity. Additionally or alternatively, the outgoing communication may be transmitted to other devices within the network in order to infect new hosts.

Yet another technical effect of utilizing the disclosed subject matter is to protect from macro attacks that may be executed by authorized software entities, such as word processors, or other macro-executing applications. Similarly, runtime interpreters, such as Internet browsers, may also be protected against being exploited by third-party code.

Yet another technical problem dealt with by the disclosed subject matter is to automatically generate a security configuration for a system that is associated with an organization.

Security configuration are typically generated by a system administrator, such as an IT person, a sysadmin, or a person who is responsible for the upkeep, configuration, and reliable operation of devices within the system. The system administrator seeks to ensure that the uptime, performance, resources, and security of device in the system meet the needs of the users, without committing a security offence. To meet these needs, a system administrator may acquire, install, or upgrade computer components and software; provide routine automation; maintain security configurations; troubleshoot; train or supervise staff; or offer technical support for projects. However, configuring a system by a system administrator may a labor-intensive manual effort, which may be expensive and bug prone. In some cases, manual security configuration may require a substantial amount of time, such as weeks or months. In some cases, the security configuration may be required in order for a security solution, such as a firewall, an outgoing communication filter, an anti-virus program, or the like, may be activated and prevent potential cyber-related incidents in the organization.

Yet another technical problem is to deploy a security system that requires a list of predetermined authorized programs, without manually choosing the authorized programs. Some security systems, such as firewalls or filtering systems, may utilize whitelist of authorized programs that are allowed to transmit outgoing communications from a device or a network. Existing whitelists may be general and may comprise a large amount of irrelevant programs for the specific system. Manually choosing the authorized programs and compiling the whitelist from scratch may be a time consuming process. A long time may be required to objectively identify all authorized programs that may be executed in any of the devices of the organization. As the organization may have different types of users and devices, there may be a potentially large number of different use cases that may need to be manually explored and reviewed. Substantial amount of resources may be invested in such an investigation, postponing the date in which the configuration can be applied. Furthermore, as the manual task is time consuming, some manual handpicking of programs may be defunct by the time the configuration is applied. For example, consider a version of the web browser GOOGLE™ CHROME™ that is identified as a valid program that is allowed to transmit outgoing communications. By the time the configuration is applied, the identified version may no longer be available, may no longer be used, and may be replaced by another version that would also need to be included in the whitelist.

Yet, another technical problem dealt with by the disclosed subject matter is to deploy the security configuration over the system, in order to provide a configuration that prevents from security attacks.

In some exemplary embodiments, devices of the system may be connected to an organizational network associated with the organization. The security configuration may be required to be deployed over devices connected to the organizational network. The security configuration may comprise configurations associated with communications transmitted via the organizational network. Additionally or alternatively, the security configuration may be required to be adapted to each device connected to the organizational network based on requirements of the device.

Yet another technical solution is to automatically generate a local list of authorized programs in the organizational network. The local list is generated based on monitored communications. Devices in the organizational network are monitored to identify outgoing communications issued by programs executed thereby. The local list may be deployed over devices in the organizational network, such as a security configuration for a security-related tool that is activated in the organizational network. As an example, the local list may serve as a whitelist of a firewall of the organizational network. The firewall may utilize the whitelist to prevent unauthorized programs from transmitting communications outside the organizational network, thereby preventing potential data leaks and mitigating a risk of a malicious program exploiting vulnerabilities in the organizational network. Additionally or alternatively, the local list may be deployed on each device of the system when an outgoing communication filter is activated. The outgoing communication filter may be a software-based or hardware-based monitoring device that monitors each outgoing communication and prevents from unauthorized programs from sending outgoing communications. In some exemplary embodiments, the outgoing communication filter may be configured to process outgoing communications only of authorized programs, such as by employing port scrambling on authorized communications and not employing such scrambling on communications issued by unauthorized programs.

In some exemplary embodiments, the local list may comprise programs that are authorized to transmit outgoing communications. In some exemplary embodiments, the outgoing communication may be transmitted from a device within the organizational network. The outgoing communication may be a communication directed at another device, either within the organizational network or external thereto. The local list may be generated based on outgoing communications transmitted by programs executed within the organizational network. The local list may be retained within the organizational network, such as by a server connected to the organizational network, on each device in the organizational network having a whitelist-based security tool installed thereon, or the like.

In some exemplary embodiments, programs executed by each device within the organizational network may be monitored, to identify an attempt to transmit outgoing communications. When an attempt to transmit an outgoing communication is determined, the program attempting to transmit the outgoing communication may be checked to determine if it is authorized to transmit outgoing communications. The authorization of the program to transmit outgoing communications may be determined based on the program being listed in a base list of authorized programs. In response to the program being listed in the base list, the program may be added to the local list.

In some exemplary embodiments, the base list may be located external to the organizational network. The base list may comprise programs that are pre-determined to be authorized to transmit outgoing communications, based on the programs service providers, general configurations, rules and parameters defined by IT administrators, whitelists, blacklists, malicious signature identification methods, or the like. The base list may be pre-determined and may be a general list, such as including all known non-malicious programs, all versions thereof, or the like. The base list may not be particularly associated with a type of organization, and may include programs of different fields, such as word processing program, web browsers, an image editor, a video editor, a numeral computing program (e.g., MATLAB™), or the like. As can be appreciated, it is unlikely a law firm organization would authorize or use the video editor, while it is similarly unlikely that a movie studio would employ the numeral computing program, which may be typically used by research organizations.

In some exemplary embodiments, the generated local list may be a sub-set of the base list. The local list may comprise programs that are originally listed in the base list. In some exemplary embodiments, the local list may comprise programs that are generally authorized and are observed to be relevant to the organizational network.

In some exemplary embodiments, after the local list is generated, the local list may be transmitted to one or more devices within the organizational network.

In some exemplary embodiments, a system in accordance with the disclosed subject matter may be deployed in a passive learning mode. During a passive learning mode deployment, the local list may be generated based on outgoing communications transmitted from programs executed by devices in the organizational network. During the passive learning mode, no decisions may be made regarding blocking or transmitting the outgoing communications. In some exemplary embodiments, during passive learning mode, the security system may not be actively attempting to protect the organization, and it may solely focus on learning the behavior of the organization for the purpose of generating the local list.

In some exemplary embodiments, the system may be deployed in a passive learning mode over only a portion of the devices in the organizational network. Other devices in the organizational network may not be monitored, during the learning phase of the behavior of the organization. In some exemplary embodiments, the portion of the devices may be a representative sample of the devices of the organization, such as including different types of devices having different associated users. The local list may be generated based on monitored communications of programs executed by all the devices in the portion of the devices. Each program executed by a device of the portion of devices and attempting to transmit an outgoing communication may be checked if listed in the base list, and accordingly may be added to the local list. After the local list is fully generated, the system may be activated and enforce the local list-based security configuration on all the devices in the organizational network, and not just the portion which were monitored during the learning phase.

Additionally or alternatively, a system in accordance with the disclosed subject matter may be deployed in an active learning mode. During an active learning mode deployment, in addition to generating the local list based on monitored communications, the system may be active in attempting to mitigate security risks. In some exemplary embodiments, the system may selectively block the outgoing communications based on intermediate security configurations. In some exemplary embodiments, the selective blocking may be based on an intermediate version of the local list, as is currently available, or may be based on the base list, which is remotely accessible, potentially incurring substantive delay in accessing thereof.

In some exemplary embodiments, a determination that a program attempting to transmit an outgoing communication is not listed in the local list may be performed before checking whether the program is listed in the base list. In case the program is already listed in the local list, the outgoing communication may be allowed to be transmitted, and checking in the base list may be avoided. In some exemplary embodiments, there may be no need to update the local list, as the program is already determined to be listed therein. In case the program is not listed in the local list, it may be checked whether the program is listed in the base list. In case the program is listed in the base list, the outgoing communication may be allowed to be transmitted (e.g., not blocked). Additionally or alternatively, the program may be added to the local list. In case the program is not listed in the base list, the outgoing communication may be blocked, thereby mitigating the risk associated with allowing the transmission to be performed.

In some exemplary embodiments, in case the program is not listed in the local list, the outgoing communication may be initially blocked and the program may be prevented from transmitting the outgoing communication. The selective blockage may be based solely on the local list, which may be locally available, or at least not require a substantial delay in reaching thereof. After the outgoing communication is blocked, the base list may be examined to determine whether the base list includes the program. In case the program is listed in the base list, the local list may be then updated to contain the program. In some exemplary embodiments, after the program is initially forbidden from transmitting the outgoing communication, the program may attempt to transmit the outgoing communication again. Such may be the case, for example, if the blockage is implemented in a manner that indicates potentially temporary problem, such as a timeout, a network connectivity issue, or the like. Additionally or alternatively, the program may be configured to make several attempts to transmit the outgoing communication regardless to the reason the previous attempts were unsuccessful. If in the meantime, between the blockage of the first attempt and a next attempt, the local list is already updated to include the program, the outgoing communication may be allowed to be transmitted. In some exemplary embodiments, the repeated attempts may be performed within a relatively short time frame, such as within less than 100 milliseconds, 0.5 second, 2 seconds, or the like. The user of the device may therefore may be delayed for a relatively short time period and may be unaware of the initial security-based blockage and may practically not be affected by such blockage.

In some exemplary embodiments, the local list may be transmitted to one or more devices within the organizational network after being generated. A determination that generating of the local list is completed may be performed based on the local list not being updated for a number of successive attempts to transmit outgoing communications that is above a predetermined threshold, such as about 10 attempts, about 50 attempts, about 200 attempts, or the like. Additionally or alternatively, the stopping condition may be based on a number of attempts from each monitored device, which may be provided either in absolute numbers, relative number, a combination thereof, or the like. Additionally or alternatively, the stopping condition of the learning phase may be a predetermined amount of time elapsing from the last update of the local list, such as no update within about 12 hours, about 3 days, about one week, or the like. It may be noted that in some exemplary embodiments the local list may not be updated in response to an attempt to transmit an outgoing communications in two cases: the first, the program attempting to transmit the outgoing communication is already authorized and listed in the local list; the second, the program attempting to transmit the outgoing communication is not listed in the base list. Additionally or alternatively, a determination that generating of the local list is completed, may be performed based on a user input, such as an IT administrator input, based on reaching a threshold on the size of the local list, or the like.

In some exemplary embodiments, the local list may be utilized by a firewall device of the organizational network. The firewall device may be configured to monitor and control incoming and outgoing network traffic of the organizational network based on predetermined security rules associated with the local list. As an example, the firewall device may prevent programs that are not listed in the local list from passing any data packets from within the organizational network externally thereof.

Additionally or alternatively, the local list may be utilized by outgoing communication filters of one or more devices to perform selective blocking of outgoing communications of programs executed thereon. An outgoing communication filter of a device may be configured to block outgoing communication of programs executed by the device that are not listed in the local list.

Yet another technical effect of utilizing the disclosed subject matter is to leverage a pre-prepared base list of authorized programs to provide an organization-specific tailor list. The base list may be of a potential large volume, such as including gigabytes or even terabytes of information. The base list may include many programs, and different versions thereof. The base list may include for each executable of each version of each program, a signature, such as hash value, allowing for relatively secure validation integrity of an executed program against the base list. Much of the information retained in the base list may be irrelevant to the organization in which the security configuration is to be applied. Utilizing the generated local list is more efficient than the pre-prepared base list, as it may be smaller and may comprise only programs that are relevant for the organization. Program lookup in local list may be substantially faster than a corresponding lookup in the base list. Furthermore as the size of the local list may be considerably smaller, such as in kilobytes or few megabytes, it may be plausible to retain the local list in one or more devices. Furthermore, much of the bandwidth which may be required to download the base list to a local device within the organization is spared, as well as the storage space. Further still, the local list may be duplicated and retained in different devices, such as for example in each device being monitored. Since the local list is of significant smaller size, the storage overhead is significantly reduced, while still including potentially all relevant information to the organization. Furthermore, the reduced size may also allow for providing an integrity signature of the local list that can be computed significantly faster than a corresponding signature of the much larger, base list.

Yet another technical effect of utilizing the disclosed subject matter is to improve performance of security configurations, and allow the deployment thereof to be practical. Base lists or databases of authorized programs, may be too big for being stored locally by the system. In some exemplary embodiments, it may take a long time to send an authorization query of each program to be handled by an external server before any attempt to transmit an outgoing communication. Retaining a local list internally within the organization, and limiting it to include only authorized programs that are observed to be relevant to the organization, may allow the system to effectively operate and check authorization in a short timeframe and provide an efficient process.

Yet another technical problem dealt with by the disclosed subject matter is to provide a security measurement for BYOD devices that is applicable in both the organizational setting and the home setting.

Yet another technical problem dealt with by the disclosed subject matter is to enable to use of a device implementing port scrambling in a synchronized manner, when disconnected from the network. In U.S. Pat. No. 9,838,368, entitled “PORT SCRAMBLING FOR COMPUTER NETWORKS”, filed Aug. 25, 2016, which is hereby incorporated by reference in its entirety for all purposes without giving rise to disavowment, a method, system and product for providing secure communications through the use of port scrambling was disclosed. Such secure communication is implemented by selectively scrambling the ports of outgoing communications, if such communications are authorized, and descrambling the ports of all incoming communications. As a result, only devices that utilize the same scrambling method and encryption keys used for scrambling are able to effectively communicate with one another. However, a same device may be connected to different networks at different times. If such device continues to employ the above scrambling scheme in an environment where no other device utilizes it, the device may not be able to communicate with other devices. Yet, it may be desired to still provide the protection layer for the device, to reduce the risk of the device being infected. It is noted that as far as Applicant is aware the selective port scrambling technique is a matter of public knowledge in view of the previous disclosure, but has not yet become widely spread, routine or conventional.

Yet another technical solution is to provide a scrambling mechanism whose operation depends on connectivity of the computer to a network. In some exemplary embodiments, when the computer is connected to the network, scrambling is performed for outgoing communications that are authorized (e.g., transmitted by authorized programs that appear in a whitelist). When the computer is not connected to the network where the synchronized scrambling is performed, outgoing communications are scrambled only for unauthorized communications. Hence, a communication message issued an authorized program, such as MICROSOFT OUTLOOK™, may be transmitted in a scrambled port, if the computer is connected to the network, and transmitted in its original port, if the computer is disconnected from the network (or connected to another network). In some exemplary embodiments, incoming messages are handled in a manner that depends on the connectivity to the network: ports of incoming messages are descrambled when connected to a network where the devices scramble authorized communications, and in case the computer is not connected to such network, no descrambling is performed for incoming messages.

Yet another technical effect of utilizing the disclosed subject matter is to allow detection of attacks or outbreaks within the network by identifying access attempts at regular port numbers. Furthermore, attempts to access ports that are not a scrambled version of any useful ports may also be indicative of potential unauthorized activity as authorized activity is constrained to be directed solely at scrambled ports.

Yet another technical effect is to prevent outspread of malicious activity that relies on human engineering in the network. Even in case a human user is manipulated to allow access to a malicious user or code (e.g., pressing a harmful link or executing a malware sent via e-mail), malicious activity is likely to be contained in the infected device and not be spread to other devices.

Yet another technical effect is providing a cyber security protection measurement for BYOD devices and other devices that are not permanently connected to the organizational network and which sometimes connect to other networks. The disclosed subject matter enables the devices to continue working, even when a port scrambling agent is operating on them. The devices are provided with a firewall-like security layer using the same software, without requiring additional software to be installed or executed.

In some exemplary embodiments, the security layer may be provided while applying the policy defined by their organization when outside the organizational network. In some cases, an alternative policy may be defined as a modification of the organizational policy, such as by preventing usage of some authorized programs that are internal to the organization, or by allowing usage of commonly used programs that are prohibited when in the organization. In some other cases, different policies may be implemented and used for different connectivity statuses (e.g., different policy for home usage, for organizational usage, for usage in airport networks, or the like).

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

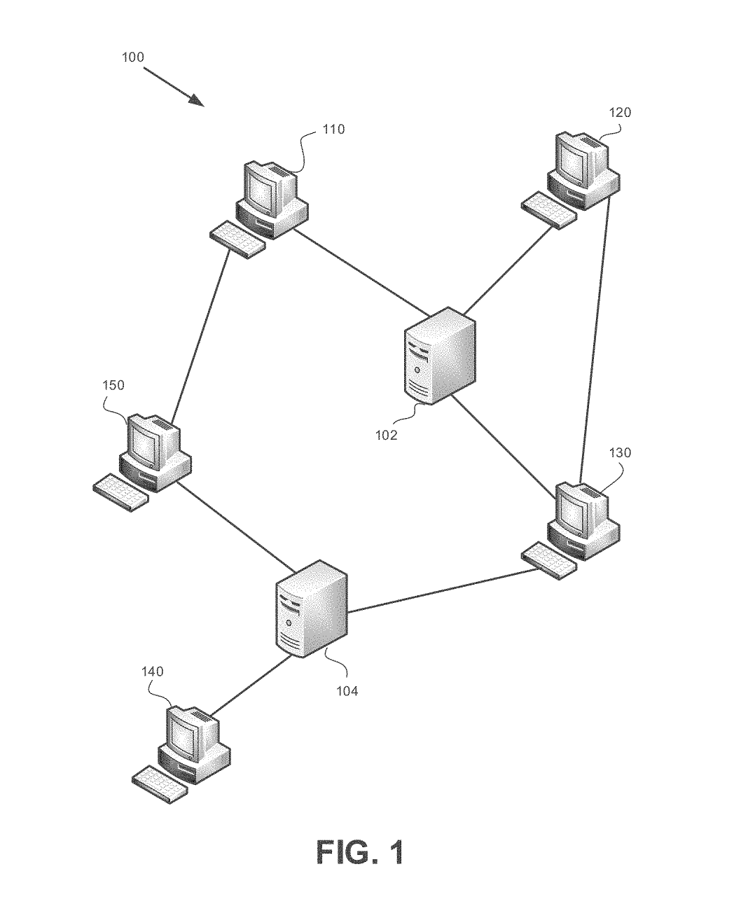

Referring now to FIG. 1 showing a computer network in which the disclosed subject matter is used, in accordance with some exemplary embodiments of the subject matter.

In some exemplary embodiments, a Computer Network 100 may comprise a plurality of computing devices, such as Devices 110, 120, 130, 140 and 150. Computer Network 100 may comprise one or more servers, such as Servers 102 and 104. Devices 110 to 150 may be interconnected to one another, either by common access to one of Servers 102 and 104 or directly, such as through using a network switch, a hub, or the like. For example, Devices 110, 120 and 130 are connected to Server 102, while Devices 140 and 150, as well as Device 130 are connected to Server 104. In addition, Device 110 is directly connected to Device 150 and Device 120 is directly connected to Device 130.

In some exemplary embodiments, Computer Network 100 may be an intranet network of an organization. Computer Network 100 may be connected to an external network, such as the Internet (not shown). In some cases, Computer Network 100 is connected to the external network by a router, switch, server or the like, which may or may not be configured to provide some security measures to prevent malicious activity. In one embodiment, the switch comprises a firewall that prevents access of undesired entities.

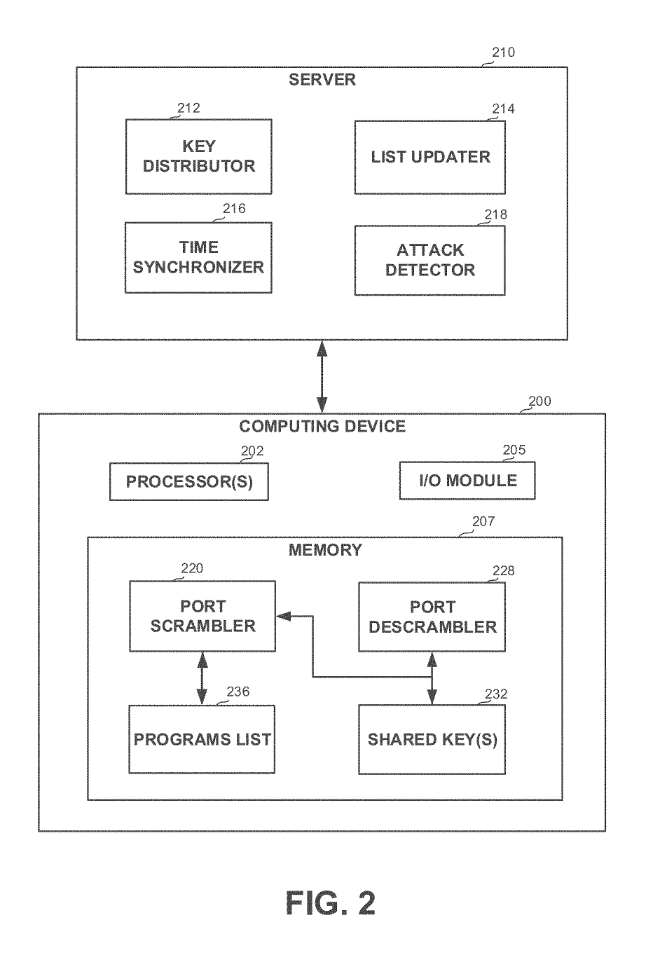

Referring now to FIG. 2 showing a block diagram of a system in accordance with some exemplary embodiments of the disclosed subject matter. The system comprises a Computing Device 200, such as Devices 110 to 150 of FIG. 1, and may be configured to provide for port scrambling, in accordance with the disclosed subject matter. In some exemplary embodiments, the system further comprises a Server 210, such as Servers 102 and 104 of FIG. 1, which may be in communication with Computing Device 200 via any suitable communication channel, such as an Ethernet switch connection or the like.

In some exemplary embodiments, Computing Device 200 may comprise one or more Processor(s) 202. Processor 202 may be a Central Processing Unit (CPU), a microprocessor, an electronic circuit, an Integrated Circuit (IC) or the like. Processor 202 may be utilized to perform computations required by Computing Device 200 or any of its subcomponents.

In some exemplary embodiments of the disclosed subject matter, Computing Device 200 may comprise an Input/Output (I/O) Module 205. The I/O Module 205 may be utilized to provide an output to and receive input from a user. Additionally or Alternatively, I/O Module 205 may be utilized to provide output to and receive input from Server 210 or another Computing Device 200 in communication therewith, such as another one of Devices 110 to 150 of FIG. 1.

In some exemplary embodiments, Computing Device 200 may comprise a Memory 207. Memory 207 may be a hard disk drive, a Flash disk, a Random Access Memory (RAM), a memory chip, or the like. In some exemplary embodiments, Memory 207 may retain program code operative to cause Processor 202 to perform acts associated with any of the subcomponents of Computing Device 200.

Memory 207 may comprise one or more components as detailed below, implemented as executables, libraries, static libraries, functions, or any other executable components.

Memory 207 may comprise Port Scrambler 220 which may comprise or be in communication with a Programs List 236 and one or more Shared Key(s) 232. Port Scrambler 220 may be configured to selectively apply a port scrambling function on port numbers associated with outgoing communications. Port Scrambler 220 may apply the port scrambling function responsive to receiving a request to transmit an outgoing communication from an application program listed on Programs List 236 (and executed by Computing Device 200). Port Scrambler 220 may use Shared Key(s) 232 as a parameter of the port scrambling function. Port Scrambler 220 may obtain a scrambled port number by applying the port scrambling function on the port number identifying the destination of the outgoing communication. Port Scrambler 220 may direct the outgoing communication to a destination identified by the scrambled port number.

Memory 207 may comprise Port Descrambler 228 which may comprise or be in communication with Shared Key(s) 232. Port Descrambler 228 may be configured to apply a port descrambling function on port numbers associated with incoming communications to Computing Device 200. The port descrambling function may be an inverse function of the port scrambling function applied by Port Scrambler 220. Port Descrambler 228 may use Shared Key(s) 232 as a parameter of the port descrambling function. Port Descrambler 228 may receive an incoming communication at a port identified by a scrambled port number. Port Descrambler 228 may obtain a descrambled port number by applying the port descrambling function on the scrambled port number.

In some exemplary embodiments, Port Descrambler 228 may perform the descrambling on all incoming communications regardless of their origin. Port Descrambler 228 may redirect the incoming communication to a port identified by the descrambled port number. Port Descrambler 228 may issue a notification to Server 210 in case that the descrambled port number is not assigned to any application program currently executing on Computing Device 200.

Similarly to Computing Device 200, Server 210 may comprise Processor(s) (not shown), I/O Module (not shown) and Memory (not shown).

Server 210 may comprise a Key Distributor 212 for generating and distributing Shared Key(s) 232 among a plurality of computing devices, such as Computing Device 200, in a computer network environment such as Computer Network 100 of FIG. 1. Key Distributor 212 may distribute Shared Key 232 to Computing Device 200 using Public Key Infrastructure (PM) cryptography. Shared Key 232 may comprise a fixed encryption key. Additionally or alternatively, Shared Key 232 may comprise a time-dependent encryption key, replaced periodically and valid for a limited time duration. In some exemplary embodiments, Shard Key(s) 232 may comprise three keys: a time dependent key that is updated periodically, a fixed key that uniquely identifies the organization in which the system of FIG. 2 is deployed, and a key which depends on Programs List 236, such as a hashing of Programs List 236.

Server 210 may comprise a List Updater 214 for maintaining and updating Programs List 236 among the plurality of computing devices in the network environment. List Updater 214 may provide credentials enabling verification of the content of Programs List 236 by Computing Device 200, for example by applying a hash function on Programs List 236 and digitally signing the result. The credentials may also be used for the scrambling or descrambling process, as one of the Shared Key(s) 232, and distributed by Key Distributor 212.

Server 210 may comprise a Time Synchronizer 216 for synchronizing system clocks among the plurality of computing devices in the network environment, in case that one or more of the Shared Key(s) 232 distributed by Key Distributor 212 are time-dependent.

Server 210 may comprise an Attack Detector 218, configured for tracking and analyzing traffic in the computer network environment in order to detect possible security attacks and outbreaks. Attack Detector 218 may receive and analyze notifications from Computing Device 200 concerning incoming communications for which the descrambled port number is not assigned to an application program.

In some exemplary embodiments, Key Distributor 212, List Updater 214, Time Synchronizer 216 and Attack Detector 218 may be deployed on one or more separate servers. In one embodiment, each of the above is deployed on a stand-alone and separate server.

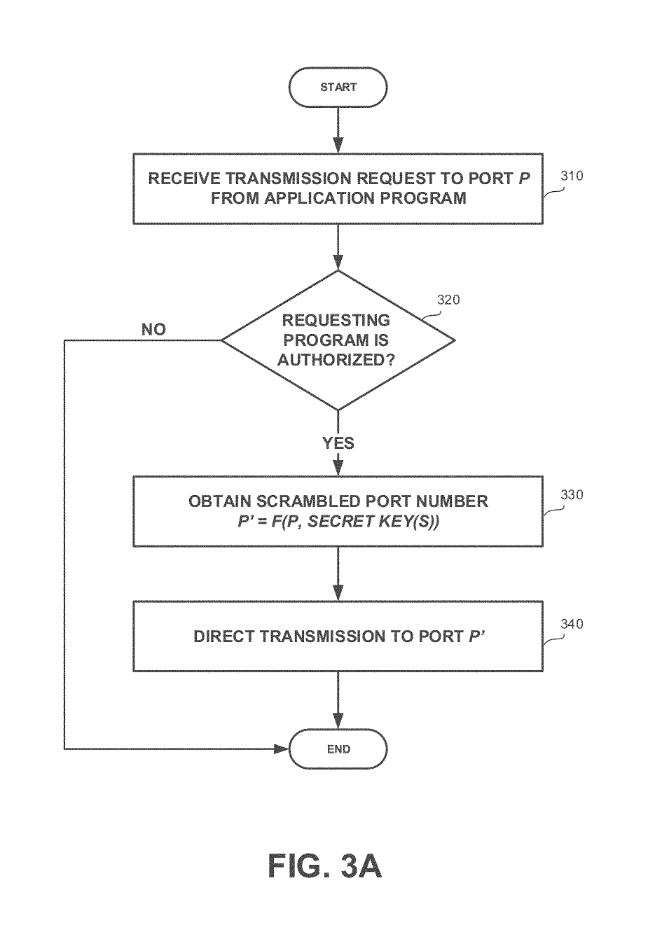

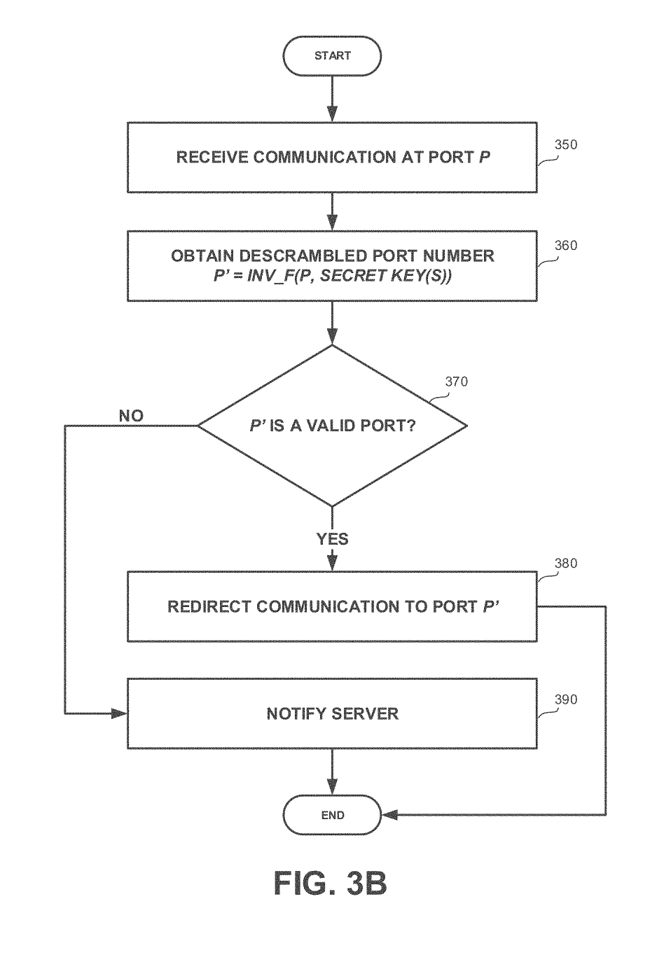

Referring now to FIG. 3A showing a flowchart diagram of a method in accordance with some exemplary embodiments of the disclosed subject matter.

On Step 310, a request of an application program to transmit an outgoing communication may be received. The application program may be executed by a computerized apparatus, such as Computing Device 200 of FIG. 2. The outgoing communication may be designated to be received at a destination via a first port (denoted “P”). The destination may be a destination external to the computerized apparatus, e.g. another Computing Device 200. As an example, the destination of a UDP packet may be provided as an IP address and a port (e.g., 192.168.1.52:80).

On Step 320, a determination whether the requesting application program is authorized may be made. The determination may be accomplished by consulting a list of authorized programs, such as Programs List 236 of FIG. 2. In some exemplary embodiments, non-authorized programs may still operate in the computing device, however, in view of the disclosed subject matter, such programs may not be able to effectively communicate with other devices on the same network.

On Step 330, in case that the requesting application program was determined to be authorized on Step 320, a transformation function may be applied on an identifier of the first port to obtain an identifier of a second port. The transformation function may depend on at least one secret parameter shared among a plurality of computing devices in a computer network, such as Shared Key 232 of FIG. 2. The identifier of the first port may be obtained by applying an inverse transformation on the identifier of the second port. The inverse transformation may depend on the at least one secret parameter, such that only devices sharing the at least one secret parameter may be able to apply the inverse transformation. The transformation function may be either a symmetric cryptography function, such as DES, AES, or the like, or an asymmetric cryptography function, such as RSA, El-Gammal, or the like.

In some exemplary embodiments, the scrambled port number may not be a port number which has a general known functionality, such as port numbers known as “common port numbers” which are published by the Internet Assigned Number Authority (IANA) or the like. As an example, the scrambled port may not be port 20-21 (used for FTP), port 22 (used for SSH), port 53 (used for DNS), port 80 (used for HTTP), port 443 (used for HTTPS) or the like. On Step 330, in case the transformation function provides an excluded port, a next non-excluded port may be selected. Additionally or alternatively, a list of excluded ports may include common port numbers or other port numbers which are constantly excluded. The list may also include port numbers which were used as scrambled ports in a previous time segment. For example, in case port 80 was scrambled to port 1579 during a first time segment, in a next time segment, when port 80 is scrambled to a different port number, all other ports may be excluded from being scrambled to port 1579 so as to avoid collision and confusion. In such an embodiment, a packet that is destined to port 1579 and is received in the second segment may be uniquely identified as a packet that was transmitted during the first time segment towards port 80.

On Step 340, the outgoing communication may be directed to be received at the destination via the second port. In the above given example in which the original address is 192.168.1.52:80 and in which port 80 is scrambled to port 1579, the outgoing communication may be transmitted to 192.168.1.52:1579.

In some exemplary embodiments, a content of the at least one secret parameter may be updated in each of the plurality of computing devices in the network. As a result, operation of the transformation function may be dynamically and automatically modified for all computing devices in the network. In particular, a subsequent request to transmit an outgoing communication to be received via the first port, may result in the application of the transformation function on Step 330 yielding an identifier of a third port different from the second port. In some exemplary embodiments, the transformation function is modified without a user providing a modified definition thereof.

Referring now to FIG. 3B showing a flowchart diagram of a method in accordance with some exemplary embodiments of the disclosed subject matter.

On Step 350, an incoming communication via a first port of a computerized apparatus, such as Computing Device 200 of FIG. 2, may be received. The incoming communication may be received from an external device via a computer network, such as Computer Network 100.

On Step 360, an identifier of a second port may be obtained by applying an inverse transformation function on an identifier of the first port. The inverse transformation function may depend on at least one secret parameter shared among a plurality of computing devices in the computer network, such as Shared Key 232 of FIG. 2.

On Step 370, a determination whether the second port is a valid port may be made. A valid port may be any port that is used by any of the programs in a list of authorized programs, such as Programs List 236 of FIG. 2. Additionally or alternatively, a valid port may be any common port. Additionally or alternatively, a valid port may be any port that is used by a program that is executed by the computerized apparatus.

On Step 380, in case that the second port was determined to be a valid port on Step 370, the incoming communication may be redirected to the second port. In some exemplary embodiments, subsequently, the incoming communication is received by a program and handled appropriately.

On Step 390, in case that the second port was determined as not being a valid port on Step 370, a corresponding notification may be issued to an entity in charge of tracking and analyzing network traffic for detecting attacks, such as Attack Detector 218 at Server 210 of FIG. 2. Additionally or alternatively, the received communication may be dropped and disregarded.

In some exemplary embodiments, a communication issued by an application that is not part of the list of authorized programs, such as Programs List 236 of FIG. 2, is not scrambled as described in FIG. 3A and thus is not received and handled by the desired final destination at the receiving device, as depicted in FIG. 3B. As a result, any non-authorized program that is executed by a device on the network is unable to effectively communicate with other devices.

In some exemplary embodiments, an unauthorized application is incapable of effectively accessing an external network to report to a malicious user. In order to communicate with a device in the external network, the device first needs to communicate with a router, bridge, switch or a similar device referred to as a router, which connects the network to the external network. Such communication may also be performed based on scrambled ports. As a result, and as the communication initiated by the unauthorized application is not scrambled, the router dismisses the communication and does not act upon it.

In some exemplary embodiments, communications in an organization's network may go through a firewall. The firewall may not be configured to handle port scrambling/descrambling. In such case, the transmitting device may determine that the packet is directly transmitted to a firewall and avoid port scrambling of such packet. Additionally or alternatively, a receiving device receiving a packet directly from a firewall, may avoid performing port descrambling on the received packet.

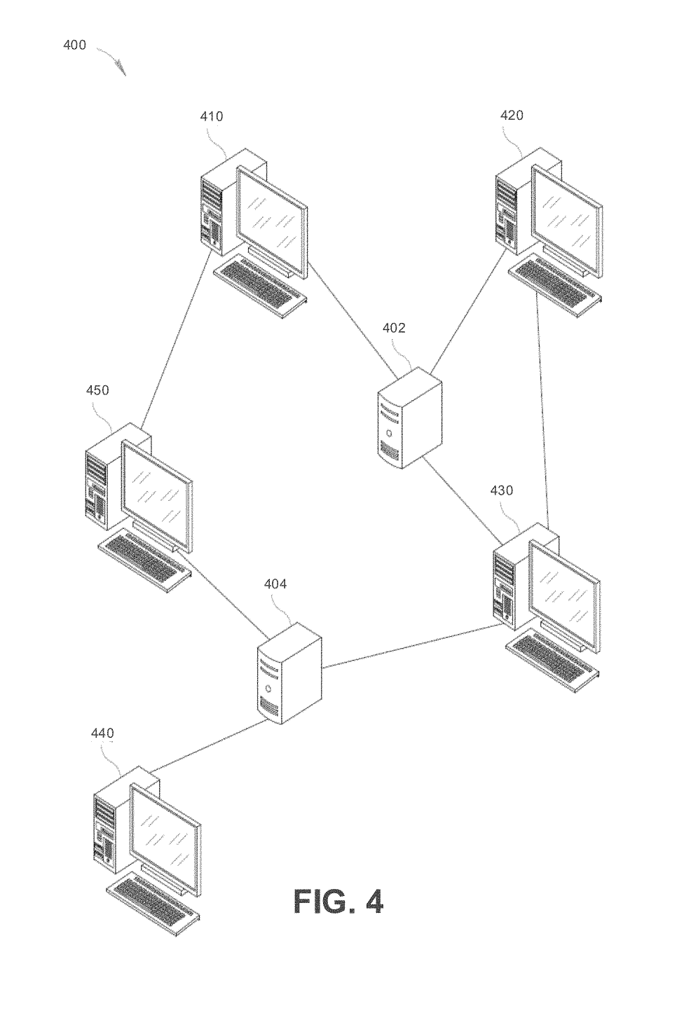

Referring now to FIG. 4 showing a computer network in which the disclosed subject matter is used, in accordance with some exemplary embodiments of the subject matter.

In some exemplary embodiments, a Computer Network 400 may comprise a plurality of computing devices, such as Devices 410, 420, 430, 440 and 450. Computer Network 400 may comprise one or more servers, such as Servers 402 and 404. Devices 410 to 450 may be interconnected to one another, either by common access to one of Servers 402 and 404 or directly, such as through using a network switch, a hub, or the like. For example, Devices 410, 420 and 430 are connected to Server 402, while Devices 440 and 450, as well as Device 430 are connected to Server 404. In addition, Device 410 is directly connected to Device 450 and Device 420 is directly connected to Device 430.

In some exemplary embodiments, Computer Network 400 may be an intranet network of an organization. Computer Network 400 may be connected to an external network, such as the Internet (not shown). In some cases, Computer Network 400 is connected to the external network by a router, switch, server or the like, which may or may not be configured to provide some security measures to prevent malicious activity. In one embodiment, the switch comprises a firewall that prevents access of undesired entities.

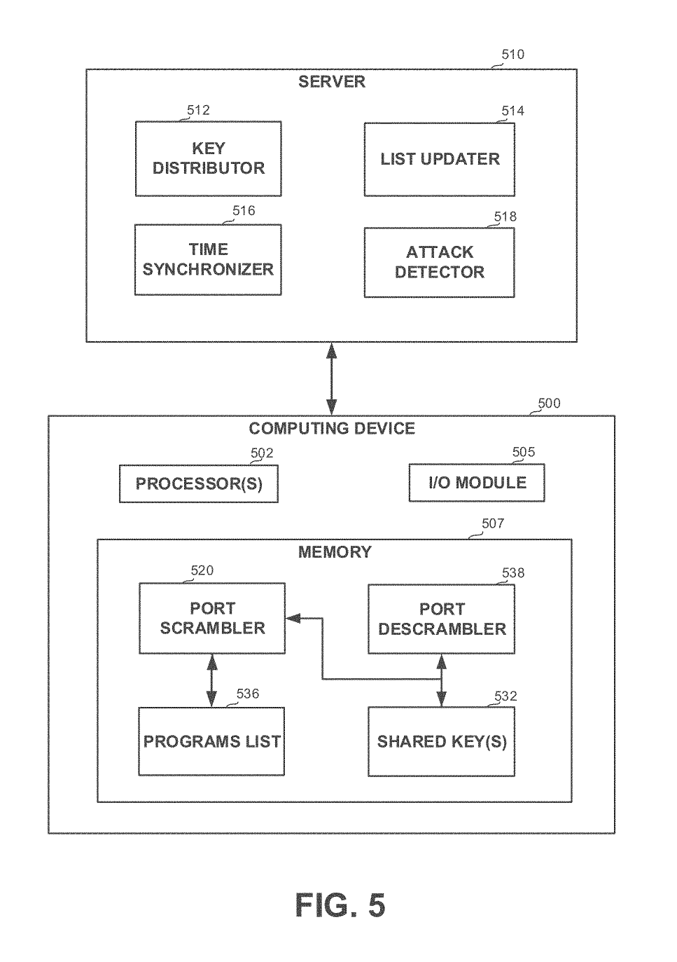

Referring now to FIG. 5 showing a block diagram of a system in accordance with some exemplary embodiments of the disclosed subject matter. The system comprises a Computing Device 500, such as Devices 410 to 450 of FIG. 4, and may be configured to provide for port scrambling, in accordance with the disclosed subject matter. In some exemplary embodiments, the system further comprises a Server 510, such as Servers 402 and 404 of FIG. 4, which may be in communication with Computing Device 500 via any suitable communication channel, such as an Ethernet switch connection or the like.

In some exemplary embodiments, Computing Device 500 may comprise one or more Processor(s) 502. Processor 502 may be a Central Processing Unit (CPU), a microprocessor, an electronic circuit, an Integrated Circuit (IC) or the like. Processor 502 may be utilized to perform computations required by Computing Device 500 or any of its subcomponents.

In some exemplary embodiments of the disclosed subject matter, Computing Device 500 may comprise an I/O Module 505. The I/O Module 505 may be utilized to provide an output to and receive input from a user. Additionally or Alternatively, I/O Module 505 may be utilized to provide output to and receive input from Server 510 or another Computing Device 500 in communication therewith, such as another one of Devices 410 to 450 of FIG. 4.

In some exemplary embodiments, Computing Device 500 may comprise a Memory 507. Memory 507 may be a hard disk drive, a Flash disk, a Random Access Memory (RAM), a memory chip, or the like. In some exemplary embodiments, Memory 507 may retain program code operative to cause Processor 502 to perform acts associated with any of the subcomponents of Computing Device 500.

Memory 507 may comprise one or more components as detailed below, implemented as executables, libraries, static libraries, functions, or any other executable components.

Memory 507 may comprise Port Scrambler 520 which may comprise or be in communication with a Programs List 536 and one or more Shared Key(s) 532. Port Scrambler 520 may be configured to selectively apply a port scrambling function on port numbers associated with outgoing communications. Port Scrambler 520 may apply the port scrambling function responsive to receiving a request to transmit an outgoing communication from an application program listed on Programs List 536 (and executed by Computing Device 500). Port Scrambler 520 may use Shared Key(s) 532 as a parameter of the port scrambling function. Port Scrambler 520 may obtain a scrambled port number by applying the port scrambling function on the port number identifying the destination of the outgoing communication. Port Scrambler 520 may direct the outgoing communication to a destination identified by the scrambled port number.

Memory 507 may comprise Port Descrambler 528 which may comprise or be in communication with Shared Key(s) 532. Port Descrambler 528 may be configured to apply a port descrambling function on port numbers associated with incoming communications to Computing Device 500. The port descrambling function may be an inverse function of the port scrambling function applied by Port Scrambler 520. Port Descrambler 528 may use Shared Key(s) 532 as a parameter of the port descrambling function. Port Descrambler 528 may receive an incoming communication at a port identified by a scrambled port number. Port Descrambler 528 may obtain a descrambled port number by applying the port descrambling function on the scrambled port number. In some exemplary embodiments, Port Descrambler 528 may perform the descrambling on all incoming communications regardless of their origin. Port Descrambler 528 may redirect the incoming communication to a port identified by the descrambled port number. Port Descrambler 528 may issue a notification to Server 510 in case that the descrambled port number is not assigned to any application program currently executing on Computing Device 500.

Similarly to Computing Device 500, Server 510 may comprise Processor(s) (not shown), I/O Module (not shown) and Memory (not shown).

Server 510 may comprise a Key Distributor 512 for generating and distributing Shared Key(s) 532 among a plurality of computing devices, such as Computing Device 500, in a computer network environment such as Computer Network 400 of FIG. 4. Key Distributor 512 may distribute Shared Key 532 to Computing Device 500 using Public Key Infrastructure (PM) cryptography. Shared Key 532 may comprise a fixed encryption key. Additionally or alternatively, Shared Key 532 may comprise a time-dependent encryption key, replaced periodically and valid for a limited time duration. In some exemplary embodiments, Shard Key(s) 532 may comprise three keys: a time dependent key that is updated periodically, a fixed key that uniquely identifies the organization in which the system of FIG. 5 is deployed, and a key which depends on Programs List 536, such as a hashing of Programs List 536.

Server 510 may comprise a List Updater 514 for maintaining and updating Programs List 536 among the plurality of computing devices in the network environment. List Updater 514 may provide credentials enabling verification of the content of Programs List 536 by Computing Device 500, for example by applying a hash function on Programs List 536 and digitally signing the result. The credentials may also be used for the scrambling or descrambling process, as one of the Shared Key(s) 532, and distributed by Key Distributor 512.

Server 510 may comprise a Time Synchronizer 516 for synchronizing system clocks among the plurality of computing devices in the network environment, in case that one or more of the Shared Key(s) 532 distributed by Key Distributor 512 are time-dependent.

Server 510 may comprise an Attack Detector 518, configured for tracking and analyzing traffic in the computer network environment in order to detect possible security attacks and outbreaks. Attack Detector 518 may receive and analyze notifications from Computing Device 500 concerning incoming communications for which the descrambled port number is not assigned to an application program.

In some exemplary embodiments, Key Distributor 512, List Updater 514, Time Synchronizer 516 and Attack Detector 518 may be deployed on one or more separate servers. In one embodiment, each of the above is deployed on a stand-alone and separate server.

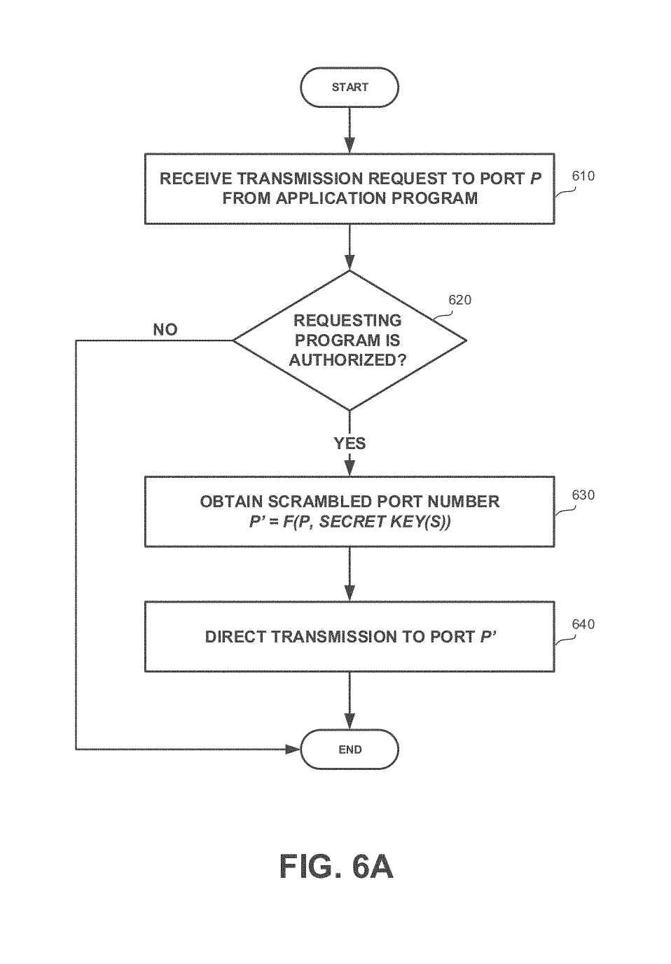

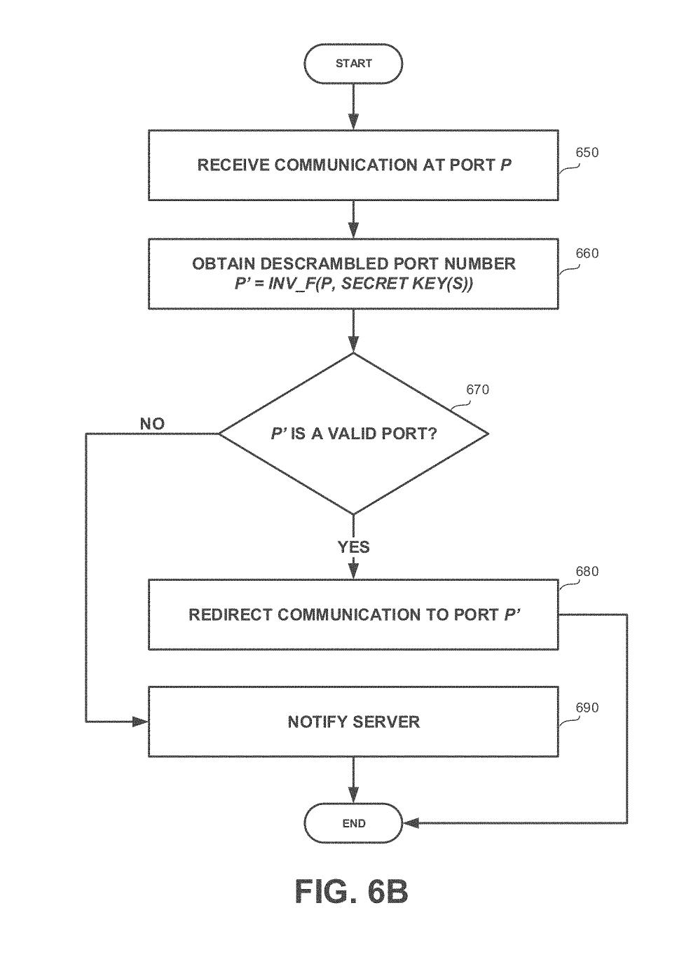

Referring now to FIG. 6A showing a flowchart diagram of a method in accordance with some exemplary embodiments of the disclosed subject matter.

On Step 610, a request of an application program to transmit an outgoing communication may be received. The application program may be executed by a computerized apparatus, such as Computing Device 500 of FIG. 5. The outgoing communication may be designated to be received at a destination via a first port (denoted “P”). The destination may be a destination external to the computerized apparatus, e.g. another Computing Device 500. As an example, the destination of a UDP packet may be provided as an IP address and a port (e.g., 192.168.1.52:80).

On Step 620, a determination whether the requesting application program is authorized may be made. The determination may be accomplished by consulting a list of authorized programs, such as Programs List 536 of FIG. 5. In some exemplary embodiments, non-authorized programs may still operate in the computing device, however, in view of the disclosed subject matter, such programs may not be able to effectively communicate with other devices on the same network.

On Step 630, in case that the requesting application program was determined to be authorized on Step 620, a transformation function may be applied on an identifier of the first port to obtain an identifier of a second port. The transformation function may depend on at least one secret parameter shared among a plurality of computing devices in a computer network, such as Shared Key 532 of FIG. 5. The identifier of the first port may be obtained by applying an inverse transformation on the identifier of the second port. The inverse transformation may depend on the at least one secret parameter, such that only devices sharing the at least one secret parameter may be able to apply the inverse transformation. The transformation function may be either a symmetric cryptography function, such as DES, AES, or the like, or an asymmetric cryptography function, such as RSA, El-Gammal, or the like.

In some exemplary embodiments, the scrambled port number may not be a port number which has a general known functionality, such as port numbers known as “common port numbers” which are published by the Internet Assigned Number Authority (IANA) or the like. As an example, the scrambled port may not be port 20-21 (used for FTP), port 22 (used for SSH), port 53 (used for DNS), port 80 (used for HTTP), port 443 (used for HTTPS) or the like. On Step 660, in case the transformation function provides an excluded port, a next non-excluded port may be selected. Additionally or alternatively, a list of excluded ports may include common port numbers or other port numbers which are constantly excluded. The list may also include port numbers which were used as scrambled ports in a previous time segment. For example, in case port 80 was scrambled to port 1579 during a first time segment, in a next time segment, when port 80 is scrambled to a different port number, all other ports may be excluded from being scrambled to port 1579 so as to avoid collision and confusion. In such an embodiment, a packet that is destined to port 1579 and is received in the second segment may be uniquely identified as a packet that was transmitted during the first time segment towards port 80.

On Step 640, the outgoing communication may be directed to be received at the destination via the second port. In the above given example in which the original address is 192.168.1.52:80 and in which port 80 is scrambled to port 1579, the outgoing communication may be transmitted to 192.168.1.52:1579.

In some exemplary embodiments, a content of the at least one secret parameter may be updated in each of the plurality of computing devices in the network. As a result, operation of the transformation function may be dynamically and automatically modified for all computing devices in the network. In particular, a subsequent request to transmit an outgoing communication to be received via the first port, may result in the application of the transformation function on Step 630 yielding an identifier of a third port different from the second port. In some exemplary embodiments, the transformation function is modified without a user providing a modified definition thereof.

Referring now to FIG. 6B showing a flowchart diagram of a method in accordance with some exemplary embodiments of the disclosed subject matter.

On Step 650, an incoming communication via a first port of a computerized apparatus, such as Computing Device 500 of FIG. 5, may be received. The incoming communication may be received from an external device via a computer network, such as Computer Network 400.

On Step 660, an identifier of a second port may be obtained by applying an inverse transformation function on an identifier of the first port. The inverse transformation function may depend on at least one secret parameter shared among a plurality of computing devices in the computer network, such as Shared Key 532 of FIG. 5.

On Step 670, a determination whether the second port is a valid port may be made. A valid port may be any port that is used by any of the programs in a list of authorized programs, such as Programs List 536 of FIG. 5. Additionally or alternatively, a valid port may be any common port. Additionally or alternatively, a valid port may be any port that is used by a program that is executed by the computerized apparatus.

On Step 680, in case that the second port was determined to be a valid port on Step 670, the incoming communication may be redirected to the second port. In some exemplary embodiments, subsequently, the incoming communication is received by a program and handled appropriately.

On Step 690, in case that the second port was determined as not being a valid port on Step 670, a corresponding notification may be issued to an entity in charge of tracking and analyzing network traffic for detecting attacks, such as Attack Detector 518 at Server 510 of FIG. 5. Additionally or alternatively, the received communication may be dropped and disregarded.

In some exemplary embodiments, a communication issued by an application that is not part of the list of authorized programs, such as Programs List 536 of FIG. 5, is not scrambled as described in FIG. 6A and thus is not received and handled by the desired final destination at the receiving device, as depicted in FIG. 6B. As a result, any non-authorized program that is executed by a device on the network is unable to effectively communicate with other devices.

In some exemplary embodiments, an unauthorized application is incapable of effectively accessing an external network to report to a malicious user. In order to communicate with a device in the external network, the device first needs to communicate with a router, bridge, switch or a similar device referred to as a router, which connects the network to the external network. Such communication may also be performed based on scrambled ports. As a result, and as the communication initiated by the unauthorized application is not scrambled, the router dismisses the communication and does not act upon it.

In some exemplary embodiments, communications in an organization's network may go through a firewall. The firewall may not be configured to handle port scrambling/descrambling. In such case, the transmitting device may determine that the packet is directly transmitted to a firewall and avoid port scrambling of such packet. Additionally or alternatively, a receiving device receiving a packet directly from a firewall, may avoid performing port descrambling on the received packet.

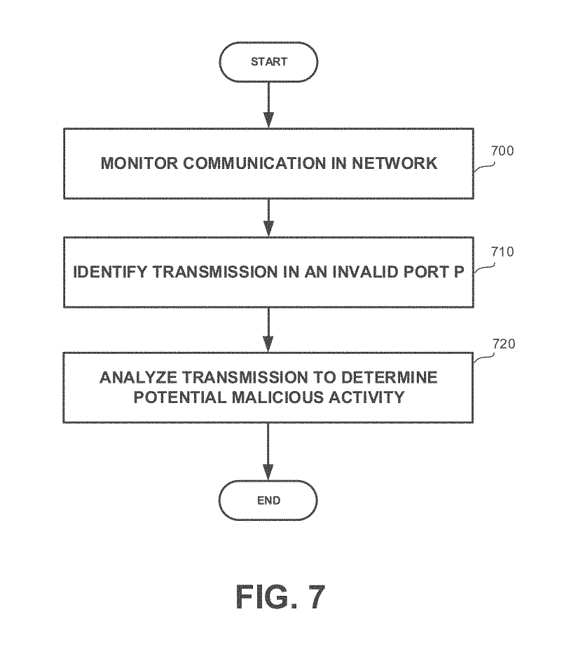

Referring now to FIG. 7 showing a flowchart diagram of a method in accordance with some exemplary embodiments of the disclosed subject matter. In some exemplary embodiments, FIG. 7 may be performed by a sever, such as 510 of FIG. 5.

On Step 700, traffic in the network may be monitored. In some exemplary embodiments, the traffic may be monitored directly by a server, such as by analyzing packets that are routed via the server. Additionally or alternatively, the traffic may be monitored using distributed agents, such as dedicated software executed by devices in the network. In one embodiment, a port scrambler is installed on each device in the network and is used as a distributed monitoring agent on behalf of the server.

On Step 710, a transmission that attempts to access an invalid port is identified. In some exemplary embodiments, transmission which is performed within a reasonable timeframe after a port was valid and became invalid, such as within 5 seconds, about 1 minute, about 10 minutes, or the like, may be overlooked as such attempt to access invalid port may be attributed to differences in clocks of different devices. In some exemplary embodiments, the target port may be compared to currently valid ports, such as defined by the transformation function.

In some exemplary embodiments, a list of predetermined ports, such as ports commonly used ports (e.g., common port numbers), may be excluded from being valid at any time. For example, port 80 may not be used as a scrambled port. Any attempt to access a port in the list may be immediately identified as an attempt, and attempt to access such predetermined known port which is invalid by definition of the transformation function, may be immediately determined to be an attempt to access an invalid port.

In some exemplary embodiments, a minority of the devices of the network, such as a firewall component, may not be configured to scramble and descramble ports. The analysis of Step 710 may ignore packets originating from such devices or directed towards such devices. In some exemplary embodiments, only transmission attempts directed towards devices that descramble ports for incoming packets may be analyzed and considered during Step 710.

Additionally or alternatively, on Step 710, a notification by a receiving client that the port is invalid may be received, such as depicted on Step 690 of FIG. 6B.

On Step 720, the transmission may be analyzed to determine whether it is part of malicious activity. In some exemplary embodiments, past attempts from the same device may also be used to make such determination. In some exemplary embodiments, port scanning attempts may include a repetitive attempt to access ports in order to identify open ports. Such activity may include several attempts to access ports that may be invalid.

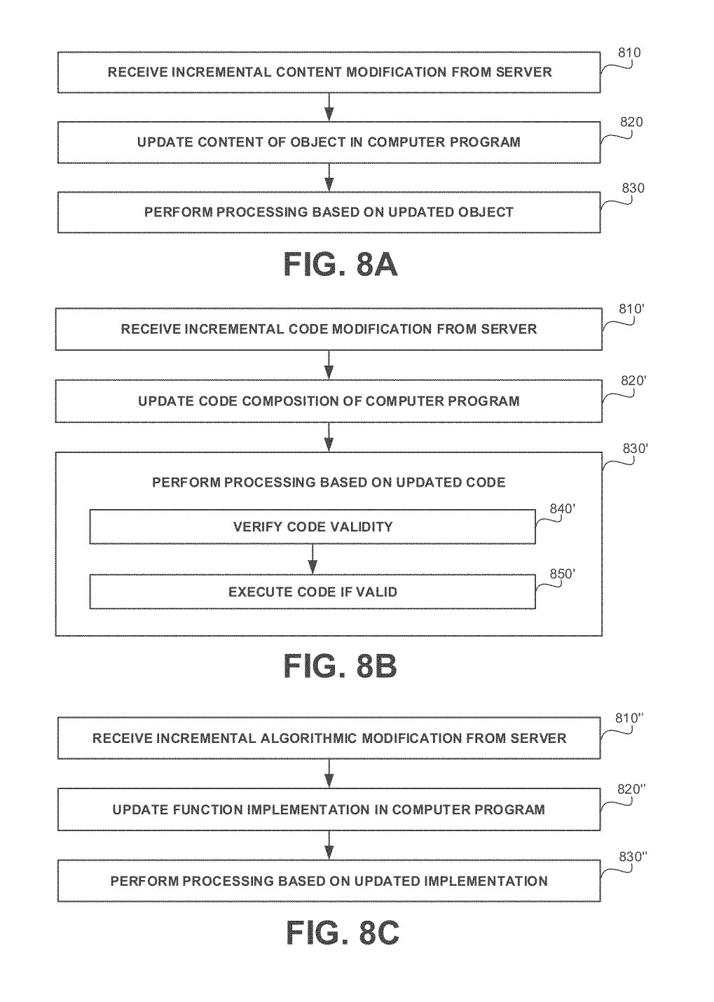

Referring now to FIG. 8A showing a flowchart diagram of a method in accordance with some embodiments of the disclosed subject matter.

On Step 810, an incremental content modification may be received from a server. The incremental content modification may be received at a computerized apparatus being in communication with the server and configured for executing a computer program. The computer program may be retained in a storage device coupled to or comprised by the computerized apparatus. The computer program may be configured for utilizing, in processing performed thereby, an object capable of admitting content. The incremental content modification may comprise a modification to a current content of the object, whereby an updated content thereof may be obtained.

In some exemplary embodiments, the computerized apparatus may be comprised in a network environment of a plurality of computerized apparatuses to which the server distributes the incremental content modification. The server may be configured to transmit incremental content modifications periodically, e.g., monthly, weekly, daily, hourly, or the like. In some exemplary embodiments, the period between each two consecutive incremental content modifications being transmitted, may be rationed so as to make reverse engineering of the computer program during that time practically infeasible or prohibitively intensive on computing resources. The incremental content modifications may be determined by the server using a randomized process. In some exemplary embodiments, the object may be initialized with an initial content assignment provided to an instance of the computer program retained in the computerized apparatus at a first distribution of the computer program to the computerized apparatus or subsequently from the server.

On Step 820, the incremental content modification received on Step 810 may be used for updating content of the object in the computer program, from a current content thereof to an updated content per a modification entailed by the incremental content modification, whereby an updated content of the object is obtained in a synchronized manner and without the updated content being transmitted via a communication channel. It will be appreciated that by transmitting only the incremental content modification, i.e. a delta change between the current content and the updated content, rather than transmitting the updated content itself, a risk of the updated content being intercepted by a man-in-the-middle eavesdropping to the transmission channel is avoided. As a result, a likelihood of the updated content being used to reverse engineer the program for malicious purposes, or otherwise exploited or corrupted, is significantly decreased.

On Step 830, processing may be performed by the computer program based on the updated content of the object as obtained on Step 820. In some exemplary embodiments, operation of the computer program based on the updated content may be altered in comparison to its operation prior to the updating performed on Step 820. In consequence, any instance of the computer program obtained by an unauthorized entity prior to performing of Step 820, such as, for example, by means of hacking to the computerized apparatus, performing reverse engineering of the computer program during its execution on the computerized apparatus, or the like, may become invalid and possibly ineffective for its intended purpose thereafter, unless the incremental content modification, as well as every incremental content modification preceding it, is also obtained by that entity. Similarly, if the unauthorized entity manages to intercept the incremental content modification, without having also obtained the computer program with a current content of the object, then the unauthorized entity would still remain with an invalid instance of the computer program after applying the incremental content modification on a hacked copy of the computer program it possesses.

In some exemplary embodiments, the object may be a database. The database may comprise one or more tables, each of which having a plurality of fields. The incremental content modification may comprise a change to the schema of the database, such as, for example, names of fields, ordering of the fields or tables, addition or deletion of dummy fields, or the like. Changes to the database schema may be designed themselves for being applied in an incremental manner, e.g. a change of name may be accomplished by concatenation of a string as a prefix, suffix, or the like to a pre-existing field name, i.e. “user id” may be substituted by “user id1234” or the like. The manner by which changes are indicated in the incremental content modification may be preferably designed so as not to disclose details of the database schema or current disposition thereof. For example, fields ordering change may be indicated by mere specifying of a permutation over the whole set fields, including all fixed points, if any, without reference to specific fields by name, content, or likewise privileged information. In some exemplary embodiments, SQL injection attacks may be prevented as such attack may require a knowledge of the database schema. Even if an attacker is made aware of the schema, the attacker may not make use of such information, as when the attacker attempts to employ it, the schema may have already changed. Additionally or alternatively, the dummy fields may be fields that are defined as requiring to be set with a value, thereby preventing SQL injection attacks which insert new records by an attacker who is not aware of all the dummy fields.

It will be appreciated, however, that the disclosed subject matter is not meant to be limited in such manner, and may be utilized in context of other software resources incrementally modifiable, such as, for example, computer program code, algorithms, protocols, or the like, as described in detail hereinafter.

Referring now to FIG. 8B showing a flowchart diagram of a method in accordance with some embodiments of the disclosed subject matter.

On Step 810′, an incremental code modification may be received from a server. The incremental code modification may be received at a computerized apparatus being in communication with the server and configured for executing a computer program, similarly as in Step 810 of FIG. 8A. The computer program may be embodied in a form of a plurality of contiguous segments of code lines, which in the context of the present disclosure are being referred to as “code sections”. The incremental code modification may comprise a modification to a current composition of the plurality of code segments, whereby an updated composition thereof may be obtained.

In some exemplary embodiments, the computerized apparatus may be comprised in a network environment of a plurality of computerized apparatuses to which the server distributes the incremental code modification. The server may be configured to transmit incremental code modifications periodically, e.g., monthly, weekly, daily, hourly, or the like. In some exemplary embodiments, the period between each two consecutive incremental code modifications being transmitted, may be rationed so as to make reverse engineering of the computer program during that time practically infeasible or prohibitively intensive on computing resources. The incremental code modifications may be determined by the server using a randomized or pseudo-randomized process.

In some exemplary embodiments, the plurality of code segments may be configured for receiving and maintaining a plurality of keys at different locations therein. The keys may be initially provided to an instance of the computer program retained in the computerized apparatus at a first distribution of the computer program to the computerized apparatus or subsequently from the server. In some exemplary embodiments, the server may further provide for a wrapper or decorator software adapting the computer program to incorporate therein placeholders for the plurality of keys in the plurality of code sections. The plurality of code sections for housing the plurality of keys may be dummy code sections injected by the wrapper software such that functionality of the computer program is not affected thereby. The keys may be provided in a form of numeric values, e.g. big integers such as used in cryptographic computing or the like. The keys may be selected by the server at random from a given bank of admissible values or fabricated using a random or pseudo-random generator function or the like.

On Step 820′, the incremental code modification received on Step 810′ may be used for updating composition of the plurality of code sections in the computer program, from a current composition thereof to an updated composition per a modification entailed by the incremental code modification, whereby an updated composition of the plurality of code sections is obtained in a synchronized manner and without the updated composition being transmitted via a communication channel, similarly as accomplished in Step 820 of FIG. 8A. It will be appreciated that by transmitting only the incremental code modification, i.e. a delta change between the current and updated composition, instead of transmitting the updated composition of the code itself, a risk of the updated code being intercepted by a man-in-the-middle eavesdropping to the transmission channel is avoided. As a result, a likelihood of the updated code being used for malicious purposes is significantly decreased.

On Step 830′, processing may be performed by the computer program based on the updated composition of the plurality of code sections, as obtained on Step 820′, similarly as in Step 830 of FIG. 8A. In some exemplary embodiments, operation of the computer program based on the updated composition may be altered in comparison to its operation prior to the updating performed on Step 820′. In consequence, any instance of the computer program obtained by an unauthorized entity prior to performing of Step 820′, such as, for example, by means of hacking to the computerized apparatus, performing reverse engineering of the computer program during its execution on the computerized apparatus, or the like, may become invalid and possibly ineffective for its intended purpose thereafter, unless the incremental code modification is also obtained by that entity. Similarly, if the unauthorized entity manages to intercept the incremental code modification, without having also obtained the computer program with a current composition of the code, then the unauthorized entity would still remain with an invalid instance of the computer program after applying the incremental code modification on a hacked copy of the computer program it possesses.

In some exemplary embodiments, the processing performed on Step 830′ may comprise performing, On Step 840′, an act of verifying the computer program by checking validity of the plurality of code sections comprised in an instance of the computer program being executed or retained in the computerized apparatus at the time, whereby verifying that the computer program maintains its authenticity and integrity, namely that it originates from a legitimate source and has not been tampered with or otherwise corrupted. A positive result to verification of the computer program's code may be set as a precondition to execution of the computer program or predetermined portions thereof being launched or resumed on Step 850′. In some exemplary embodiments, a verification operation performed on Step 840′ may comprise verifying validity of the plurality of keys embedded in the plurality of code sections. In some further exemplary embodiments, a checker function for performing said verification may be also provided in a similar manner as integrated component within the plurality of code sections. Alternatively, the checker function may reside only at the server side and invoked in an online, dynamic fashion upon demand.

In some exemplary embodiments, the incremental code modification may comprise a change to a structure of the plurality of code sections, such as, for example, a re-ordering thereof, an addition, deletion or modification of dummy code sections, or the like. Additionally or alternatively, the incremental code modification may comprise a change to the plurality of keys, where applicable, such as, for example, a change in locations of keys within the code, a change in the keys' values, or the like. In some exemplary embodiments, the incremental code modification may further comprise a change to a checker function for verifying the plurality of keys, where applicable. It will be appreciated that each of which changes to either the code structure, keys' values or locations, checker function, or the like, may be indicated in the incremental code modification in an incremental manner, such that only the differences between the current and updated composition of the code are prescribed thereby and not the whole composition (current or updated) in entirety. For example, a structure change may be prescribed as an instruction to duplicate a dummy code section in a start position and placing a copy in an end position. Similarly, a key location change may be stated as an instruction to move up or down a specified number of code lines, or to displace to another code section altogether. A change to a key value may be instructed as an arithmetic operation to be performed on a current value, e.g. addition, subtraction, multiplication or division by a specified value or the like. Any and all of such changes may be also fed into a checker function where present so it is updated accordingly.

Referring now to FIG. 8C showing a flowchart diagram of a method in accordance with some embodiments of the disclosed subject matter.

On Step 810″, an incremental algorithmic modification may be received from a server, similarly as in Steps 810 and 810′ of FIGS. 8A-8B. The incremental algorithmic modification may be received at a computerized apparatus being in communication with the server and configured for executing a computer program. The computer program may be retained in a storage device coupled to or comprised by the computerized apparatus. The computer program may be configured for utilizing, in processing performed thereby, a function configured to admitting input and generating output therefrom. The incremental algorithmic modification may comprise a modification to a current implementation of the function, whereby an updated implementation thereof may be obtained.

In some exemplary embodiments, the computerized apparatus may be comprised in a network environment of a plurality of computerized apparatuses to which the server distributes the incremental algorithmic modification. The server may be configured to transmit incremental algorithmic modifications periodically, e.g., monthly, weekly, daily, hourly, or the like. In some exemplary embodiments, the period between each two, consecutive incremental algorithmic modifications being transmitted, may be rationed so as to make reverse engineering of the computer program during that time practically infeasible or prohibitively intensive on computing resources. The incremental algorithmic modifications may be determined by the server using a randomized process.

On Step 820″, the incremental algorithmic modification received on Step 810″ may be used for updating implementation of the function in the computer program, from a current implementation thereof to an updated implementation per a modification entailed by the incremental algorithmic modification, whereby an updated implementation of the function is obtained in a synchronized manner and without the updated implementation being transmitted via a communication channel, similarly as in Steps 820 and 820′ of FIGS. 8A-8B. It will be appreciated that by transmitting only the incremental algorithmic modification, i.e. a delta change between the current implementation and the updated implementation, rather than transmitting the updated implementation itself, a risk of the updated implementation being intercepted by a man-in-the-middle eavesdropping to the transmission channel is avoided. As a result, a likelihood of the updated implementation being used to reverse engineer the program for malicious purposes is significantly decreased.

On Step 830″, processing may be performed by the computer program based on the updated implementation of the function as obtained on Step 820″, similarly as in Steps 830 and 830′ of FIGS. 8A-8B. In some exemplary embodiments, operation of the computer program based on the updated implementation may be altered in comparison to its operation prior to the updating performed on Step 820″. In consequence, any instance of the computer program obtained by an unauthorized entity prior to performing of Step 820″, such as, for example, by means of hacking to the computerized apparatus, performing reverse engineering of the computer program during its execution on the computerized apparatus, or the like, may become invalid and possibly ineffective for its intended purpose thereafter, unless the incremental algorithmic modification is also obtained by that entity. Similarly, if the unauthorized entity manages to intercept the incremental algorithmic modification, without having also obtained the computer program with a current implementation of the function, then the unauthorized entity would still remain with an invalid instance of the computer program after applying the incremental algorithmic modification on a hacked copy of the computer program it possesses.

In some exemplary embodiments, the incremental algorithmic modification received on Step 810″ may comprise an indication of a second function, similarly configured for admitting input and generate output therefrom. The second function may be configured for admitting one or more types of input, a first of which conforming in type to output generated by the function, and zero or more additional input parameters as a second type of input, which input parameters or values therefor may also be indicated in the incremental algorithmic modification. The updated implementation may accordingly be obtained by composing the second function on the function, along with the zero or more input parameters values, where applicable. In some further exemplary embodiments, the function may be an arithmetic formula adapted to admitting a sequence of one or more variables and generate a single value therefrom. The second function may be an arithmetic operator over one or more operands, a first of which being an output of the function, and the remainder zero or more operands being some arbitrary values, which may be prescribed in the incremental algorithmic modification or otherwise determined in a centralized manner. For example, the operator may be an addition, subtraction, multiplication, division, exponentiation or the like of an output of the function by a constant value, e.g. “+5”, “2”, “−3”, or the like. In some exemplary embodiments, the values of the additional zero or more operands of the operator may be selected by the server at random or obtained using random or pseudo-random number generation algorithms, such as used in cryptographic computing or the like.

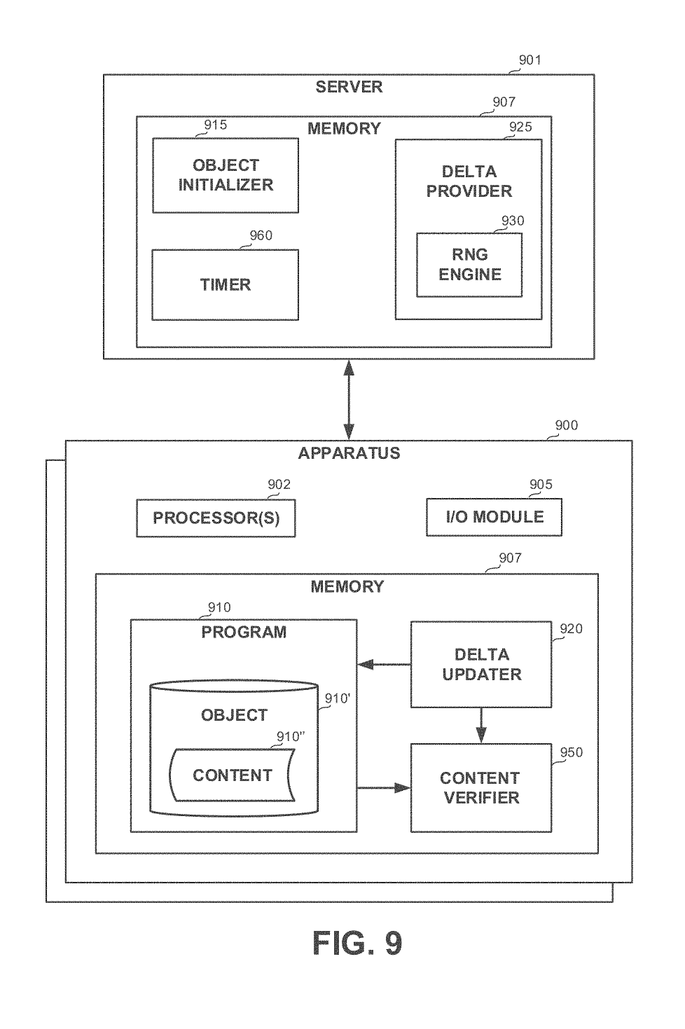

Referring now to FIG. 9 showing a block diagram of an apparatus comprised in a computerized environment schematically illustrated, in accordance with some exemplary embodiments of the disclosed subject matter. An Apparatus 900 may be configured to provide for an enhanced resistance to reverse engineering of a computer program or other software resource executing thereon, in accordance with the disclosed subject matter.

In some exemplary embodiments, Apparatus 900 may comprise one or more Processor(s) 902. Processor 902 may be a Central Processing Unit (CPU), a microprocessor, an electronic circuit, an Integrated Circuit (IC) or the like. Processor 902 may be utilized to perform computations required by Apparatus 900 or any of it subcomponents.

In some exemplary embodiments of the disclosed subject matter, Apparatus 900 may comprise an I/O Module 905. I/O Module 905 may be utilized to provide an output to and receive input from a user or another apparatus being in communication therewith, such as Server 901. Server 901 may comprise, similarly to Apparatus 900, a Processor, an I/O Module and a Memory (not shown). Apparatus 900 may communicate with Server 901 over any available communication channel, such as the Internet.

In some exemplary embodiments, Apparatus 900 may comprise a Memory 907. Memory 907 may be a hard disk drive, a Flash disk, a Random Access Memory (RAM), a memory chip, or the like. In some exemplary embodiments, Memory 907 may retain program code operative to cause Processor 902 to perform acts associated with any of the subcomponents of Apparatus 900.

Apparatus 900 may be configured to execute a Program 910 retained in Memory 907, which may comprise a sequence of instructions to be performed by Processor 902. Program 910 may comprise an Object 910′ to be utilized in processing performed by Program 910 during execution thereof on Apparatus 900. Object 910′ may be any computing resource, such as, for example, a database, an algorithm, a library, a code block, or the like. In some exemplary embodiments, Object 910′ may be configured for receiving and maintaining a Content 910″. For example, Content 910″ may be a database schema comprised of tables having data fields of predetermined names, structure and ordering, where Object 910′ is a database. As another example, Content 910″ may be a composition of code segments of Program 910 comprising structure, ordering, values or locations of keys, or the like. It will be noted that Program 910 may be executed by many different Apparatuses 900 each of which communicating with Server 901.

Memory 907 may comprise a Delta Updater 920, configured for updating Content 910″ of Object 910′ in Program 910 based on an incremental modification thereto as received from Server 901, similarly as in Steps 820, 820′ and 820″ of FIGS. 8A-8C. In some exemplary embodiments, Memory 907 may further comprise a Content Verifier 950, configured for verifying validity of Content 910″, similarly as in Step 850′ of FIG. 8B. Content Verifier 950 may be either integrally comprised by Program 910 or provided as stand-alone unit capable of interfacing therewith. In some exemplary embodiments, Delta Updater 920 may be further configured to update Content Verifier 950 too using an appropriate incremental modification received from Server 901, whether as part of the modification to Content 910″ or in addition thereto.

In some exemplary embodiments, Server 901 may comprise an Object Initializer 915 configured for providing an initial content assignment distributed to Apparatus 900, whereby Object 910′ is initialized with initial Content 910″. In some further exemplary embodiments, Object Initializer 915 may be further configured for providing a wrapper function to enhance Program 910 with evolving code polymorphing capabilities, such as, for example, receiving, maintaining and verifying keys at specific locations in the program code, in accordance with the disclosed subject matter.

Server 901 may comprise a Delta Provider 925 configured for providing incremental modifications of Content 910″ to Apparatus 900. In some exemplary embodiments, the incremental modifications may be randomized. Delta Provider 925 may comprise a Random Number Generator (RNG) Engine 930 to assist in random computing functions that may be required in connection with provision of incremental modifications by Delta Provider 925. Server 901 may provide the incremental modifications periodically. In some exemplary embodiments, Server 901 may comprise a Timer 960 configured for timing a period between issuing of one incremental modification by Server 901 and until a next incremental modification succeeding it is delivered.

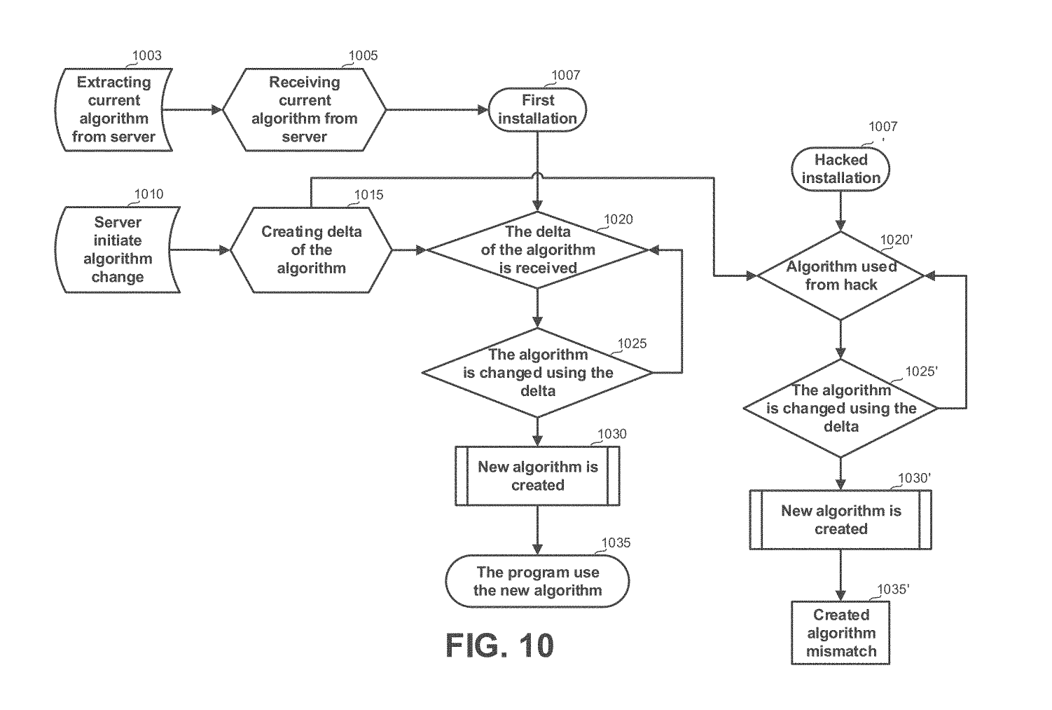

Referring now to FIG. 10 showing a flowchart diagram schematically illustrating operating mode and principles of utilizing the disclosed subject matter to frustrate hacking attempts, in accordance with some exemplary embodiments of the disclosed subject matter.

A current algorithm version may be extracted from the server in Step 1003, received at an authorized apparatus in Step 1005, and first installed thereon in Step 1007. A hacked installation may then be obtained by an unauthorized entity in Step 1007′, such as by reverse engineering of first installation performed in Step 1007. An algorithm change may be initiated by the server in Step 1010, and a delta of the algorithm may be accordingly created in Step 1015. The delta of the algorithm may be received at the authorized apparatus in Step 1020 and used to change the algorithm accordingly in Step 1025. Steps 1020 to 1025 may be repeated one or more times, in accordance with algorithm changes as initiated by the server. Based on the accumulated changes thereto, a new algorithm may be created in Step 1030 and used by the program in Step 1035. The unauthorized entity may attempt to imitate the process and use the algorithm from the hacked installation in Step 1020′, which algorithm may then also be changed in Step 1025′ using the delta, similarly as in Step 1025, and, following one or more such changes, a new algorithm may be created based thereon in Step 1030′. However, as the unauthorized entity may not have access to the first installation of the algorithm, but rather to merely a hacked installation at best, or it may not have access to one or more of the deltas, then the created algorithm of Step 1030′ may end up in Step 1035′ being in mismatch with the algorithm used by the program in Step 1035.

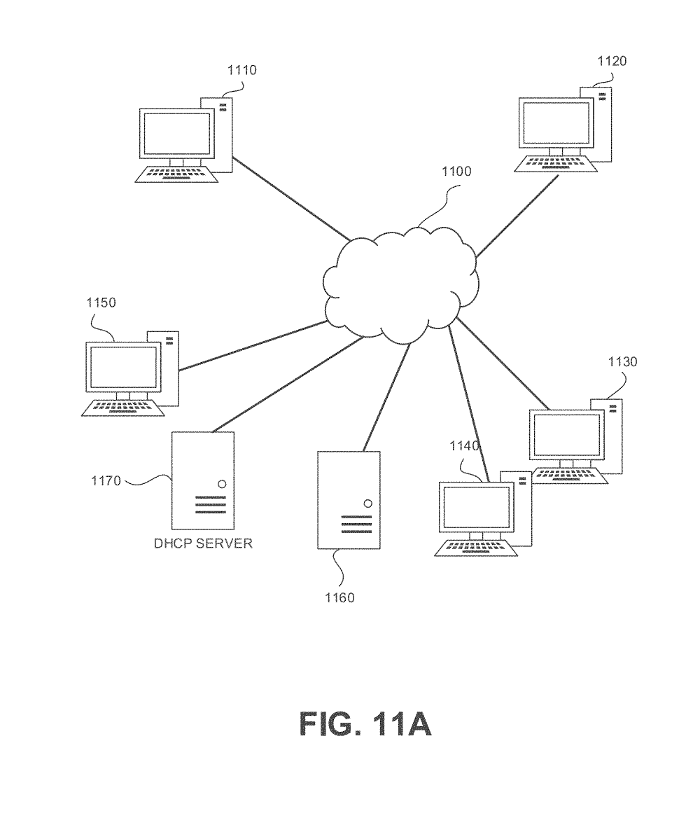

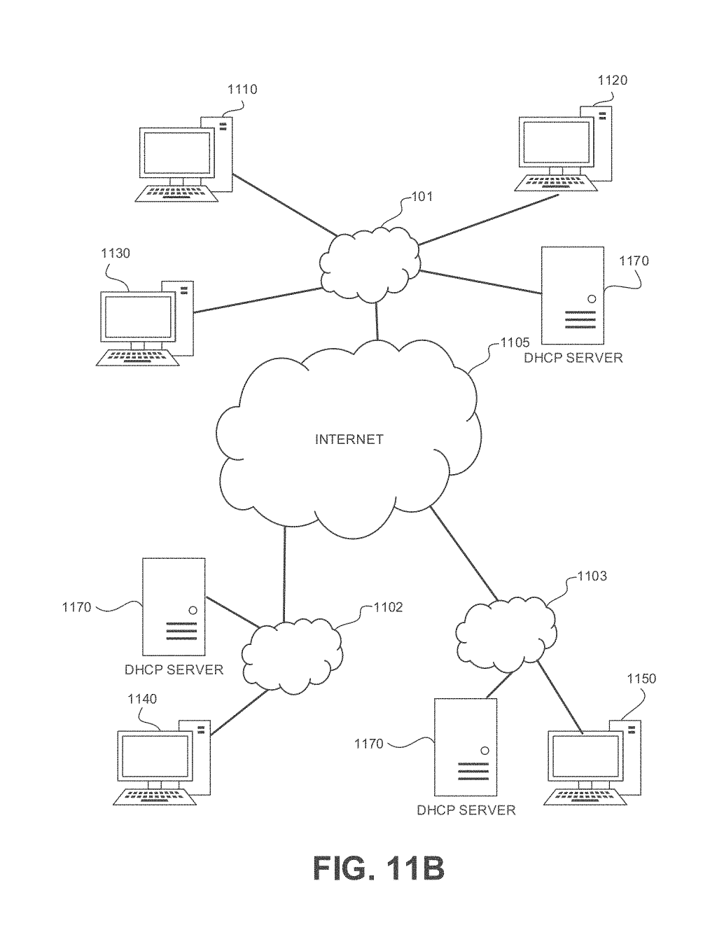

Referring now to FIG. 11A showing a computerized environment in which the disclosed subject matter is used, in accordance with some exemplary embodiments of the subject matter.

In some exemplary embodiments, a plurality of devices may be connected via a Computer Network 1100, such as Devices 1110-1150. Computer Network 1100 may comprise one or more servers, such as Server 1160 and DHCP Server 1170. Computer Network 1100 may be a telecommunications network which allows Devices 1110-1150 and Servers 1160-1170 to share resources. Devices 1110-1150 and Servers 1160-1170 may exchange data with each other using data links. The connections between Devices 1110-1150 and Servers 1160-1170 may be established using either a wired connection, a wireless connection, or combination thereof. In some exemplary embodiments, Computer Network 1100 may be an intranet network of an organization. Computer Network 1100 may be connected to an external network, such as the Internet (not shown). In some cases, Computer Network 1100 may be connected to the external network by a router, switch, server or a similar network device. In some exemplary embodiments, the network device may be configured to provide some security measures to prevent malicious activity. In some exemplary embodiments, the network device may provide a functionality of a firewall monitoring incoming and outgoing communications in and from Computer Network 1100. Computer Network 1100 may support different protocols, applications and services. In some exemplary embodiments, Computer Network 1100 may enable sharing of resources between devices connected thereto, such as a shared storage space, a shared printer, or the like.

In some exemplary embodiments, Devices 1110-1150 may be computerized devices such as personal computers, smartphones, servers, networking hardware or the like. Two such devices may be networked together when one device is able to exchange information with the other device, whether or not they have a direct connection to each other.

In some exemplary embodiments, a portion of Devices 1110-1150 and Servers 1160-1170 connected via Computer Network 1100 may communicate as a sub-network, such as for example, Device 1110, Device 1120, Device 1140 and Server 1160. Devices of the sub-network may be configured to scramble and descramble communication ports. Each Device of the portion of devices may retain a certificate that is shared among all the members of the sub-network.

In some exemplary embodiments, the certificate may be a number. The certificate may be a number represented by a number of bits that is larger than a predetermined threshold, such as a 128-bit number, 256-bit number, 1024-bit number. As will be apparent to a person of ordinary skill in the art, the larger the number of bits used for the certificate, the less likely that a malicious entity will be able to independently obtain it based on observed communications in Computer Network 1100.

In some exemplary embodiments, the certificate may comprise a static encryption key. The static encryption key may be a fixed key that uniquely identifies the sub-network. In some exemplary embodiments, the fixed key may identify the organization in which the computerized environment operates in addition to or instead of the identification of the sub-network. Additionally or alternatively, the certificate may comprise a time-dependent encryption key. The time-dependent encryption key may be valid for a limited time duration. In some exemplary embodiments, the time-dependent encryption key may be replaced routinely, such as periodically. In some exemplary embodiments, the certificate may comprise a combination of keys, such as a time dependent key that is updated periodically, and a fixed key that is constant.

In some exemplary embodiments, the certificate may be distributed to the portion of devices by Server 1160. Additionally or alternatively, a device in the sub-network that is deemed as a leader device may be responsible to distribution of the certificate. In some exemplary embodiments, the leader device may be selected using a quorum-based protocol. Additionally or alternatively, a group of two or more devices may operate in conjunction to distribute the certificate in the sub-network. Additionally or alternatively, the certificate may be obtained based on credentials provided by a user (not shown) of each device. In some exemplary embodiments, based on credential provides by the user, the certificate may be retrieved from a remote storage. Additionally or alternatively, the certificate may be generated based on the credentials. For example, a password provided by the user may be fed into a hash function, such as MD5, to generate the certificate. In some exemplary embodiments, the hash value generated based on the credentials may be used in conjunction with a static key, such as by concatenating the bits of the hash value and the bits of the static key, by performing a mathematical operation on the static key and the hash value (e.g., multiplying the hash value by the static key), or the like.

In some exemplary embodiments, the certificate may be used as part of a transformation function associated with the sub-network. In some exemplary embodiments, the transformation function may be a function receiving two parameters: a certificate to be used for the transformation and a value to perform the certificate-based transformation. Additionally or alternatively, the transformation function may be hard-coded to utilize the certificate and if the certificate is modified, a different function may be used instead thereof. Each device in the sub-network may apply the transformation function on identifiers of ports of outgoing communications of the device to obtain transformed ports. The device may transmit its outgoing communications via the transformed ports. Each device in the sub-network may apply a reverse function of the transformation function on identifiers of ports of incoming communications of the device to obtain transformed ports. The device may process its incoming communications as if received via the transformed ports. When transmitting an outgoing communication via a transformed port, in case the target device is a member of the sub-network, the target device may be enabled to perform reverse transformation on an identifier of the transformed port to obtain the identifier of the original port of the outgoing communication, and process it correctly. In case the target device is not a member of the sub-network, the target device may not process the outgoing communication in the correct, original port. In some exemplary embodiments, if a device of the sub-network obtains an incoming communication from a source device which is not a member of the sub-network, the device may not be able to correctly process the incoming communication, as it may attempt to descramble the port using the reverse transformation function, although the port may not be scrambled or may be scrambled using a different certificate.

It will be noted that the transformation function and the reverse transformation function may be used interchangeably. The transformation function is, in fact, a reverse function of the reverse transformation function.

As a non-limiting example, consider the sub-network comprising Devices 1110, 1120 and 1140. Devices 1110, 1120 and 1140 may each retain the shared certificate. Other devices such as Device 1130 and Device 1150, may not retain the shared certificate. It may be noted that Device 1130 and Device 1150 may, in some embodiments, be members of another sub-network and accordingly may retain another shared certificate. Assuming, for example, the Device 1110 intends to transmit an outgoing communication via port 1562 to a Device 1120. Prior to the transmission, Device 1110 may scramble port 1562 using the transformation function (that is based on the shared certificate) to obtained a scrambled port number. For example, the scrambled port number may be 2503. Device 1110 may transmit the outgoing communication to the target device via the scrambled port (i.e., port 2503). Device 1120 may obtain the outgoing communication as an incoming communication which is received in the scrambled port (port 2503). Prior to processing the payload of the incoming communication, Device 1120 may apply the reverse transformation function to obtain a descrambled port. As the reverse transformation function of Device 1120 is based on the same certificate that the transformation function of Device 1110 is based on, the descrambled port will be the original port (port 1562). As a result, Device 1120 may correctly process the incoming communication via the original port, as was originally intended.

Consider that Device 1110 instead transmits the outgoing communication to Device 1130 who is not a member of the sub-network. Device 1130 may be incapable of correctly descrambling the scrambled port. In some exemplary embodiments, Device 1130 may attempt processing the communication in the scrambled port (port 2503). Additionally or alternatively, Device 1130 may attempt to descramble the scrambled port. However, as the descrambling may be based on a function that uses a different certificate than the certificate used by Device 1110, the descrambled port may be a different port than the original port (for the sake of example, port 3999).

Similarly, in response to receiving an incoming communication, Device 1110 may descramble the port of the incoming communication. The descrambling may be performed by applying the reverse transformation function that is based on the certificate, on an identifier of the port of the incoming communication to obtain an identifier of a descrambled port. Device 1110 may process the incoming communication as if received via the reversed port. The payload of the incoming communication may be processed correctly if the descrambled port is the original port, such as if Device 1120 had transmitted the incoming communication after scrambling its port using the transformation function that is based on the certificate. Additionally or alternatively, the payload may be processed incorrectly if the port was not scrambled or if the port was scrambled using a different certificate-based transformation function.

In some exemplary embodiments, server communications, such as DHCP communications transmitted to or received by DHCP Server 1170, communications to and from email servers, communications to and from web servers, or the like, may be excluded from the above mentioned process. The server may be configured to communicate with different devices of potentially different sub-networks and/or devices not comprised by any sub-network. For example, DHCP Server 1170 may be configured to manage IP addresses of computing devices of Computer Network 1100.

In order to preserve such functionality without having a dedicated DHCP Server 1170 for the sub-network, devices of the sub-network, such as Device 110, may be configured to transmit server outgoing communications without applying the transformation function on identifiers of ports thereof. Additionally or alternatively, devices of the sub-network, such as Device 1110, may be configured to process incoming server communications without applying the reverse transformation on identifiers of ports of the incoming server communications. In some exemplary embodiments, Device 1110 may be configured to identify server communications based on their port identifiers. As an example, DHCP communications may be transmitted and received via User Datagram Protocol (UDP) ports. Device 1110 may be configured to identify that an outgoing communication is a DHCP communication based on the UDP port number of the destination port being a port number of a server, i.e. 67; and that an incoming communication is a DHCP communication based on the UDP port number of the source port being a port number of a server, i.e. 68. Additionally or alternatively, Device 1110 may be configured to identify server communication based on adherence of their payload to a predetermined protocol. For example, the payload may be examined to identify network configuration parameters, addresses, structure, headers, or the like.

In some exemplary embodiments, a device belonging to the sub-network, such as Device 1110, may communicate with a device excluded from the portion of devices, such as Device 1150, despite not belonging to the same sub-network. Device 1110 may be configured to determine communication directed to and from Device 1150, based on being addressed to and from the IP address of Device 1150. Device 1110 may transmit communications to Device 1150 without applying the transformation function on identifiers of their ports; and to process incoming communications without applying reverse transformation function on identifiers of their ports. Additionally or alternatively, communications between Device 1110 and Device 1150 may be performed using scrambling and descrambling of ports based on a second certificate that is shared between Device 1110 and Device 1150.

In some exemplary embodiments, Device 1110 may retain a blacklist of programs, allowing transmissions without encoding using the transformation of the ports. The device may transmit outgoing communications of program comprised by the blacklist, without applying the transformation function on identifiers of their port. In case, the destination device of the not a member of the portion of devices, the destination device may be enabled to correctly process the outgoing communications of the program as transmitted and received via the original ports. Non-limiting examples of programs in the blacklist may be Internet browsers, e-mail clients, or the like. In some exemplary embodiments, the blacklist may comprise programs that are configured to communicate with servers outside the sub-network, such as a third-party servers, servers serving devices from different sub-networks, or the like. Additionally or alternatively, other programs may be listed in the blacklist, such as based on manual identification of administrators, based on automatic rules, or the like.

In some exemplary embodiments, Device 1130 and Device 1150 may form a second sub-network within Computer Network 1100. Device 1130 and Device 1150 may retain a second certificate. A second transformation function and a second reverse transformation function depending on the second certificate may be utilized by Device 1130 and Device 1150 to privately communicate by transforming ports of outgoing communications and reversely transforming ports of incoming communications. Devices 1110, 1120, and 1150 may be unable to correctly process communications from Device 1130 and Device 1150, if ports thereof are scrambled using the second transformation function.

In some exemplary embodiments, the certificate retained by Device 1110 may be replaced with the second certificate that is associated with the second sub-network. Accordingly, Device 1110 may be logically migrated from the sub-network to the second sub-network. In some exemplary embodiments, Device 1110 may be able to correctly communicate with devices of the second sub-network and no longer be able to correctly communicate with the devices of the sub-network.

In some exemplary embodiments, Server 1160 may send Device 1110 the second certificate. The decision to migrate Device 1110 may be automatic based on rules or configurations. Additionally or alternatively, the decision to migrate Device 1110 may be made by an administrator or by a user of Device 1110. In some exemplary embodiments, Server 1160 may update configurations of Device 1110 based on the configurations of the second sub-network, such as update the blacklist. Additionally or alternatively, Server 1160 may update exception rules for Device 1110, such as delete a previously existing exception rule regarding communication with Device 1130 (e.g., previously a device that was not a member of the same sub-network as Device 1110 and which is a member of Device 1110's current sub-network).

Additionally or alternatively, Device 1110 may obtain the second certificate from another source different than Server 1160. For example, a user of Device 1110 may provide credentials associated with the second sub-network, such as a shared password that is shared by the users of the devices of the second sub-network.

In some exemplary embodiments, similarly to Devices 1100-1150, Server 1160 may comprise Processor(s) (not shown), I/O Module (not shown) and Memory (not shown). Server 1160 may be configured to generate and distribute certificates among a plurality of computing devices in Computer Network 1100. Additionally or alternatively, Server 1160 may be configured to generate and distribute the time-dependent key in a periodic manner, such as every one hour, every ten minutes, or the like. In some exemplary embodiments, Server 1160 may be configured to maintain and updating blacklist of programs of Device 1150 or other devices in Computer Network 1100.

Referring now to FIG. 11B showing a computerized environment in which the disclosed subject matter is used, in accordance with some exemplary embodiments of the subject matter.

In some exemplary embodiments, each device may be directly connected to one of Computer Networks 1101-1103. Computer Networks 1101-1103 may be characterized by its physical capacity or its organizational purpose. Use of each computer network, including user authorization and access rights, may differ accordingly. Computer Networks 1101-1103 may be Personal Area Networks (PAN), Local Area Networks (LAN), Wide Area Networks (WAN), Home Area Networks (HAN), Storage Area Networks (SAN), Campus Area Networks (CAN), Metropolitan Area Network (MAN), Virtual Private Network (VPN), Global Area Network (GAN), or the like.

In some exemplary embodiments, Computer Networks 1101-1103 may be connected via the Internet 1105. Internet 1105 may be a global system of interconnected computer networks such as Computer Networks 1101-1103. Internet 1105 may be based on the networking technologies of the Internet Protocol suite. Internet 1105 may connect between Devices 1110-1150 and DHCP Servers 1170 connected to different Computer Networks 1101-1103 via a common routing technology using routers.

In some exemplary embodiments, Devices 1110-1150 may be interconnected to one another via the aggregation of computer networks. In some exemplary embodiments, Devices 1110-1150 may be connected to one another via a WAN that is composed of several LANs, such as Computer Networks 1101, 1102, 1103. Each LAN may be managed separately, such as by a different administrator, using a different

DHCP server 1170, or the like.

In some exemplary embodiments, Devices 1110, 1120 and 1140, which are not directly connected to the same computer network, may be function as a sub-network. Devices 1110, 1120 and 1140 may communicate therebetween by scrambling and descrambling ports of their communication.

In some exemplary embodiments, the sub-network may be maintained by a cloud-based server (not shown) with which all devices may communicate. The cloud-based server may be configured to distribute the shared certificates and other configuration files, update the certificates and configuration files, or the like. In some exemplary embodiments, a user of Device 1110 attempting to connect to a sub-network, may access a web portal. The user may provide her credentials in the web portal. The cloud-based server may verify the credentials to determine whether the user is authorized. In case the user is authorized, the cloud-based server may transmit the certificate to Device 1110.

Additionally or alternatively, connecting to the sub-network may maintained in a distributed manner without having a centric server. The user of Device 1110 may provide her credentials. The credentials may be transformed, such as using a hash function, into a certificate having a static key. The generated certificate may be used in the communications of Device 1110, thereby effectively allowing Device 1110 to communicate correctly with all other devices whose users provided the same credentials.

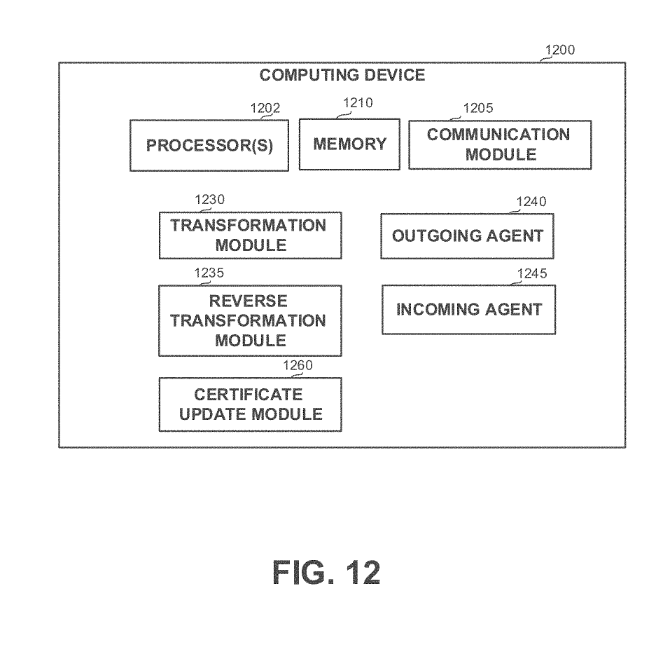

Referring now to FIG. 12 showing a computing device in accordance with some exemplary embodiments of the disclosed subject matter.

A Computing Device 1200, such as Device 1110 of FIG. 11A, may be configured to operate within a computer network, such as Computer Network 1100 of FIG. 11A.

In some exemplary embodiments, Computing Device 1200 may be operated by a user (not shown). Computing Device 1200 may provide an output to and receive input from the user, such as, for example, receiving credentials, updating configuration files, adding or removing exception rules, adding programs to black lists, or the like.

In some exemplary embodiments, Computing Device 1200 may comprise one or more Processor 1202. Processor 1202 may be a Central Processing Unit (CPU), a microprocessor, an electronic circuit, an Integrated Circuit (IC) or the like. Processor 1202 may be utilized to perform computations required Computing Device 1200 or any of it subcomponents.

In some exemplary embodiments, Computing Device 1200 may comprise a Communication Module 1205. Computing Device 1200 may utilize Communication Module 1205 as an interface to transmit and/or receive information and instructions between Computing Device 1200 and external devices. In some exemplary embodiments, Communication Module 1220 may be utilized by Computing Device 1200 for sending and receiving transmissions to and from devices in the computer network.

In some exemplary embodiments, Computing Device 1200 may comprise a Memory 1210. Memory 1210 may be a hard disk drive, a Flash disk, a Random Access Memory (RAM), a memory chip, or the like. In some exemplary embodiments,

Memory 1210 may retain program code operative to cause Processor 1202 to perform acts associated with any of the subcomponents of Computing Device 1200.

Memory 1207 may comprise one or more components as detailed below, implemented as executables, libraries, static libraries, functions, or any other executable components.

In some exemplary embodiments, Memory 1210 may retain a certificate. The certificate may be shared among a portion of the plurality of devices comprised by the computer network. In some exemplary embodiments, the certificate may be a static encryption key, a time-dependent encryption key, a combination of static and time-dependent keys, or the like.

In some exemplary embodiments, the certificate may be distributed to the portion of the plurality of devices by a server connected to the computer network, such as Server 160 in FIG. 1A or a cloud-based server. The server may distribute and synchronize time-dependent encryption keys used as the certificate, a part of the certificate, or the like.

Additionally or alternatively, the certificate may be generated based on credentials provided by a user of Computing Device 1200, such as but not limited to a password provided by the user. In such a case, the certificate may not be distributed over the computer network, but rather privately generated at each end-point.

In some exemplary embodiments, Memory 1210 may retain exception rules for

Computing Device 1200. The exception rules may define rules for determining when an outgoing communication or an incoming communication is not to be scrambled or descrambled, respectively. The exception rules may include a blacklist of programs, whose outgoing communications are not to be scrambled. It will be noted that the blacklisted programs may or may not be actually installed on Computing Device 1200 or may not be executed by Device 1200 at any time. The exception rules may include protocols, ports, patterns of payloads, which indicate a communication that is not to be scrambled/descrambled, such as relating to DHCP, Simple Mail Transfer Protocol (SMTP), HyperText Transformation Protocol (HTTP), Internet Message Access Protocol (IMAP), Web Calendar Access Protocol (WCAP), or the like. The exception rules may include IP addresses of devices which are handled in a different manner, either by avoiding scrambling/descrambling, or by scrambling/descrambling using a different certificate.

In some exemplary embodiments, Computing Device 1200 may comprise a Transformation Module 1230. Transformation Module 1230 may be configured to apply a transformation function on identifiers of ports associated with outgoing communications to obtain identifiers of scrambled ports. In some exemplary embodiments, the transformation function may depend on the certificate. Additionally or alternatively, Transformation Module 1230 may use the certificate as a parameter of the transformation function. The transformation function may be a symmetric cryptography function, such as Data Encryption Standard (DES), Advanced Encryption Standard (AES), Blowfish, or the like.

In some exemplary embodiments, Computing Device 1200 may comprise a Reverse Transformation Module 1235. Reverse Transformation Module 1235 may be configured to apply a reverse transformation function on identifiers of ports of incoming communication of Computing Device 1200, to obtain identifiers of descrambled ports. In some exemplary embodiments, the reverse transformation may be a reverse function of the transformation function. The reverse transformation function may depends on the certificate, may use the certificate as a parameter, or the like.

In some exemplary embodiments, Computing Device 1200 may comprise an Outgoing Agent 1240. Outgoing Agent 1240 may be configured to obtain outgoing communications from programs of Computing Device 1200. Outgoing Agent 1240 may be configured to selectively invoke Transformation Module 1230 on an identifier of a target port of an outgoing communication to obtain an identifier of a second target port. Outgoing Agent 1240 may be configured to provide a modified outgoing communication to Communication Module 1220 for being transmitted to a target device via the second target port. In case the target device is a member of a sub-network, the target device may be enabled to utilize her Incoming Agent 1245 to perform reverse transformation on the identifier of the second target port to obtain the identifier of the target port of the outgoing communication.

In some exemplary embodiments, Outgoing Agent 1240 may be configured to monitor outgoing server communications. Outgoing Agent 1240 may be configured to provide a server outgoing communication to Communication Module 1220 to transmit the server outgoing communication, without invoking Transformation Module 1230. In some exemplary embodiments, Outgoing Agent 1240 may be configured to identify the server outgoing communication based on a port identifier of the server outgoing communication. In some applications, Computing Device 1200 and the server each may use specific port numbers assigned by the Internet Assigned Numbers Authority (IANA).

As an example, one type of server communications may be communication to and from the Internet mail system, which is a server used for sending and receiving emails. Computing Device may transport email to and from the server with the SMTP. By default, the SMTP service application may listen on TCP port 25 for incoming requests. Additionally or alternatively, Computing Device may transport emails to and from the server using the Post Office Protocol (POP) which is used by e-mail clients to fetch email messages from the server. By default, the POP service may listen on TCP port number 110.

Further, Outgoing Agent 1240 may be configured to identify the server outgoing communication based on adherence of a payload of the server outgoing communication to a predetermined protocol.

In some exemplary embodiments, the server outgoing communication may be a communication directed at a DHCP server. DHCP may be a standardized network protocol used on IP networks. DHCP may be controlled by a DHCP server that dynamically distributes network configuration parameters, such as IP addresses, for interfaces and services. The DHCP server may enable devices to request IP addresses and networking parameters automatically, reducing the need for a network administrator or a user to configure these settings manually. The DHCP server may be capable of managing the IP addresses in the computer network. The DHCP server may be capable of assigning a first IP address to Computing Device 1220 and a second IP address to a second device which does not retain the certificate. Outgoing Agent 1240 may be configured to identify communications directed to DHCP server, based on the specific port numbers assigned by the IANA to DHCP, in which the Computing Device 1200 may use UDP port 68 and the DHCP server may use UDP port 67. Further, Outgoing Agent 1240 may be configured to identify communications directed to DHCP server, based on adherence of a payload of the communications, such as requests for assigning IP addresses or the like.

In some exemplary embodiments, Outgoing Agent 1240 may be configured to implement any exception rule retained in Memory 1210, such as IP-based exception rules, protocol-based exception rules, or the like.

In some exemplary embodiments, Computing Device 1200 may comprise an Incoming Agent 1245 that is configured to obtain incoming communications received by Communication Module 1220. Incoming Agent 1245 may be configured to invoke Reverse Transformation Module 1235 on an identifier of a second source port of an incoming communication, wherein the incoming communication was transmitted by a source device, whereby an identifier of a first source port may be obtained. Incoming Agent 1245 may be configured to output a modified incoming communication directed at the first source port instead of the second source port. In case the source device is not a member of the portion of the plurality of devices, the device may not be able to correctly process the incoming communication.

In some exemplary embodiments, similarly to Outgoing Agent 1240, Incoming Agent 1245 may be configured to implement any exception rule retained in Memory 1210. As an example, Incoming Agent 1245 may be configured to process incoming server communication of Computing Device 1200. Incoming Agent 1245 may be configured to provide a server incoming communication, without invoking Reverse Transformation Module 1235. In some exemplary embodiments, Incoming Agent 1245 may be configured to identify the server incoming communication based on a port identifier of the server incoming communication. Further, Incoming Agent 1245 may be configured to identify the server incoming communication based on adherence of a payload of the server incoming communication to a predetermined protocol.

In some exemplary embodiments, Outgoing Agent 1240 and Incoming Agent 1245 may be implemented as part of a driver of a hardware communication component of Computing Device 1200. The driver may intercept and analyze any outgoing packet before its transmission. The driver may modify the outgoing packet, such as by changing the port number, and allow the hardware communication component to transmit the modified packet. Similarly, the driver may intercept and analyze any incoming packet before its processing by the target component of Computing Device 1200. The driver may modify the incoming packet, such as by changing the port number, and provide the modified incoming packet for processing. In such an embodiment, Communication Module 1205 may be implemented, at least in part, by the hardware communication component.

In some exemplary embodiments, Memory 1210 may retain an IP address of a second device. The second device may operate within the computer network. The second device may not be a part of the portion of the plurality of devices that constitute the sub-network. Outgoing Agent 1240 may be configured to determine that a second outgoing communication is directed to the second device, based on the second outgoing communication being addressed to the IP address. Outgoing Agent 1240 may be configured to provide the second outgoing communication to Communication Module 1220 for transmission, without invoking said Transformation Module 1230, allowing a direct connection between Computing Device 1220 and the second device, without being in the same sub-network. In some exemplary embodiments, Incoming Agent 1245 may be configured to determine that a second incoming communication was transmitted by the device having the IP address. Incoming Agent 1245 may be configured to process the second incoming communication without invoking Reverse Transformation Module 1235.

In some exemplary embodiments, A Certificate Updating Module 1260 may be configured to replace the certificate with a second certificate. The second certificate may be shared among a second portion of the plurality of devices. In response to Certificate Updating Module 1260 updating the certificate, the transformation function of Transformation Module 1230 and the reverse transformation function of Reverse Transformation Module 1235, may be updated to utilize the second certificate for the transformation or reverse transformation, respectively. In such a case, Computing Device 1200 may be enabled to communicate with devices comprised by the second portion of the plurality of devices using Transformation Module 1230 and Reverse

Transformation Module 1235. In some exemplary embodiments, Certificate Update Module 1260 may be configured to delete the certificate from Memory 1210 and store the second certificate in Memory 1210. In some exemplary embodiments, Certificate Update Module 1260 may be invoked based on a command of a user of Computing Device 1200, based on an application of an automated rule, based on a remote command from a remote server, such as a cloud-based server, or the like. The remote command may be invoked based on a rule, based on a command from a system administrator maintaining the sub-network, or the like.

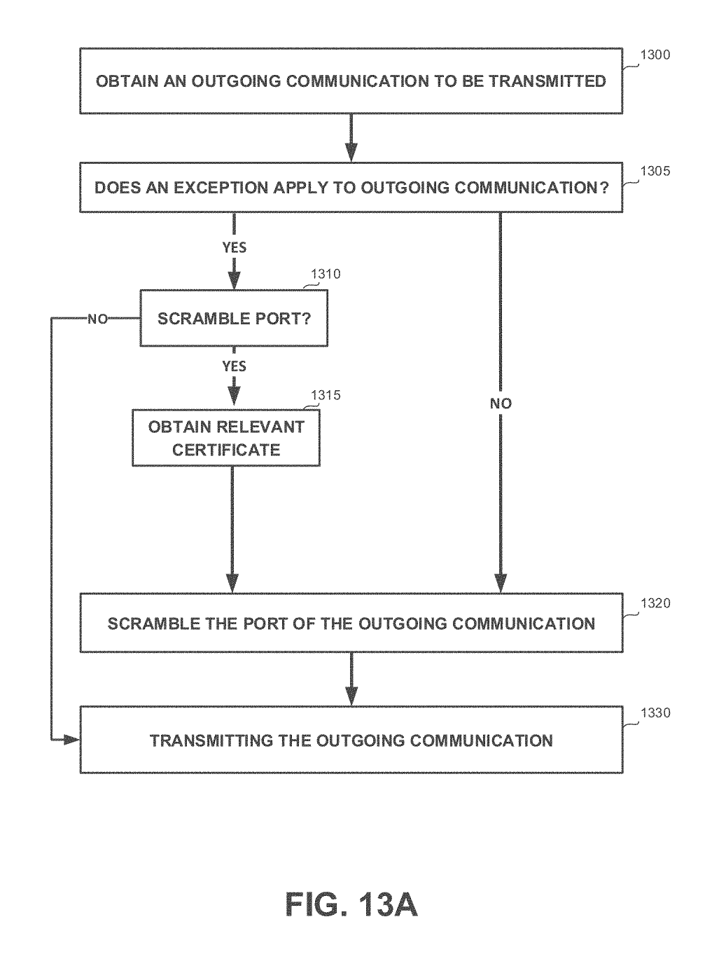

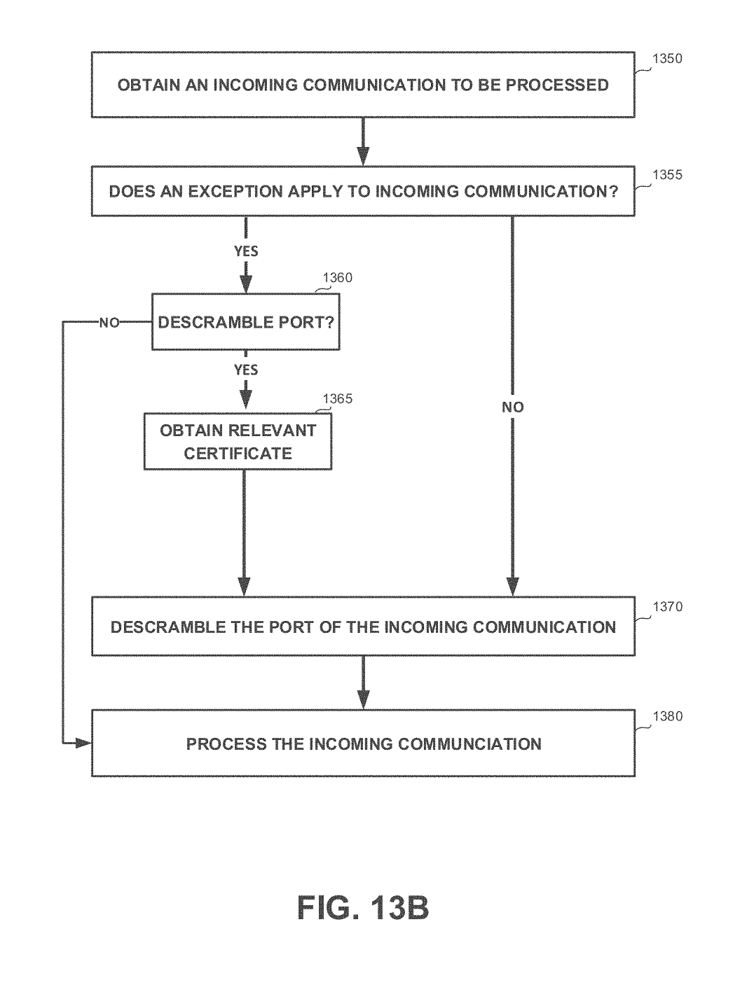

Referring now to FIG. 13A showing a flowchart diagram of a method in accordance with some exemplary embodiments of the disclosed subject matter. The method of FIG. 13A may be performed by device, such as Computing Device 1200 of FIG. 12.

On Step 1300, an outgoing communication to be transmitted may be obtained. In some exemplary embodiments, the outgoing communication may be received from an application program requesting to transmit the outgoing communication.

The outgoing communication may be designated to be received at a destination via a first port. The destination may be a destination external to the computerized apparatus, e.g. another device. As an example, the destination of a UDP packet may be provided as an IP address and a port (e.g., 192.168.1.52:80).

On Step 1305, a determination whether an exception applies to the outgoing communication may be made. In some exemplary embodiments, one or more potential exceptions may be hard coded. Additionally or alternatively, one or more potential exceptions, or parameters thereof, may be retained in memory of the device executing the method.

One example of an exception may be that the application program requesting to transmit the outgoing communication is an authorized program. In some exemplary embodiments, authorized programs of the computing device may be programs or applications authorized to transmit and receive communication without scrambling, in order to be able to effectively communicate with other devices on the same network that are not a part of sub-network. The determination may be accomplished by consulting a list of authorized programs, such as the blacklist described in the context of FIG. 12.

Another example of an exception may be that the outgoing communication is a server communication, such as for example, a communication directed to a DHCP server. Server communication may be transmitted and received without scrambling. The determination may be accomplished by identifying that the first port is a port of a server communication, based on adherence of a payload of the outgoing communication to a predetermined protocol, or the like.

Yet another example of an exception may be that the outgoing communication is directed to an authorized destination device. The authorized destination device may not be a part of the sub-network. In some exemplary embodiments, the computerized apparatus may communicate with the authorized destination device without scrambling communications there-between. Additionally or alternatively, the computerized apparatus may communicate with the authorized destination device by scrambling communication before transmitting, based on a second certificate. The determination may be accomplished by identifying a match between the destination IP address and an

IP address of the authorized destination device retained by the computerized apparatus.

In case, an exception applies, Step 1310 may be performed. Step 1320 may be performed for all communications for which no exception applies.

On Step 1310, a determination whether or not the port of the outgoing communication should be scrambled is made. In case the exception stipulates that no scrambling is performed, Step 1330 may be performed, and the outgoing communication may be transmitted without scrambling its port. In case the exception stipulates that scrambling is to be performed but in a different manner, Step 1315 may be performed.

On Step 1315, a certificate may be obtained. The certificate may be different than the certificate shared by the sub-network. The certificate may be a certificate that deemed relevant for the exception which applies. In some exemplary embodiments, the relevant certificate may be shared between the computerized apparatus and the authorized destination device, and used in communications therebetween. In some exemplary embodiments, the relevant certificate may be retained by the memory of the device along with the IP address of the authorized destination device for which it is relevant. Additionally or alternatively, the relevant certificate may be obtained from a user of the authorized destination device.

On Step 1320, the port toward which the outgoing communication is directed at may be scrambled based on the certificate. In some exemplary embodiments, the port may be scrambled by applying a transformation function on an identifier of the port to obtain an identifier of an alternative port. The transformation function may depend on the certificate shared among the portion of devices, and may be utilized by each device of the portion of devices to perform the scrambling. The certificate used in Step 1320 may be the shared certificate of the sub-network. Additionally or alternatively, in case of an exception which applies, the certificate used for the port scrambling may be the certificate obtained in Step 1315. Step 1320 may modify the outgoing communication and provide a modified outgoing communication that is direct at the scrambled port. The modified outgoing communication may be transmitted instead of the outgoing communication.

On Step 1330, the outgoing communication may be transmitted to the destination device. The outgoing communication may either be a modified outgoing communication if Step 1320 was performed, or the original outgoing communication if Step 1320 was not performed.

In case Step 1320 is performed, the outgoing communication may be directed to be received at the destination device via the scrambled port. In some exemplary embodiments, if the destination device is a member of the sub-network, the destination device may retain the certificate, and may be able to descrambling the port. Otherwise, the target device may not descramble the scrambled port, or may perform a different reverse transformation on the scrambled port; and may not be able to correctly process the outgoing communication.

Additionally or alternatively, if the destination device is an authorized destination device, a server, or another device for which an exception applies, the outgoing communication may be correctly processed by the destination device, albeit the destination device may not retain the shared certificate of the sub-network.

Referring now to FIG. 13B showing a flowchart diagram of a method in accordance with some exemplary embodiments of the disclosed subject matter. The method of FIG. 13B may be performed by device, such as Computing Device 1200 of FIG. 12.

On Step 1350, an incoming communication to be processed may be obtained. In some exemplary embodiments, the incoming communication may be received from a source device, such as Device 110 of FIG. 1A. The source device may operate within the computer network comprising the computerized apparatus receiving the incoming communication. Source device may or may not be a member of a sub-network. Members of the sub-network may communicate by selectively scrambling ports based on a shared certificate. The incoming communication may be designated to be received via a first port.

On Step 1355, a determination whether an exception applies to the incoming communication may be made.

One example of an exception may be that the application program who had transmitted the incoming communication from the source device is an authorized program, such as an incoming mail server communication, an incoming web server communication, or the like. The determination may be accomplished by consulting a list of authorized programs, such as the blacklist described in the context of FIG. 12, or based on a payload of the incoming communication.

Another example of an exception may be that the incoming communication is a server communication, such as for example, a communication originating from a DHCP server, a webserver, an email server, or the like. Server communication may be transmitted and received without scrambling. The determination may be accomplished by identifying that the first port is a port of a server communication, based on adherence of a payload of the outgoing communication to a predetermined protocol, or the like.

Yet another example of an exception may be that the outgoing communication transmitted from an authorized source device that is not a part of the sub-network. In some exemplary embodiments, the device may process communications from the authorized destination device without descrambling their ports. Additionally or alternatively, descrambling may be performed using a different certificate.

On Step 1360, a determination may be made as to whether the exception which applies stipulates that the incoming communication is or is not to be scrambled. In case the port is not to be descrambled, Step 1380 may be performed. Otherwise, Step 1365 may be performed.

On Step 1365, a certificate that is relevant for the exception may be obtained. In some exemplary embodiments, the relevant certificate may be shared between the device and the authorized source device, and may be retained by the memory of the device along with the IP address of the authorized source device. Additionally or alternatively, the relevant certificate may be obtained from a user of the authorized destination device.

On Step 1370, the port via which the incoming communication has been received may be descrambled. In some exemplary embodiments, the port may be descrambled by applying a reverse transformation function on an identifier of the first port to obtain an identifier of an alternative port. In case no exception applies, the certificate used for the reverse transformation may be a default certificate which is shared among the sub-network. In case an exception does apply, the relevant certificate obtained on Step 1365 may be utilized.

On Step 1380, the incoming communication may be processed. In case the port was not descrambled, the incoming communication may be processed in its original port. In case the port was descrambled, the incoming communication may be processed as if received in the descrambled port.

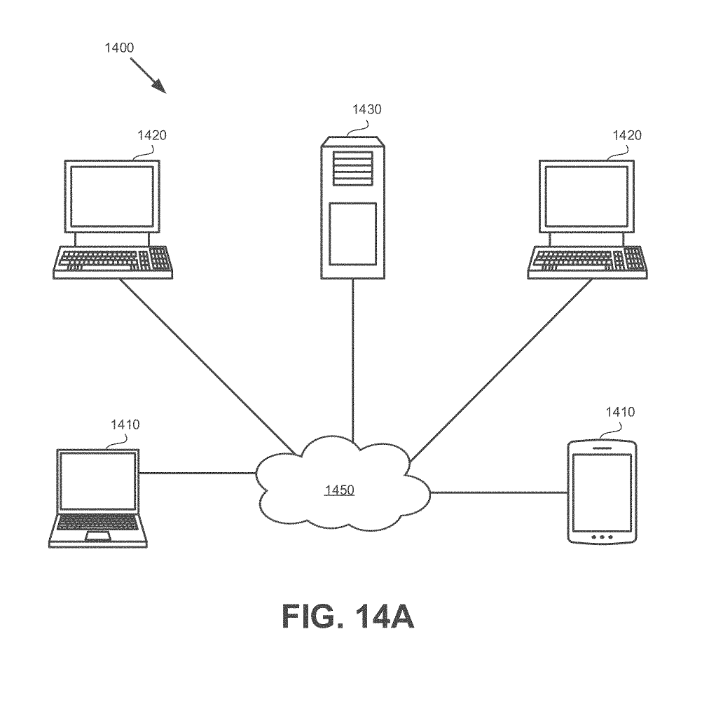

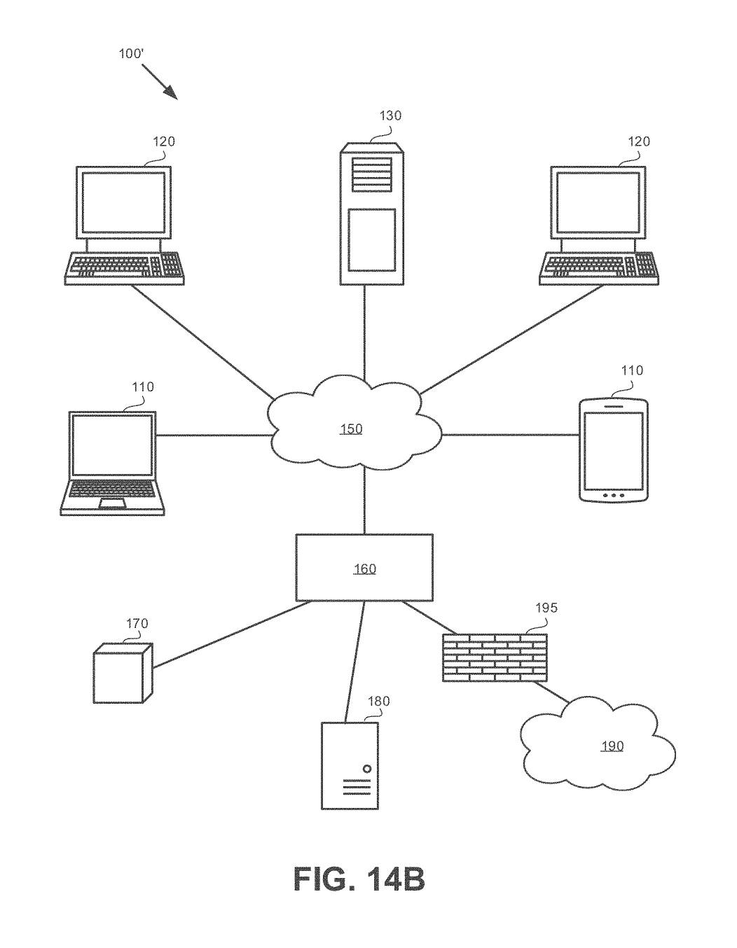

Referring now to FIG. 14A showing a schematic illustration of a computer network, in accordance with some exemplary embodiments of the disclosed subject matter.

In some exemplary embodiments, a Computer Environment 1400 may comprise a plurality of computing devices, such as 1410, 1420 and 1430, which may be connected via a Network 1450. Devices 1410, 1420, 1430 may be interconnected to one another, either by common access to a server (e.g., Server 1430) or directly, such as through using a network switch, a hub, or the like.

In some exemplary embodiments, Network 1450 may be an intranet network of an organization. Network 1450 may be connected to an external network, such as the Internet (not shown). In some cases, Network 1450 may be connected to the external network by a router, switch, server or the like, which may or may not be configured to provide some security measures to prevent malicious activity. In some exemplary embodiments, the switch may comprise a firewall for preventing access of undesired entities.

Devices 1410, 1420, 1430 may be general purpose processing devices, such as, for example, a desktop computer, a server, a laptop computer, a tablet computer, a smartphone, or the like, being capable and permitted to execute application programs provided by third party developers, i.e. vendors other than a manufacturer of the device in question. Devices 1410, 1420, 1430 may be either devices that are temporarily connected to Network 1450, e.g. mobile devices such as Computers 1410, or devices permanently connected to Network 1450, e.g. desktop workstations such as Computers 1420, or server computers such as Server 1430.

Server 1430 may be a computerized server tasked with monitoring and protecting the security of Network 1450. In some exemplary embodiments, an IT professional may define an organizational policy, such as defining a whitelist of authorized programs, authorized uses of programs, a blacklist of unauthorized programs, or the like. Additionally, or alternatively, the policy may be automatically defined. Server 1430 may publish and distribute the policy to computers connected to Network 1450. Additionally, or alternatively, Server 1430 may publish and update an encryption key to be used for security-related operation. The encryption key may be modified periodically, such as about every one second, one minute, one hour, or the like.

In some exemplary embodiments, computers connected to Network 1450 may be configured to communicate using scrambled ports. Authorized outgoing communications, such as packets issued by authorized programs or under authorized conditions, may be processed and their ports may be scrambled, such as by using a transformation function. The transformation function may utilize shared parameters such as the whitelist, encryption key, or the like, so as to achieve the same results on different computers. As the encryption key may change periodically, the transformation function may yield different results for the same port at different times. The ports of unauthorized communications may not be scrambled, and these communications may be transmitted via the original ports. Additionally, or alternatively, the content of the packets may be encrypted. In some exemplary embodiments, computers connected to Network 1450 may be configured to descramble the ports of any incoming communication, using an inverse function of the transformation function. Hence, ports of authorized communications may be scrambled at transmission and descrambled at reception, yielding the original port, while ports of unauthorized communications are descrambled upon receipt without having been scrambled prior thereto, and therefore get directed at a wrong port in the receiving end. In some exemplary embodiments, scrambling and descrambling may be performed by a port scrambling agent, which may be implemented in software, hardware, combination thereof, or the like.

In some exemplary embodiments, communications in a network such as Network 1450 may go through a firewall. The firewall may not be configured to handle port scrambling/descrambling. In such case, the port scrambling agent may determine that the packet is directly transmitted to a firewall and avoid port scrambling of such packet. Additionally, or alternatively, a connected device receiving a packet directly from a firewall, may avoid performing port descrambling on the received packet. Similarly, the port scrambling agent may be configured to avoid scrambling when transmitting packets towards specific devices, such as sending packets towards a Voice over IP (VoIP) telephone, a printer, a network-connected time clock, or other devices which utilize the network connection but for which an agent may not be installed, e.g. an IoT device or the like. Additionally, or alternatively, the port scrambling agent may be configured to avoid descrambling ports of packets received from such devices. This course of action, however, may be disadvantageous as endpoint devices may get exposed to security risks.

Referring now to FIG. 14B showing a schematic illustration of a computer network in which the disclosed subject matter is used, in accordance with some exemplary embodiments of the disclosed subject matter.

In some exemplary embodiments, a Computer Environment 1400′ may comprise a plurality of computing devices, such as 1410, 1420 and 1430, connected via a Network 1450, similarly as Computer Environment 1400 of FIG. 14A. Network 1450 may be connected to a Gateway Apparatus 1460. Gateway Apparatus 1460 may be configured to receive and process all outgoing communications transmitted from the network to an outside destination and incoming communications directed to the network. Gateway Apparatus 1460 may be configured to scramble ports of incoming communications and descramble ports of outgoing communications. Gateway Apparatus 1460 may utilize the same transformation function and inverse transformation function utilized by Network 1450 for port scrambling and descrambling and same shared parameters utilized by the functions.

In some exemplary embodiments, Computer Environment 1400′ may comprise one or more simple devices provided with network connectivity but having limited capabilities otherwise, such as IoT Device(s) 1470. IoT device 1470 may not be configured to execute an agent for port scrambling and descrambling, due to being lacking an operating system or likewise support for execution of third-party application programs. IoT device 1470 may be connected to Gateway Apparatus 1460 and exchange communications with Network 1450 via Gateway Apparatus 1460. Gateway Apparatus 1460 may receive incoming communications directed to Network 1450 from IoT device 1470, scramble their ports utilizing the transformation function and forward them to Network 1450 to be received via the scrambled ports. Similarly, Gateway Apparatus 1460 may receive from Network 1450 outgoing communications directed to IoT device 1470, descramble their ports utilizing the inverse transformation function and forward them to IoT Device 1470 to be received via the descrambled ports.

In some exemplary embodiments, Computer Environment 1400′ may comprise a device that may be prohibited from executing an agent for port scrambling and descrambling, such as OT Device 1480. OT Device 1480 may be connected to Gateway Apparatus 1460 and exchange communications with Network 1450 via Gateway Apparatus 1460, similarly as IoT device 1470. Gateway Apparatus 1460 may be configured to receive incoming communications from OT Device 1480 to Network 1450 and outgoing communications from Network 1450 to OT Device 1480, scramble ports of incoming communications, descramble ports of outgoing communications, and forward the communications to their respective destination, similarly as with communications between Network 1450 and IoT device 1470.

It will be appreciated that secure communication between Network 1450 and IoT device 1470 or OT Device 1480 may be provided via Gateway Apparatus 1460, wherein Network 1450 may employ selective port scrambling by which only ports of authorized communications are scrambled, e.g. communications transmitted by programs listed in a whitelist of authorized programs. Gateway Apparatus 1460 may be configured to descramble ports of all outgoing communications sent from Network 1450, thereby ports of unauthorized, potentially malicious communications that have not been scrambled prior to arrival at Gateway Apparatus 1460, may be rendered improper by result of the descrambling by Gateway Apparatus 1460, such that when those communications arrive at IoT device 1470 or OT Device 1480 they are received via improper ports and therefore not handled. Additionally, or alternatively, incoming communications to Network 1450 arriving at Gateway Apparatus 1460 may be processed and their ports may be selectively scrambled, if they match a security policy defined for Network 1450. IoT device 1470 and OT Device 1480 may be connected to Gateway Apparatus 1460 via wired connection, encrypted wireless connection, or the like.

In some exemplary embodiments, Gateway Apparatus 1460 may be connected to one or more other networks, such as Network 1490. Network 1490 may be employing a regular non-secure communication protocol, or a secure communication protocol different from the port scrambling security protocol employed by Network 1450, such as, for example, port scrambling utilizing different transformation function or different shared parameters. Additionally, or alternatively, Network 1490 may be a public network, such as, for example, the Internet, a wide area network (WAN), or the like. Gateway Apparatus 1460 may process outgoing communications from Network 1450, descramble their ports and transmit the modified communications, with the descrambled ports, to Network 1490. Additionally, or alternatively, incoming communications from Network 1490 to Network 1450 may be processed by Gateway Apparatus 1460 and their ports may be scrambled and forwarded to Network 1450 via the scrambled ports. In some exemplary embodiments, Gateway Apparatus 1460 may be configured to perform security analysis of the incoming communications. Gateway Apparatus 1460 may determine based on the security analysis whether to forward an incoming communication to Network 1450 or take other actions, such as, for example, discard the communication, transfer it to a sandbox or quarantined storage, report to a server monitoring the traffic in Network 1450, such as Server 1430, or the like.

In some exemplary embodiments, a Firewall 1495 may be deployed between Gateway Apparatus 1460 and Network 1490. Firewall 1495 may be configured to analyze packets directed outwards towards Network 1490 and packets directed inwards towards Network 1450. In some exemplary embodiments, Firewall 1495 may be configured to analyze the content of the packets when making its decision of whether to allow the packet to pass or not. In some cases, Firewall 1495 may be configured to drop packets received at improper ports. In some exemplary embodiments, Gateway Apparatus 1460 may process a packet received from Network 1450 to descramble its ports. If the port of the packet was not originally scrambled, the descrambled port may be an invalid port, and Firewall 1495 may drop the packet without analyzing the content of the packet. As a result, the resources of Firewall 1495 may not be exhausted on analyzing packets that are deemed unauthorized by Network 1450 and there may be a potentially significant increase of dozens of percentages in the bandwidth that is limited by the processing capability of Firewall 1495. In some exemplary embodiments, Firewall 1495 may be implemented as part of Gateway Apparatus 1460.

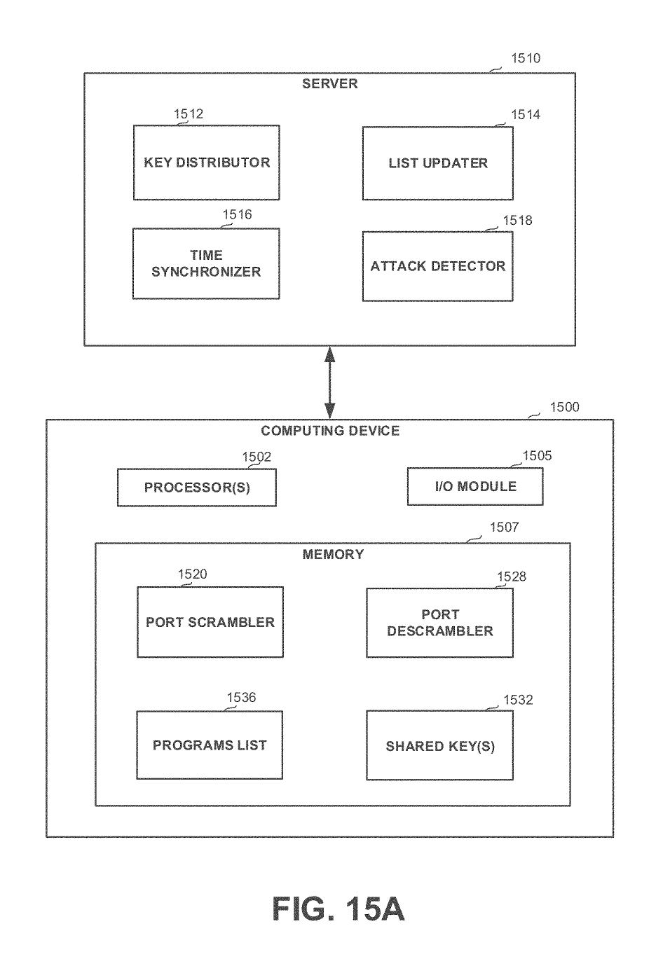

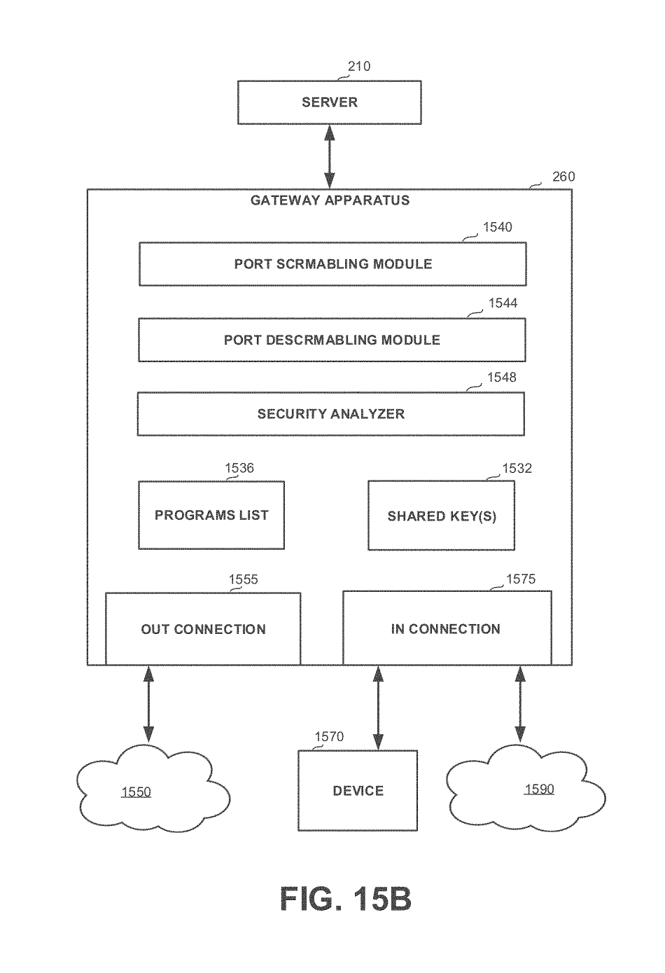

Referring now to FIG. 15A showing a block diagram of a system in accordance with some exemplary embodiments of the disclosed subject matter. The system comprises a Computing Device 1500, such as 1410, 1420 of FIG. 14A, and may be configured to perform selective port scrambling, in accordance with the disclosed subject matter. In some exemplary embodiments, the system further comprises a Server 1510, such as Server 1430 of FIG. 14A, which may be in communication with Computing Device 1500 via any suitable communication channel, such as an Ethernet switch connection or the like.

In some exemplary embodiments, Computing Device 1500 may comprise one or more Processor(s) 1502. Processor 1502 may be a Central Processing Unit (CPU), a microprocessor, an electronic circuit, an Integrated Circuit (IC) or the like. Processor 1502 may be utilized to perform computations required by Computing Device 1500 or any of its subcomponents.

In some exemplary embodiments of the disclosed subject matter, Computing Device 1500 may comprise an I/O Module 1505. The I/O Module 1505 may be utilized to provide an output to and receive input from a user. Additionally, or Alternatively, I/O Module 1505 may be utilized to provide output to and receive input from Server 1510 or another Computing Device 1500 in communication therewith, such as another one of Devices 1410, 1420 of FIG. 14A.

In some exemplary embodiments, Computing Device 1500 may comprise a Memory 1507. Memory 1507 may be a hard disk drive, a Flash disk, a Random-Access Memory (RAM), a memory chip, or the like. In some exemplary embodiments, Memory 1507 may retain program code operative to cause Processor 1502 to perform acts associated with any of the subcomponents of Computing Device 1500. Memory 1507 may comprise one or more components as detailed below, implemented as executables, libraries, static libraries, functions, or any other executable components.

Memory 1507 may comprise Port Scrambler 1520 which may comprise or be in communication with a Programs List 1536 and one or more Shared Key(s) 1532. Port Scrambler 1520 may be configured to selectively apply a port scrambling function on port numbers associated with outgoing communications. Port Scrambler 1520 may apply the port scrambling function responsive to receiving a request to transmit an outgoing communication from an application program listed on Programs List 1536 (and executed by Computing Device 1500). Port Scrambler 1520 may use Shared Key(s) 1532 as a parameter of the port scrambling function. Port Scrambler 1520 may obtain a scrambled port number by applying the port scrambling function on the port number identifying the destination of the outgoing communication. Port Scrambler 1520 may direct the outgoing communication to a destination identified by the scrambled port number.

Memory 1507 may comprise Port Descrambler 1528 which may comprise or be in communication with Shared Key(s) 1532. Port Descrambler 1528 may be configured to apply a port descrambling function on port numbers associated with incoming communications to Computing Device 1500. The port descrambling function may be an inverse function of the port scrambling function applied by Port Scrambler 1520. Port Descrambler 1528 may use Shared Key(s) 1532 as a parameter of the port descrambling function. Port Descrambler 1528 may receive an incoming communication at a port identified by a scrambled port number. Port Descrambler 1528 may obtain a descrambled port number (e.g., original port number) by applying the port descrambling function on the scrambled port number. In some exemplary embodiments, Port Descrambler 1528 may perform the descrambling on all incoming communications regardless of their origin. Port Descrambler 1528 may redirect the incoming communication to a port identified by the descrambled port number. Port Descrambler 1528 may issue a notification to Server 1510 in case that the descrambled port number is not assigned to any application program currently executing on Computing Device 1500.

Similarly to Computing Device 1500, Server 1510 may comprise Processor(s) (not shown), I/O Module (not shown) and Memory (not shown).

Server 1510 may comprise a Key Distributor 1512 for generating and distributing Shared Key(s) 1532 among a plurality of computing devices, such as Computing Device 1500, in a computer network environment such as Computer Environment 1400 of FIG. 14A. Key Distributor 1512 may distribute Shared Key 1532 to Computing Device 1500 using Public Key Infrastructure (PKI) cryptography. Shared Key 1532 may comprise a fixed encryption key. Additionally or alternatively, Shared Key 1532 may comprise a time-dependent encryption key, replaced periodically and valid for a limited time duration. In some exemplary embodiments, Shared Key(s) 1532 may comprise three keys: a time dependent key that is updated periodically, a fixed key that uniquely identifies the organization in which the system of FIG. 15A is deployed, and a key which depends on Programs List 1536, such as a hashing of Programs List 1536.

Server 1510 may comprise a List Updater 1514 for maintaining and updating Programs List 1536 among the plurality of computing devices in the network environment. List Updater 1514 may provide credentials enabling verification of the content of Programs List 1536 by Computing Device 1500, for example by applying a hash function on Programs List 1536 and digitally signing the result. The credentials may also be used for the scrambling or descrambling process, as one of the Shared Key(s) 1532 that is distributed by Key Distributor 1512.

Server 1510 may comprise a Time Synchronizer 1516 for synchronizing system clocks among the plurality of computing devices in the network environment, in case that one or more of the Shared Key(s) 1532 distributed by Key Distributor 1512 are time-dependent.

Server 1510 may comprise an Attack Detector 1518, configured for tracking and analyzing traffic in the computer network environment in order to detect possible security attacks and outbreaks. Attack Detector 1518 may receive and analyze notifications from Computing Device 1500 concerning incoming communications for which the descrambled port number is not assigned to an application program.

In some exemplary embodiments, Key Distributor 1512, List Updater 1514, Time Synchronizer 1516 and Attack Detector 1518 may be deployed on one or more separate servers. In one embodiment, each of the above is deployed on a stand-alone and separate server.

In some exemplary embodiments, Server 1510 may monitor communication in the network, identify transmission to invalid ports, analyze such transmission to detect potential malicious activity and mitigate risk from such activities. In some exemplary embodiments, the disclosed subject matter may utilize a server such as disclosed in U.S. Pat. No. 9,794,277, entitled “MONITORING TRAFFIC IN A COMPUTER NETWORK”, issued on Oct. 17, 2017, which is hereby incorporated by reference in its entirety for all purposes without giving rise to disavowment.

Referring now to FIG. 15B showing a block diagram of a system, in accordance with some exemplary embodiments of the disclosed subject matter.

Gateway Apparatus 1560 may be an apparatus configured to receive and process communications sent by or towards computerized devices equipped with network connectivity, similarly as 1460 of FIG. 14B. Gateway Apparatus 1560 may comprise Processor(s) (not shown), I/O Module (not shown) and Memory (not shown). Gateway Apparatus 1560 may comprise an Out Connection 1555 configured to connect Gateway Apparatus 1560 with a network, such as Network 1550. Gateway Apparatus 1560 may receive via Out Connection 1555 any and all outgoing communications transmitted from Network 1550 towards a destination outside of Network 1550. Gateway Apparatus 1560 may comprise an In Connection 1575 configured to connect Gateway Apparatus 1560 with a device provided with network connectivity, such as Device 1570. Additionally or alternatively, In Connection 1575 may be configured to connect Gateway Apparatus 1560 with another network, different than the network connected with Gateway Apparatus 1560 via Out Connection 1555, such as Network 1590. Gateway Apparatus 1560 may receive via In Connection 1575 all ingoing communications sent to Network 1550 from Device 1570 and/or from Network 1590.

Network 1550 may be a secure network wherein secure communication is effected by means of port scrambling and descrambling, in accordance with some exemplary embodiments of the disclosed subject matter. Device 1570 may be a device unable to or prohibited from executing a port scrambling/descrambling agent, such as IoT Device 1470 or OT Device 1480 of FIG. 14B, a firewall, or the like. In some exemplary embodiments, Network 1590 may be a public, non-secure network, such as the Internet or the like. Alternatively, Network 1590 may be a secure network employing a different port scrambling protocol than Network 1550, e.g. by utilizing different parameters or the like.

Gateway Apparatus 1560 may comprise a Port Scrambling Module 1540, configured to scramble ports of incoming communications to Network 1550 received via In Connection 1575, and a Port Descrambling Module 1544, configured to descramble ports of outgoing communications from Network 1550 received via Out Connection 1555. Gateway Apparatus 1560 may be configured to retain Shared Key(s) 1532 and Program List 1536 for use by Port Scrambling Module 1540 and Port Descrambling Module 1544, similarly as Computing Device 1500 and its subcomponents Port Scrambler 1520 and Port Descrambler 1528. In some exemplary embodiments, Program List 1536 may be utilized as a parameter of the transformation and inverse transformation functions used for scrambling and descrambling ports. Gateway Apparatus 1560 may receive Shared Key(s) 1532 and Program List 1536 from a Server 1510. Server 1510 may be configured to update and distribute Shared Key(s) 1532 and Program List 1536 to Gateway Apparatus 1560 and computerized devices belonging to Network 1550, similarly as in FIG. 15A.

In some exemplary embodiments, Gateway Apparatus 1560 may comprise a Security Analyzer 1548. Gateway Apparatus 1560 may use Security Analyzer 1548 to process incoming communications received via In Connection 1575 and determine whether they are compliant with a security policy defined for Network 1550. Based on a determination by Security Analyzer 1548, Gateway Apparatus 1560 may selectively apply Port Scrambling Module 1540 on incoming communications, such that only ports of vetted communications are scrambled prior to being forwarded to Network 1550.

In some exemplary embodiments, Gateway Apparatus 1560 may be configured to process incoming and outgoing communications either at a data link layer, i.e., layer 15 in the seven layer Open Systems Interconnection (OSI) model, or at a network layer, i.e. layer 3 in the OSI model. It will be appreciated that in case Gateway Apparatus 1560 is employed at a network layer, a different IP address may be assigned for Device 1570 so that communications sent to Device 1570 may be routed to Gateway Apparatus 1560. It will be appreciated that Gateway Apparatus 1560 when employed at the network layer may be utilized as a firewall, whereby communications from a source outside Network 1550 and different from Device 1570 may be blocked, or selectively forwarded to Network 1550 based on being sent in response to request coming from Network 1550.

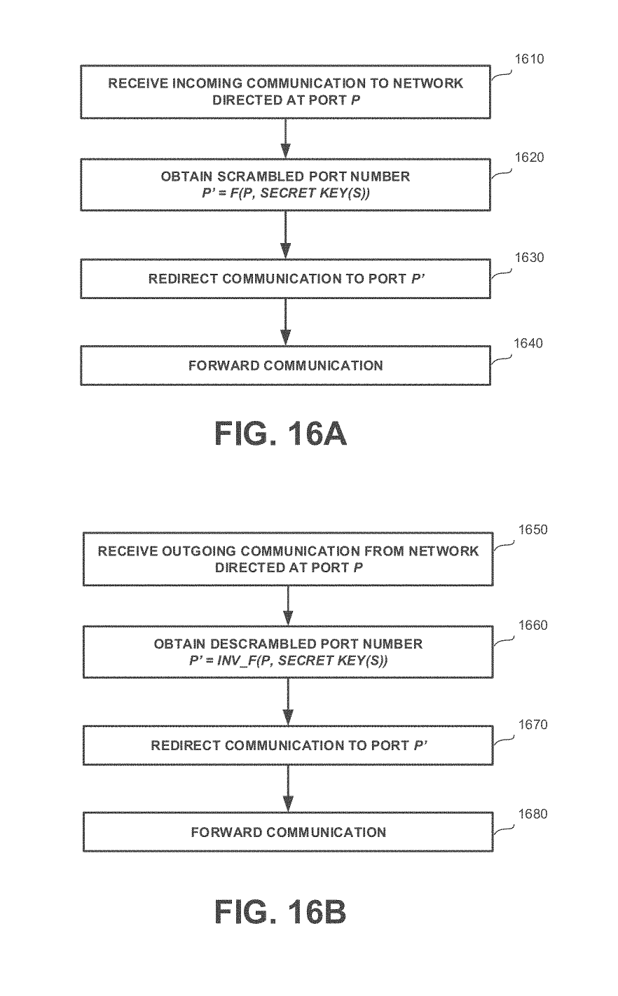

Referring now to FIG. 16A showing a flowchart diagram of method, in accordance with some exemplary embodiments of the disclosed subject matter.

On Step 1610, an incoming communication directed to a network via a first port (denoted as P), may be received. For example, the incoming communication may be a UDP packet provided with an IP address of a computerized device in the network and a port number, e.g. 192.168.1.52:80. The incoming communication may be sent by a device precluded from executing a port scrambling agent, such as Device 1570 of FIG. 15B, or by a device of a different network.

On Step 1620, a transformation function may be applied on an identifier of the first port to obtain an identifier of a second port (denoted as P′). The transformation function may depend on at least one secret parameter shared among a plurality of computing devices in a computer network, such as Shared Key 1532 of FIG. 15A.

The identifier of the first port may be obtainable by applying an inverse transformation on the identifier of the second port. The inverse transformation may depend on the at least one secret parameter, such that only devices sharing the at least one secret parameter may be able to apply the inverse transformation. The transformation function may be either a symmetric cryptography function, such as DES, AES, or the like, or an asymmetric cryptography function, such as RSA, El-Gammal, or the like.

In some exemplary embodiments, the scrambled port number may not be a port number which has a general known functionality, such as port numbers known as “common port numbers” which are published by the Internet Assigned Number Authority (IANA) or the like. As an example, the scrambled port may not be port 20-21 (used for FTP), port 22 (used for SSH), port 53 (used for DNS), port 80 (used for HTTP), port 443 (used for HTTPS) or the like. In case the transformation function provides an excluded port, a next non-excluded port may be selected on Step 1620. Additionally, or alternatively, a list of excluded ports may include common port numbers or other port numbers which are constantly excluded. The list may also include port numbers which were used as scrambled ports in a previous time segment. For example, in case port 80 was scrambled to port 1579 during a first time segment, in a next time segment, when port 80 is scrambled to a different port number, all other ports may be excluded from being scrambled to port 1579 so as to avoid collision and confusion. In such an embodiment, a packet that is destined to port 1579 and is received in the second segment may be uniquely identified as a packet that was transmitted during the first time segment towards port 80.

On Step 1630, the incoming communication may be redirected to be transmitted via the second port. In the above given example in which the original address is 192.168.1.52:80 and in which port 80 is scrambled to port 1579, the outgoing communication may be transmitted to 192.168.1.52:1579. In some exemplary embodiments, a security analysis step (not shown) may be performed on the incoming communication prior to Steps 1620 and 1630, to determine whether the incoming communication is in line with a security policy defined for the network, and if not, the method may either skip Steps 1620 to 1630 and resume at Step 1640 or stop and take no further action.

On Step 1640, the incoming communication may be forwarded to the network, either via the original port P or the scrambled port P′, depending on whether the port was scrambled or not.

Referring now to FIG. 16B showing a flowchart diagram of method, in accordance with some exemplary embodiments of the disclosed subject matter.

On Step 1650, an outgoing communication from a network, directed to be received via a first port at a destination outside of the network, may be received. The outgoing communication may be received from a device of the network such as Computing Device 1500 of FIG. 15A, whereby selective port scrambling may be performed. The destination may be a limited or restricted functionality device, such as Device 1570, or a device of a different network, configured to connect and communicate with the network via an apparatus such as Gateway Apparatus 1560 of FIG. 15B.

On Step 1660, an identifier of a second port may be obtained by applying an inverse transformation function on an identifier of the first port. The inverse transformation function may depend on at least one secret parameter shared among a plurality of computing devices in the computer network, such as Shared Key 1532 of FIG. 15A.

On Step 1670, the outgoing communication may be redirected to the second port. It will be appreciated that, in case the outgoing communication is an authorized communication, the first port may be a scrambled version of a port at which the outgoing communication was originally directed, and the second port may be identical to the original port. Otherwise the first port may be identical to the original port and the second port may be a descrambled version of the original port, which may be an improper port, causing communications received therein to be discarded.

On Step 1680, the outgoing communication may be forwarded to be received at its destination via the descrambled port P′.

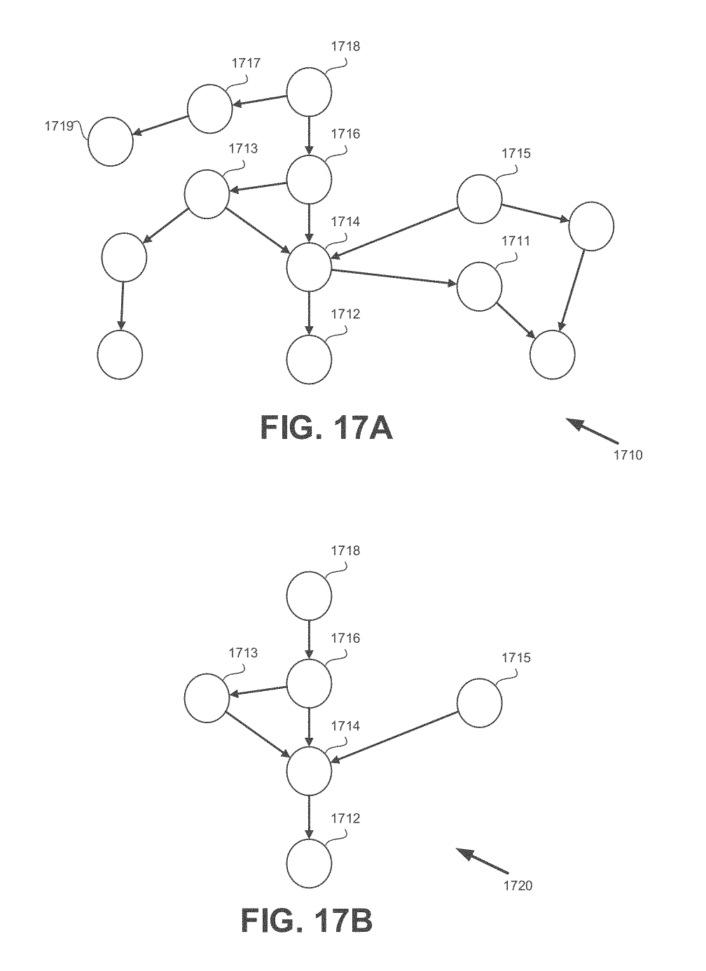

Referring now to FIG. 17A showing a schematic illustration of a graph, in accordance with some exemplary embodiments of the disclosed subject matter.

In some exemplary embodiments, a Communication Graph 1710 may represent IPC communications between software entities in a system. Communication Graph 1710 may be a directed graph. A node in Communication Graph 1710, such as Nodes 1711-1719, may represent a software entity. An edge in Communication Graph 1710 may represent an IPC between two software entities. As an example, Node 1718 may represent a first software entity; Node 1717 may represent a second software entity; and a directed edge connecting between Node 1718 and Node 1717 may represents an IPC initiated by the first software entity towards the second software entity. A path in Communication graph 1710 from a first node to a second node, may represent an indirect IPC from the software entity represented by the first node, towards the software entity represented by the second node. The path may be a directed path indicating that the entity associated with the first node had the potential to affect the entity associated with the second node.

In some exemplary embodiments, Communication Graph 1710 may be created and maintained based on monitoring of the system. In some exemplary embodiments, monitoring of the system may comprise monitoring for loading of processes executing the software entities. A node may be added to Communication Graph 1710 in response to detecting a load of a process in the Operating System (OS). The node may represent the software entity executed by the newly loaded process.

In some exemplary embodiments, the software entity loading the processes may be a dynamically-loadable code, such as a DLL, an ActiveX™ library (e.g., an OCX file), a system driver (e.g., a DRV file), a dynamic framework, a dynamic-loaded program, or the like. Additionally or alternatively, the software entity may be an executable code that is being executed.

Additionally or alternatively, Communication Graph 1710 may be created by monitoring IPC between software entities. In response to monitoring an IPC from a source software entity to a target software entity, a directed edge from the node representing the source software entity to the node representing the target software entity may be added to Communication Graph 1710. In some exemplary embodiments, in case the nodes do not already exist, new nodes may be added to Communication Graph 1710.

In some exemplary embodiments, Node 1712 may represent a transmitting software entity. In response to an attempt to transmit an outgoing communication by the transmitting software entity (Node 1712), a list of software entities having the potential affect the transmitting software entity, may be examined to determine the potential security risk associated with the outgoing communication. The list may comprise software entities which have performed IPC, directly or indirectly, with the transmitting software entity. In some exemplary embodiments, Communication Graph 1710 may be analyzed to obtain the list.

Referring now to FIG. 17B showing a schematic illustration of a graph, in accordance with some exemplary embodiments of the disclosed subject matter.

In order to obtain the list, a COI 1720 of Node 1712 may be determined. The list may comprise each software entity associated with a node in COI 1720. In some exemplary embodiments, COI 1720 may comprise each node that has a directed path to Node 1712. COI 1720 comprises Nodes 1712, 1713, 1714, 1715, 1716 and 1718.

In some exemplary embodiments, COI 1720 may comprise nodes representing software entities which have performed a direct IPC with the transmitting software entity, such as Node 1714, which has an outgoing edge that connects Node 1714 to Node 1712 directly.

Additionally or alternatively, COI 1720 may comprise nodes representing software entities which have performed an indirect IPC with the transmitting software entity. As an example, there is a path in Communication Graph 1710 starting from Node 1715 and reaching Node 1712. Such a path may represent a chain of software entities that could have affected one another using monitored IPCs, and as a result, each node in the path had the potential to affect the outgoing communication transmitted by Node 1712. COI 1720 may comprise software entities represented by nodes performing the chain of IPCs.

In some exemplary embodiments, COI 1720 may be determined by performing backward traversal of Graph 1710 starting from Node 1712. COI 1720 may comprise the nodes that are reachable from Node 1712 during backward traversal. The list may comprise the software entities associated with the nodes of COI 1720.

In some exemplary embodiments, COI 1720 may exclude some nodes which do not have a path in Communication Graph 1710 towards Node 1712. For example, Nodes 1717, 1719 are potentially affected by Node 1718, but do not have the potential to affect Node 1712 and therefore are not in COI 1720. As another example, Node 1711 also does not have the potential to affect Node 1712 via IPCs. As a result, Node 1711 is excluded from COI 1720.

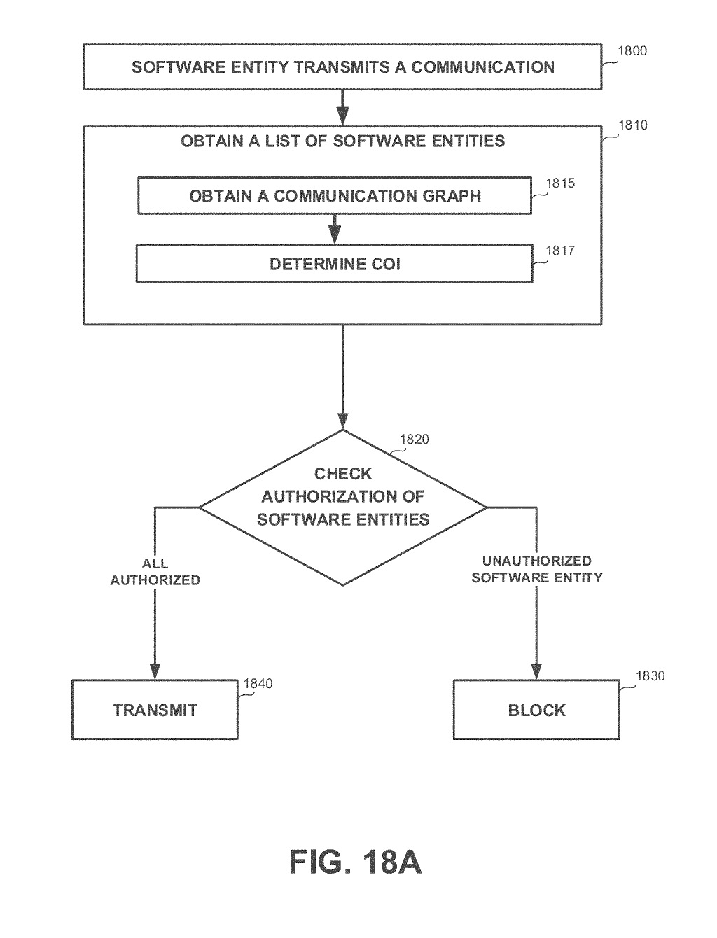

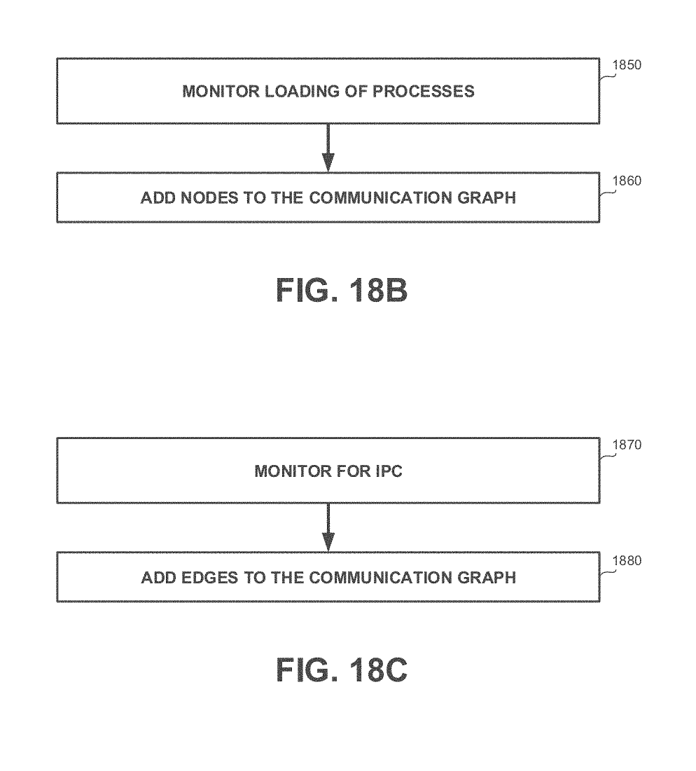

Referring now to FIG. 18A showing a flowchart diagram of a method, in accordance with some exemplary embodiments of the disclosed subject matter.

On Step 1800, a transmitting software entity may attempt to transmit an outgoing communication.

In some exemplary embodiments, the transmitting software entity may be a software entity which is authorized to transmit outgoing communications. Non-limiting example of transmitting software entities may be Internet browsers, e-mail clients, message transfer applications, data transfer applications, or the like. Authorization may be based on rules and parameters defined by IT administrators of the system, whitelists, blacklists, malicious signature identification methods, or the like.

On Step 1810, a list of software entities may be obtained. In some exemplary embodiments, the list may comprise software entities which have performed IPC, directly or indirectly, with the transmitting software entity. In some exemplary embodiments, the transmitting software entity may be potentially affected by the other software entities appearing in the list through the IPC.

On Step 1815, a communication graph may be obtained. In some exemplary embodiments, the communication graph may be a directed graph representing software entities involved with the transmitting software entity by IPC, such as Communication Graph 1710 in FIG. 17A. The communication graph may be obtained from a monitoring module which may iteratively construct and update the graph. Additionally or alternatively, the communication graph may be generated on demand, such as based on a log indicating events in the system which had previously occurred.

In some exemplary embodiments, the communication graph may be analyzed obtain the list. The communication graph may be analyzed to extract nodes that represent software entities that performed an IPC with the transmitting software entity.

On Step 1817, a COI may be determined. In some exemplary embodiments, in order to obtain the list, a COI from the node representing the transmitting software entity in the communication graph may be determined, such as COI 1720 in FIG. 17B. Each software entity in the list may be represented with a node in the COI.

On Step 1820, authorization of software entities may be checked. In some exemplary embodiments, each software entity in the list of software entities may be checked to determine whether the software entity is an authorized software entity. In some exemplary embodiments, each software entity may be checked to determine if it is a member of an authorized programs list (e.g., white list). Additionally or alternatively, each software entity may be checked to determine if it is a member of an unauthorized programs list (e.g., black list). In some exemplary embodiments, other methods to determine authorization may be utilized.

In some exemplary embodiments, software entities such as Internet browsers or a Macro-executing applications, may be authorized to transmit outgoing communications. However, such software entities may be determined as unauthorized software entities, if they are not the transmitting software entities, (i.e. are unauthorized to affect a transmitting software entity). In case such software entities are not the transmitting software entity, they may be exploited by a macro attacker to cause an indirect transmittal of the outgoing communication via another transmitting software entity. Hence, if such a software entity is identified in the list of software entities in the COI of the transmitting software entity, the software entity may be considered as unauthorized.

In some exemplary embodiments, a software entity may be unauthorized to transmit outgoing communication but may be considered as authorized if appearing in a COI of another software entity that transmits outgoing communication. Hence, authorization may be context based and may differ based on the location of the software entity within the COI and its role. In some cases, a software entity may be authorized to affect specific software entities (e.g. Node 1716 is authorized if it affects Node 1714 but is not authorized to directly perform IPC with other nodes, such as Node 1713). Additionally or alternatively, a software entity may be unauthorized to affect specific entities (e.g., Node 1716 may be generally authorized but is unauthorized to directly perform IPC with Node 1713).

In response to detecting an unauthorized software entity in the list of software entities, Step 1830 may be performed. On Step 1830, the communication may be blocked. In some exemplary embodiments, the transmitting software entity may be prevented from transmitting the outgoing communication. Additionally or alternatively, the outgoing communication may be re-routed, deceived by a honeypot, or the like. Additionally or alternatively, the event may be logged and potentially reported. In some cases, a system in accordance with the disclosed subject matter may operate in a monitoring mode and may not block the outgoing communication but only log and report it.

In case all the software entities are authorized, Step 1840 may be performed. On Step 1840, the communication may be transmitted. In some exemplary embodiments, the event may be logged. In some cases, the log may indicate the list of software entities for future analysis.

Referring now to FIG. 18B showing a flowchart diagram of a method, in accordance with some exemplary embodiments of the disclosed subject matter.

On Step 1850, loading of processes executing the software entities may be monitored. In some exemplary embodiments, processes involved with the transmitting software entity may be monitored. In some exemplary embodiments, a hook in the OS may be installed to enable the monitoring of loading of processes. Additionally or alternatively, a monitoring process may repeatedly query the OS for existing processes (e.g., repeatedly perform ps command in LINUX™). Additionally or alternatively, loading of dynamically executable code may be identified.

On Step 1860, nodes may be added to the communication graph based on the monitoring of Step 1850. In some exemplary embodiments, in response to detecting a load of a process, a node representing the software entity associated with the loaded process, may be added to the communication graph. In some exemplary embodiments, an invoking process that invoked the loaded process may be identified and an edge may be added between the node of the invoking process and the node of the loaded process. In some exemplary embodiments, a parent-child relationships between processes may be examined to identify the invoking process. In some exemplary embodiments, edges representing IPCs associated with loaded process may be added to the communication graph.

Referring now to FIG. 18C showing a flowchart diagram of a method, in accordance with some exemplary embodiments of the disclosed subject matter.

On Step 1870, monitoring for IPC between software entities may be performed. The IPC may comprise mechanisms for sharing data between processes.

In some exemplary embodiments, different forms of IPC may be monitored, such as message passing, synchronization, shared memory, pipes, Remote Procedure Calls (RPC), or the like.

As an example, files accessed by loaded processes executing the software entities and monitored on Step 1860, may be monitored. The files may be records stored on a disk, records synthesized on demand by a file server, or the like. In case two entities access the same file object, an IPC between the entities may be determined. The direction of the IPC may be from any entity that wrote to the file and towards any entity that read from the file. In some exemplary embodiments, several edges may be determined based on the same file. Consider three entities accessing the same file, where A and B write and read to the file and C only reads from the file. The following edges may be added: A to B, A to C, B to A and B to C.

As another example, a software entity may invoke an API of another software entity. For example, a library function in a DLL may be invoked. Such invocation may be considered as an IPC from the entity to the DLL. If the library function returns a value to the entity, it may also be considered as an IPC from the DLL to the entity. In some cases, over approximation may be performed and each DLL invocation may be considered as a bi-directional IPC.

In some exemplary embodiments, DLL may be dynamically loaded to an existing process. Such dynamic loading of a DLL may be considered as an IPC. In some cases, dynamic loading of a DLL may be considered as a bi-directional IPC. In some exemplary embodiments, DLL injection may be used to dynamically load the DLL. DLL injection may be used for running code within the address space of another process, by forcing the process to load the DLL into its address space. DLL injection may be used by malicious software entities to influence the behavior of another software entity, in a way its author did not anticipate or intend. For example, the injected code may hook system function calls, read the contents of password textboxes, or the like. In some exemplary embodiments, the injected DLL code may be invoked from the code of the process using pointers, functions, or other invocation methods that may rely on parameters that can be influenced and modified by the malicious software entity. Additionally or alternatively, DLL may be dynamically loaded to an existing process using reflection. Reflection may be the ability of a software entity to examine, introspect and modify its own structure and behavior at runtime. A reflection-oriented program component can monitor the execution of an enclosure of code and can modify itself according to a desired goal related to that enclosure. This may be accomplished by dynamically assigning program code at runtime. DLL code may be dynamically loaded using reflection, leading to the invocation of the DLL by the software entity. In some exemplary embodiments, malicious user may utilize reflection to perform a malicious activity. For example, the malicious user may be modify the DLL which the software entity is pre-configured to load and use. As another example, the malicious user may manipulate the software entity to use reflection and load a malicious DLL.

As yet another example, signals may be considered as a form of IPC. A signal may be an asynchronous system message sent from one process to another process. Signals may be used to notify a process of an event that occurred, to remotely command another process, to synchronize two processes to use another synchronous IPC, or the like. A similar form of IPC may be Asynchronous System Trap (AST). AST may refer to a mechanism used in several systems to signal events back to user processes.

As yet another example, sockets may be a form of IPC. A socket may be a mechanism for receiving or sending data stream over a network interface, either to a different process on the same computer or to another computer on the network. In some exemplary embodiments, there may be different kinds of sockets, such as datagram sockets used for connectionless communication, multicast sockets used to send to multiple nodes, address range sockets where there may or may not be any nodes to receive data, Unix domain socket which may be a data communications endpoint for exchanging data between processes executing on the same host operating system, or the like.

As yet another example, message queues may be a form of IPC. Message queues may be data streams which usually preserves message boundaries. Message queues may allow multiple processes to read and write to the message queue without being directly connected to each other.

As yet another example, pipes may be an additional form of IPC. Pipes may be unidirectional data channels. Data written to the write end of the pipe may buffered by the operating system until it is read from the read end of the pipe. In some exemplary embodiments, couples of pipes may be considered as two-way data streams between processes, i.e. a bi-directional IPC. The couples of pipes may be utilized to achieve standard input and output for the two-way communication. A similar form of monitored IPC may be anonymous pipes. An anonymous pipe may be a FIFO communication channel used for one-way IPC. A parent software entity may open anonymous pipes, and create a new process that inherits the other ends of the pipes, or creates several new processes and arranges them in a pipeline. Another similar form of monitored IPC may be named pipes. A named pipe may be a pipe implemented through a file on the file system instead of standard input and output. Multiple processes may read and write to the named pipe.

As yet another example, semaphores may be a form of IPC. A semaphore may be an abstract data type used to control access to a common resource by multiple processes. The semaphore may synchronize between the multiple processes acting on the common resource.

As yet another example, multiple processes may be given access to the same block of memory which creates a shared buffer for the processes to communicate with each other. This block of shared memory may be a method of IPC. Shared memory may be a way of exchanging data between software entities running at the same time. Each software entity writing to the shared memory may be viewed as an origin of the IPC and each software entity reading from the shared memory may be viewed as a target of the IPC. In some exemplary embodiments, an over approximation may be performed and each process with access to the shared memory may be viewed as being both an origin and a target of the IPC. Additionally or alternatively, access permissions may be used to define origin/target of the IPC.

As yet another example, multiple software entities may communicate by message passing. The software entities may pass messages using message queues and/or non-OS managed channels, commonly used in concurrency models. Such messages may be a method of IPC.

As yet another example, memory-mapped files may be another form of IPC. A memory-mapped file may be a file mapped to RAM that may be modified by changing memory addresses directly instead of performing I/O operations. The memory-mapped file may be physically present on disk, but may also be a device, shared memory object, or other resource that the operating system can reference through a file descriptor. The correlation between the file and the memory space may permit software entities to treat the mapped portion as if it were primary memory.

As yet another example, Atom Bombing technique may be another form of IPC. Atom Bombing may be a technique to perform code injection to a process. Atom Bombing exploit Windows™ atom tables and Async Procedure Calls (APC) to inject code into a process.

In some exemplary embodiments, monitoring for IPC may comprise memory scanning of processes. The memory space may be scanned to detect injected code within a running process. Based on identifying an injected code the corresponding software entity may be identified as being a target of an IPC. If the origin of the code injection is unknown, all processes executing in the system may be considered as a potential origin, and edges from each node may be added to the communication graph.

On Step 1880, edges may be added to the communication graph. In some exemplary embodiments, in response to determining an IPC initiated by a first software entity towards a second software entity, a directed edge representing the IPC may be added to communication graph. The directed edge may connect between a first node representing the first software entity; and a second node representing the second software entity. In some exemplary embodiments, adding the edge to the communication graph may comprise adding the nodes connected by the edge, if such nodes are not already part of the communication graph.

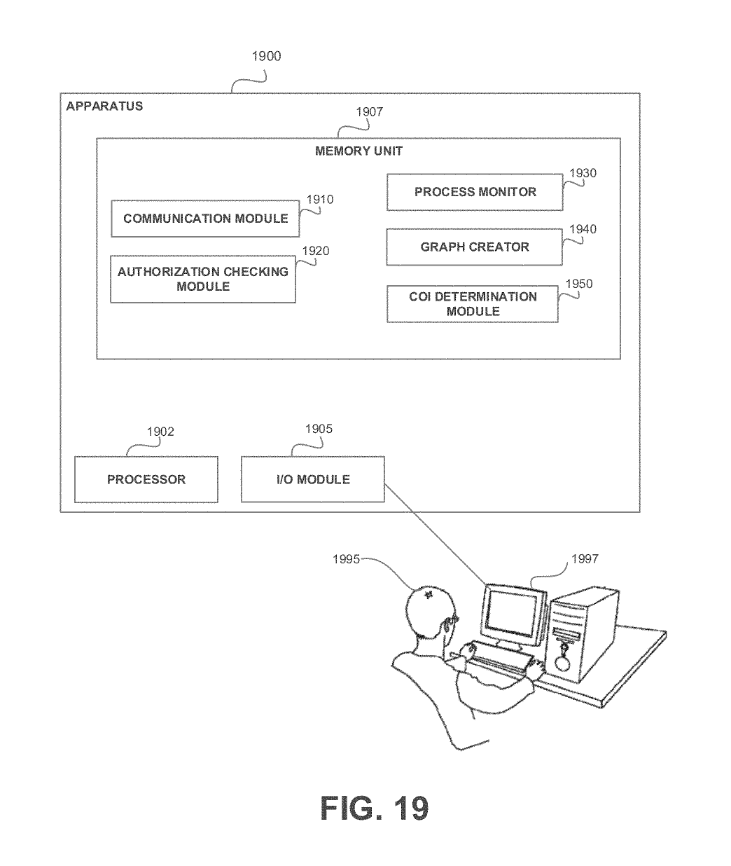

FIG. 19 showing an apparatus in accordance with some exemplary embodiments of the disclosed subject matter.

In some exemplary embodiments, Apparatus 1900 may comprise one or more Processor(s) 1902. Processor 1902 may be a Central Processing Unit (CPU), a microprocessor, an electronic circuit, an Integrated Circuit (IC) or the like. Processor 1902 may be utilized to perform computations required by Apparatus 1900 or any of it subcomponents.

In some exemplary embodiments of the disclosed subject matter, Apparatus 1900 may comprise an I/O module 1905. Apparatus 1900 may utilize I/O Module 1905 as an interface to transmit and/or receive information and instructions between Apparatus 1900 and external I/O devices, such as a Workstation 1997, computer networks (not shown), or the like. In some exemplary embodiments, I/O Module 1905 may be utilized to provide an output to and receive input from a User 1995. It will be appreciated that Apparatus 1900 can operate automatically without human intervention.

In some exemplary embodiments, Apparatus 1900 may comprise Memory Unit 1907. Memory Unit 1907 may be a hard disk drive, a Flash disk, a Random Access Memory (RAM), a memory chip, or the like. In some exemplary embodiments, Memory Unit 1907 may retain program code operative to cause Processor 1902 to perform acts associated with any of the subcomponents of Apparatus 1900.

In some exemplary embodiments, a Communication Module 1910 may be configured to transmit communications from transmitting software entities executed by Apparatus 1900.

In some exemplary embodiments, an Authorization Checking Module 1920 may be configured to analyze lists of software entities, in order to determine whether they contain an unauthorized software entity. In some exemplary embodiments, Authorization Checking Module 1920 may obtain a list of software entities which have performed IPC, directly or indirectly, with a transmitting software entity. Authorization Checking Module 1920 may be configured to check authorization of each software entity in the list. In some exemplary embodiments, Authorization Checking Module 1920 may check if each software entity in the list is a member of an authorized programs list. Additionally or alternatively, Authorization Checking Module 1920 may check if a software entity is a member of an unauthorized programs list. Additionally or alternatively, Authorization Checking Module 1920 may check whether the software entity is an Internet browser, a Macro-executing application, or the like. In some exemplary embodiments, the analysis performed by Authorization Checking Module 1920 may be affected by a context of the software entity, such as but not limited to its location in the communication graph, it being transmitting/non-transmitting entity, the software entities it initiated IPC directly with, the software entities that initiated IPC directly with it, the specific type of IPC, or the like.

In some exemplary embodiments, in response to Authorization Checking Module 1920 detecting an unauthorized software entity in the list of software entities, Communication Module 1910 may block the outgoing communication associated with the list. Additionally or alternatively, Communication Module 1910 may prevent the outgoing communication from being transmitted, provide a report about the outgoing communication, provide a report about the unauthorized software entity, create an entry in a log, or the like.

In some exemplary embodiments, a Process Monitor 1930 may be configured to monitor for loading of processes executing software entities. Process Monitor 1930 may monitor dynamically-loadable code, executable code, or the like. Additionally or alternatively, Process Monitor 1930 may be configured to monitor IPC between software entities. In some exemplary embodiments, Process Monitor 1930 may be configured to report about loaded software entities and IPC therebetween to a Graph Creator 1940.

In some exemplary embodiments, Graph Creator 1940 may be configured to utilize information obtained from Process Monitor 1930 to create a communication graph of the software entities and the IPC therebetween. Graph Creator 1940 may be configured to create a directed graph, with nodes representing the software entities and edges representing the IPC between the software entities. In some exemplary embodiments, Graph Creator 1940 may be configured to add a node to the communication graph, for each load of a process reported by Process Monitor 1930. The added node may represent the software entity executed by the loaded process. Additionally or alternatively, Graph Creator 1940 may be configured to add a directed edge in the communication graph connecting between a first node and a second node, for each IPC initiated by the software entity represented by the first node towards the software entity represented by the second node.

In some exemplary embodiments, the communication graph created by Graph Creator 1940 may be utilized to determine a list of software entities that are associated with an outgoing communication. The communication graph may be analyzed directly to obtain the list. Additionally or alternatively, a COI from the node representing the transmitting entity may be created based on the communication graph; and analyzed to obtain the list.

In some exemplary embodiments, a COI Determination Module 1950 may be configured to generate a COI from a node of the communication graph created by

Graph Creator 1940, representing the transmitting software entity. COI Determination Module 1950 may provide a list of software entities associated with nodes in the COI to Authorization Checking Module 1920.

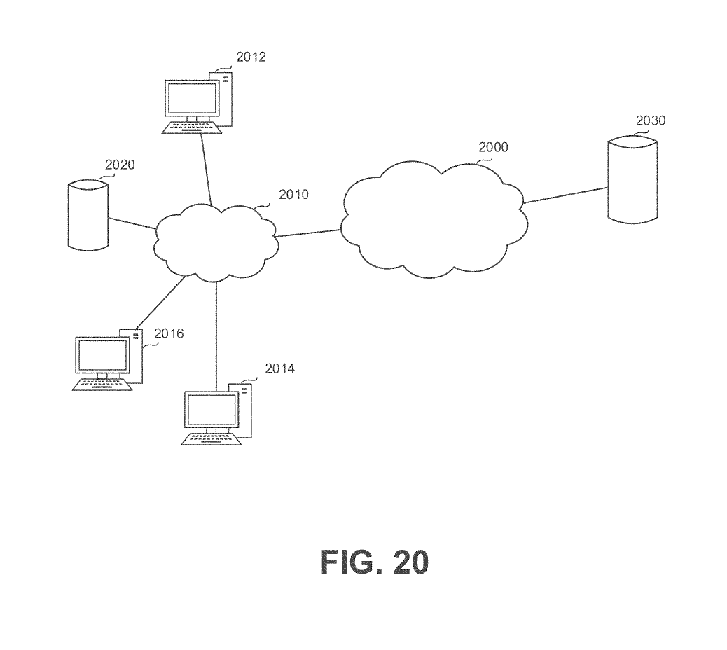

Referring now to FIG. 20 showing a schematic illustration of organizational network, in accordance with some exemplary embodiments of the disclosed subject matter.

In some exemplary embodiments, an Organizational Network 2010 may comprise a plurality of computerized devices, such as Devices 2012, 2014 and 2016, interconnected to one another and sharing resources, such as, for example, through common access to one or more servers (not shown) connected to Organizational Network 2010.

In some exemplary embodiments, Network 2010, such as intranet, Local Area Network (LAN), Wi-Fi network, or the like, may be connected to External Network 2000, such as a Wide Area Network (WAN), the Internet, or the like. In some cases, Organizational Network 2010 may be connected to External Network 2000 by a router, switch, server or the like. In some exemplary embodiments, a gateway device may be configured to provide some security measures to prevent malicious activity. In some exemplary embodiments, the gateway device may be a firewall or otherwise provide the functionality of a firewall. The firewall may monitor incoming and outgoing communications in and from Organizational Network 2010, and selectively prevent packets from passing from on network to the other. In some cases, the firewall may rely on a whitelist of allowed programs, a blacklist of banned programs, or the like.

In some exemplary embodiments, Devices 2012, 2014 and 2016 may be computerized devices, such as personal computers, smartphones, servers, Internet of Things (IoT) devices, or the like. Two such devices may be networked together when one device is able to exchange information with the other device, whether or not they have a direct connection to each other. Devices 2012, 2014 and 2016 may exchange data with each other using data links. The connections between Devices 2012, 2014 and 2016 may be established using either a wired connection, a wireless connection, or combination thereof. In some exemplary embodiments, Organizational Network 2010 may enable sharing of resources between devices connected thereto, such as a shared storage space, a shared printer, or the like.

In some exemplary embodiments, Organizational Network 2010 may be an intranet network of an organization, such as a governmental institution, a business organization, or the like. Devices 2012, 2014 and 2016 may operate as a part of the organization, or be associated with users thereof.

In some exemplary embodiments, programs authorized to transmit outgoing communications from devices in Organizational Network 2010 may be listed in a Local List 2020. Local List 120 may be retained by the organization and accessible by devices connected to Organizational Network 2010. Additionally or alternatively, Local List 2020 may be transmitted to each or some of the devices of Organizational Network 2010, and retained therein. As an example, each device of Devices 2012, 2014, 2016 may locally retain a separate duplicate copy of Local List 2020. In some exemplary embodiments, Local List 2020 may comprise identifiers of authorized software applications or programs that are permitted to act on devices within Organizational Network 2010. The identifiers may be, for example, executable names, a verifiable signature of the executable (e.g., hash of the executable), a unique identifier, or the like. In some exemplary embodiments, Local List 2020 may be generated and updated based on observed outgoing communications from Devices 2012, 2014 and 2016, such transmissions exiting a device and reaching another device, either within the Organizational Network 2010 or external thereto, such as in External Network 2000. Additionally or alternatively, the disclosed subject matter may be utilized to monitor only outgoing communications that cross over from Organizational Network 2010 to External Network 2000.

In some exemplary embodiments, Local List 2020 may be used as part of a security configuration of Organizational Network 2010. As an example, Local List 2020 may be used as a whitelist. In some exemplary embodiments, only programs that are listed in Local List 2020 may be authorized to transmit outgoing communication from devices within Organizational Network 2010. Additionally or alternatively, the whitelist may be used by a firewall of Organizational Network 2010.

In some exemplary embodiments, Local List 2020 may be a subset of a Base List 2030. Base list 2030 may be a list of authorized programs that is general and not associated with any specific organization. Base List 2030 may be retained in a storage external to the organization and may be accessed via External Network 2000. Base List 2030 may comprise programs or applications that have been approved to be protected against malicious activity, programs that are approved to be authorized, or the like. As an example, Base List 2030 may include all programs published by trusted vendors, all versions thereof, or the like.

In some exemplary embodiments, programs executed by each of Devices 2012, 2014 and 2016, may be monitored to identify any attempt to transmit outgoing communications. When an attempt to transmit an outgoing communication, by a program executed by one of Devices 2012, 2014 or 2016, is identified, a determination whether the program is listed in Base List 2030 may be performed. In response to determining that the program is listed Base List 2030, the program may be added to Local List 2020. As a result, Local List 2020 is generated as a subset of Base List 2030, and based on observed activity within Organizational Network 2010.

In some exemplary embodiments, prior to checking whether a program intending to transmit a communication is listed Base List 2030, the program may be initially checked whether is listed in Local List 2020. In case the program is already listed in Local List 2020. Only if the program is not listed in Local List 2020, is Base List 2030 examined.

In some exemplary embodiments, in case the program is not listed in the Local List 2020, the outgoing communication may be blocked. After blocking the outgoing communication, the program may be checked in Base List 2030 and added to Local List 2020 in case is listed in Base List 2030. In some exemplary embodiments, the program may be configured to make additional attempts to transmit the outgoing communication. The additional attempts may be performed in case the previous attempts were unsuccessful, regardless to the reason of their failure. The additional attempts may be performed within a relatively short time frame after the previous unsuccessful attempt, such as after a predetermined timeout has elapsed. In case the program is authorized, the program will be added to Local List 2020. The next attempts to transmit the outgoing communication after the program is added to Local List 2020 may be allowed to be transmitted. The outgoing communication may be delayed for a relatively short time period, and the initial blockage may not affect performance of the program. Additional communications of the program may be allowed to be transmitted. In some exemplary embodiments, from the perspective of the user, the delay may appear to be similar to that which she may encounter, such as in case of network congestion, connectivity problems, or the like.

In some exemplary embodiments, after Local List 2020 is generated, Local List 2020 may be transmitted to Devices 2012, 2014 and 2016. Local List 2020 may be utilized as a whitelist for a security-related tool (not shown) that is operating in Organizational Network 2010. The security related tool may operate over Organizational Network 2010, over a specific device in Organizational Network 2010, over a portion of the devices within Organizational Network 2010, or the like. Programs that are listed in Local List 2020, may be allowed to transmit outgoing communications from Devices 2012, 2014 or 2016, without checking whether are listed in Base List 2030.

In some exemplary embodiments, Local List 2020 may be utilized by a firewall device of Organizational Network 2010 (not shown). The firewall device may prevent programs that are not listed in Local List 2020 from transmitting outgoing communications from Organizational Network 2010.

Additionally or alternatively, Local List 2020 may be provided to an outgoing communication filter of Devices 2012, 2014 or 2016. The outgoing communication filter may be utilized to perform selective blocking of outgoing communications of programs within Organizational Network 2010. The outgoing communication filter may prevent programs that are not listed in Local List 2020 from transmitting outgoing communications.

In some exemplary embodiments, Local List 2020 may be generated based on monitored outgoing communications transmitted from programs executed by a portion of the devices connected to Organizational Network 2010, such as based only on outgoing communications transmitted from programs executed by Device 2012. After being generated, Local List 2020 may be transmitted to Device 2014 and Device 2016, and utilized by security relating tools thereof. In some exemplary embodiments, the portion of the devices may be a representative sample of the entire population of devices in Organization Network 2010, such as comprising representatives of different types of devices, and of users associated therewith. In some exemplary embodiments, each sub-group may be represented by at least one device in the sample, while not necessarily maintaining the ratio between the different sub-groups as is observed in the population.

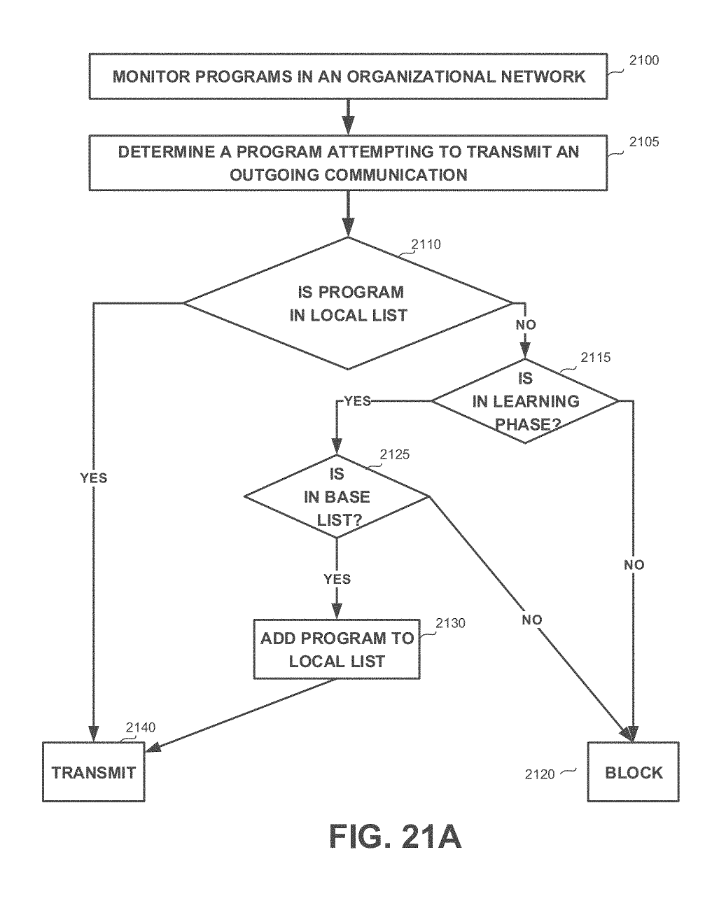

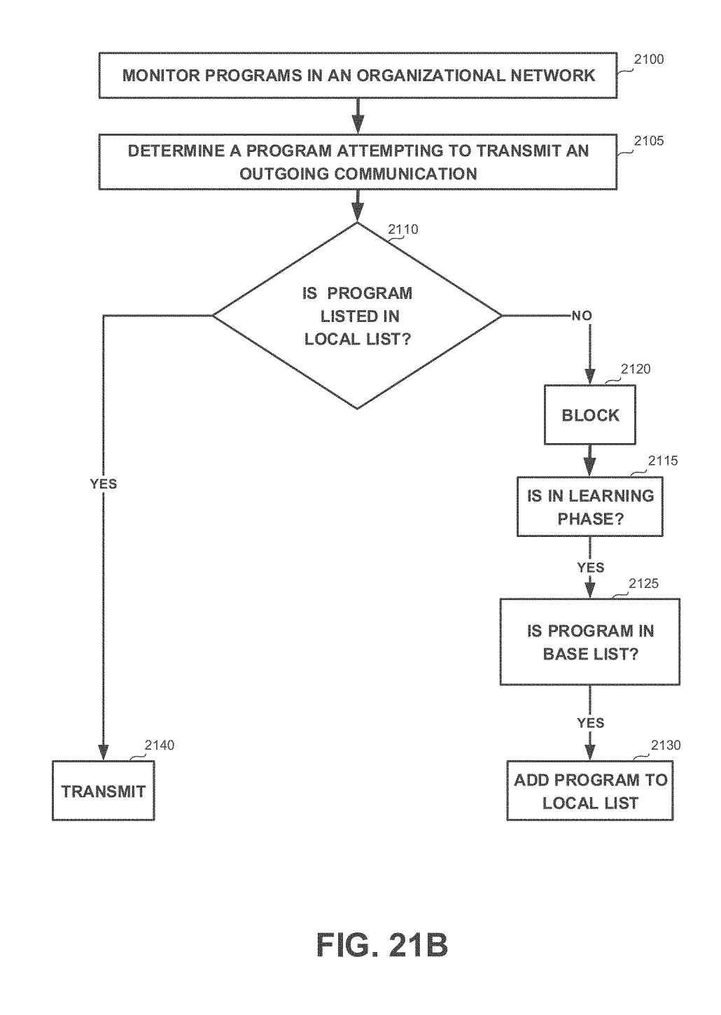

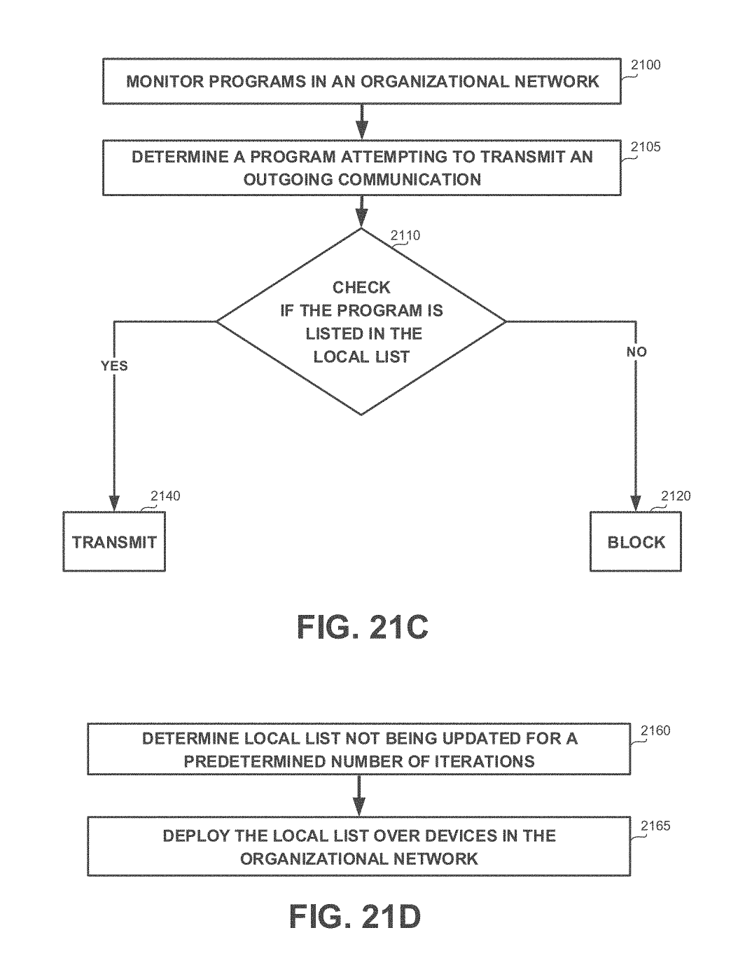

Referring now to FIG. 21A showing a flowchart diagram of a method, in accordance with some exemplary embodiments of the disclosed subject matter.

On Step 2100, programs in an organizational network such as 2010 in FIG. 20, may be monitored to identify an attempts to transmit outgoing communications. In some exemplary embodiments, the organizational network may comprise a plurality of devices, such as Devices 2012, 2014 and 2016 in FIG. 20. The organizational network may be associated with an organization. Each device may execute programs that are relevant to the functionality of the organization. In some exemplary embodiments, monitoring may be performed with respect to all of the devices in the organization, a sample thereof, or the like.

On Step 2105, a program attempting to transmit an outgoing communication may be determined. The program may be executed by a device connected to the organizational network. In some exemplary embodiments, the outgoing communication may be directed to another device within the same organizational network or directed outside the organizational network, such as outside a Local Area Network (LAN) and to a web-server connectable to the LAN via the Internet.

On Step 2110, a determination whether the program is listed in a local list, such as 2020 of FIG. 20, may be performed. The local list may comprise programs that are authorized to transmit outgoing communications within and outside the organizational network. In some exemplary embodiments, the local list may define a security configuration of the organizational network.

In case the program is listed in the local list, Step 2140 may be performed and the program may be allowed to transmit the outgoing communication.

On Step 2115, in case the program is not listed in the local list, a determination whether the system performing the method depicted in FIG. 21A is in a learning phase may be performed. During a learning phase, the local list may be potentially updated based on outgoing communications transmitted from programs executed by devices in the organizational network.

On Step 2120, in case the system is not in a learning phase, the outgoing communication may be blocked. In some exemplary embodiments, determinations whether to transmit communications or not may be solely performed based on the program transmitting the outgoing communication being listed in the local list. In some exemplary embodiments, when the system is not in a learning phase, the disclosed subject matter may be part of a security system protecting the organizational network based on security configuration defined by the local list.

On Step 2125, in case the system is during a learning phase, the program may be checked whether is listed in a base list of authorized programs. In some exemplary embodiments, during the learning phase, in response to determining that the program is not listed in the local list, prior to blocking the outgoing communication, a base list may be used to check whether the program should be added to the local list. The base list may be a general whitelist of authorized programs, such as 2030 of FIG. 20. The base list may be retained external to the organizational network, such as in a remote storage that is not directly connected to the organizational network. In some cases, the base list may be used by several different systems (or instances thereof) deployed in different organizations at the same time.

In case the program is not listed in the base list, the outgoing communication may be blocked (Step 2120) and the program may be prevented from transmitting the outgoing communication. Otherwise, in case the program is listed in the base list, on Step 2130, the program may be added to the local list, so that in future cases where the same program attempts to transmit an outgoing communication it will be allowed based on the local list and without having to consult the base list. In case the program is in the base list, the program may be allowed to transmit the outgoing communication (Step 2140).

It may be appreciated that in some exemplary embodiments, the method depicted in FIG. 21A may be performed without performing Step 2140 or Step 2160. In some exemplary embodiments, on Step 2115, the system performing the method may be determined to be deployed in a passive learning mode. During the passive learning mode, no blocking decisions may be made and all outgoing communications may be allowed to be transmitted.

Referring now to FIG. 21B showing a flowchart diagram of a method, in accordance with some exemplary embodiments of the disclosed subject matter.

In some exemplary embodiments, during a learning mode deployment, in addition to generating the local list based on monitored communications, the system may selectively block outgoing communications based on an intermediate version of the local list, as is currently available.

On Step 2110, it may be checked whether the program is listed in the local list. In case the program is not listed in the local list, the outgoing communication may be blocked (Step 2120). The outgoing communication may be blocked even if the program is listed in the base list.

On Step 2115, a determination whether the local list is in a learning phase may be performed. During the learning phase, the base list may be consulted (Step 2125) and in case the program is listed therein, the program may be added to the local list (Step 2130). When the system is not operating in learning phase, the base list may not be consulted.

In case the program attempts to transmit the outgoing communication again, such as retransmission attempts that may be associated with potential timeouts, the local list may be consulted. However, as the local list was potentially updated on Step 2130, the program may be listed, and the transmission may be allowed (Step 2140). Hence, during an active learning phase, a first transmission from a program that was not observed before may be blocked, and a second transmission may be allowed, depending on whether the program is indeed listed in the base list.

Referring now to FIG. 21C showing a flowchart diagram of a method, in accordance with some exemplary embodiments of the disclosed subject matter.

After the local list is deployed, authorization of programs to transmit communications may be determined based on the programs being listed in the local list, while avoiding checking the base list. In some exemplary embodiments, the system may be said to be in active, non-learning, phase. In such a deployment in response to a monitored outgoing transmission attempt (2100), the program attempting to transmit is identified (2105), and such program is checked against the local list (2110). Solely based on such check, it is determined whether to allow the transmission (2140) or block it (2120).

Referring now to FIG. 21D showing a flowchart diagram of a method, in accordance with some exemplary embodiments of the disclosed subject matter. In some exemplary embodiments, FIG. 21D exemplifies stopping criteria for changing from learning phase to non-learning phase.

On Step 2160, a determination that the local list is not being updated for a predetermined number of iterations may be performed. In some exemplary embodiments, each attempt to transmit an outgoing communication that is monitored and processed by the disclosed subject matter may be considered an “iteration”. In case the local list is not updated for a long while, it may be assumed that the system had concluded learning the behavior of the organization and the local list can be used without consulting the base list from now on. Such a determination may conclude the learning phase. In some exemplary embodiments, the local list may not be updated because monitored programs are either already listed in the local list (e.g., and Step 2110 determines they are listed), or they are not listed in both the local list and the base list (e.g., and Step 2125 determines they are not listed in the base list). In some exemplary embodiments, the number of iterations in which the local list is not updated may be required to be successive in order for the stopping condition to be met. In some exemplary embodiments, the predetermined number of iterations may be, for example, about 50, about 100, about 2100, or the like. Additionally or alternatively, the determination that the local list is not being updated may be performed based on a different stopping condition, such as a predetermined amount of time elapsing from the last update of the local list (the last iteration which Step 2130 has been performed), based on a user input, based on reaching a threshold on the size of the local list, or the like.

On Step 2165, the local list may be deployed over one or more devices in the organizational network. The local list may define a security configuration of the organizational network. The local list may comprise the programs that are authorized to transmit communications within the organizational network.

In some exemplary embodiments, the local list may be provided to a security related tool of the organizational network, such as firewall device. The firewall device may be configured to monitor outgoing network traffic of the organizational network and decides whether to allow or block specific traffic based on a defined set of security rules. The firewall device may utilize the local list as the set of security rules. The firewall device may prevent programs that are not listed in the local list from transmitting outgoing communications.

Additionally or alternatively, the local list may be provided to an outgoing communication filter utilized to perform selective blocking of communications of programs within the organizational network. The outgoing communication filter may prevent programs that are not listed in the list from transmitting outgoing communications.

It will be noted that the local list that is deployed may be the “final” version of the local list. In some exemplary embodiments, a plurality of local lists may be obtained from different devices and aggregated together to form the final version of the local list. In some cases, different devices that operate to gradually update the local list may share intermediate versions of the local lists. For example, in response to an update in one device, a local list in the device is updated and a notification to all other devices participating in the learning effort are notified to update their lists accordingly. Additionally or alternatively, batch updates may be transmitted periodically. Additionally or alternatively, the devices may share their updated local lists periodically to allow each device to compile a local list based on such updated local lists.

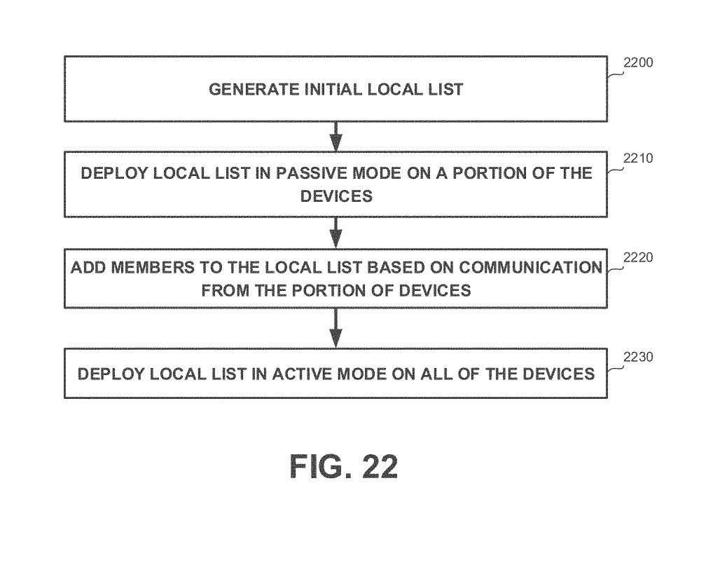

Referring now to FIG. 22 showing a flowchart diagram of a method, in accordance with some exemplary embodiments of the disclosed subject matter.

On Step 2200, an initial local list may be generated. The initial local list may be a list of programs that are authorized to transmit communication within the organizational network. In some exemplary embodiments, the initial local list may be defined by IT administrators of the organizational network. The initial local list may comprise programs that has been previously determined to be authorized, such as based on being listed in known whitelists, based on the program configuration, or the like. In some exemplary embodiments, the initial local list may be an empty list that does not include any program.

On Step 2210, the initial local list may be deployed in a passive mode over a portion of the devices. In some exemplary embodiments, the portion of devices may be a representative sample of the devices in the organizational network. While deploying the initial local list in passive mode, outgoing communications may be monitored but not blocked.

On Step 2220, members may be added to the initial local list based on communications transmitted by programs executed by the portion of devices. While deploying the initial local list in passive mode, in response to determining an attempt to transmit an outgoing communication by a program executed by a device of the portion of devices, the program may be checked to determine if listed in the base list. In case the program is listed in the base list, the program may be added to the local list. In some exemplary embodiments, the local list may be updated by a central entity receiving information from all monitored devices. Additionally or alternatively, each device may maintain a different local list and update such list independently. The independent local lists may be combined together to create the finalized local list.

On Step 2230, the local list may be deployed in active mode on all of the devices. While deploying the local list in active mode, in response to determining an attempt to transmit an outgoing communication by a program executed by any device in the organizational network, the program may be checked whether is authorized or not, only based on being listed in the local list. In some exemplary embodiments, the active mode may be learning active mode, where non-authorized programs are blocked but also checked against the base list for being included in the local list for future transmission attempts. Additionally or alternatively, the active mode may be a non-learning active mode, where the local list remains unchanged.

In some exemplary embodiments, a determination when to deploy the local list in active mode may be performed based on IT administrators decision, based on a size of the local list, based on the local list not being updated for a predetermined number of iterations (such as depicted in FIG. 2D), or the like.

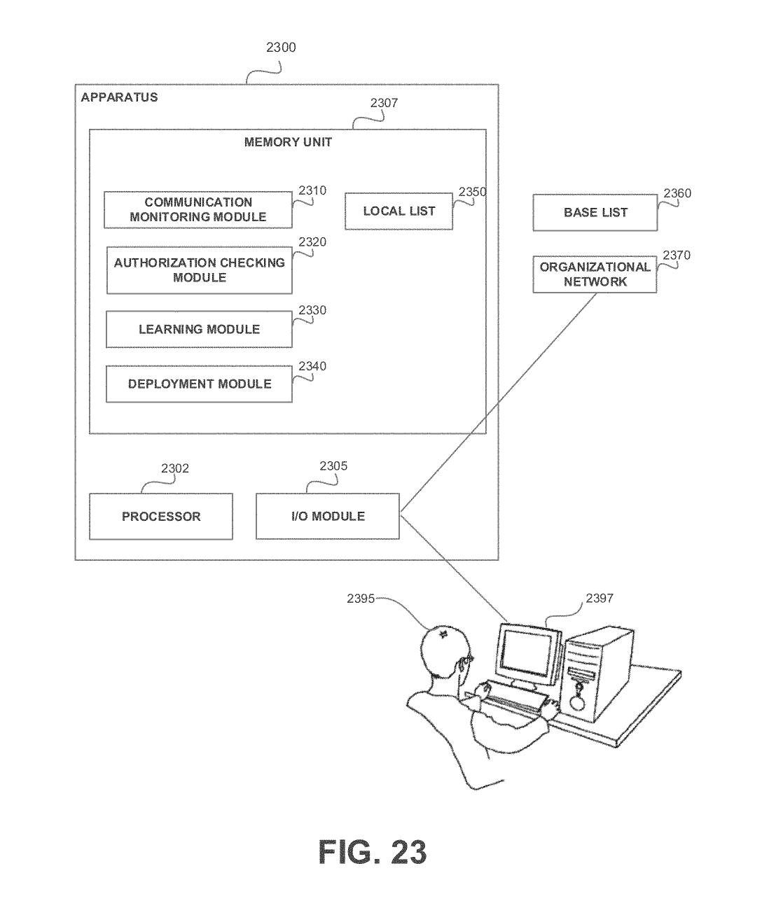

Referring now to FIG. 23 showing an apparatus, in accordance with some exemplary embodiments of the disclosed subject matter.

In some exemplary embodiments, Apparatus 2300 may comprise one or more Processor(s) 2302. Processor 2302 may be a Central Processing Unit (CPU), a microprocessor, an electronic circuit, an Integrated Circuit (IC) or the like. Processor 2302 may be utilized to perform computations required by Apparatus 2200 or any of it subcomponents.

In some exemplary embodiments of the disclosed subject matter, Apparatus 2300 may comprise an I/O module 2305. Apparatus 2300 may utilize I/O Module 2305 as an interface to transmit and/or receive information and instructions between Apparatus 2300 and external I/O devices, such as a Workstation 2397, computer networks (not shown), or the like. In some exemplary embodiments, I/O Module 2305 may be utilized to provide an output to and receive input from a User 2395. It will be appreciated that Apparatus 2300 can operate automatically without human intervention.

In some exemplary embodiments, Apparatus 2300 may be connected to an Organizational Network 2370. Organizational Network 2370 may be associated with an organization. Additional devices (not shown) may be connected together within

Organizational Network 2370. In some exemplary embodiments, Apparatus 2300 may be connected to Organizational Network 2370 via I/O Module 2305.

In some exemplary embodiments, Apparatus 2300 may comprise Memory Unit 2307. Memory Unit 2307 may be a hard disk drive, a Flash disk, a Random Access Memory (RAM), a memory chip, or the like. In some exemplary embodiments,

Memory Unit 2307 may retain program code operative to cause Processor 2302 to perform acts associated with any of the subcomponents of Apparatus 2300.

In some exemplary embodiments, a Communication Monitoring Module 2310 may be configured to monitor programs executed by a device within Organizational Network 2370, to identify an attempt to transmit outgoing communications.

In response to Communication Monitoring Module 2310 identifying a program attempting to transmit an outgoing communication, an Authorization Checking Module 2320 may be configured to check whether the program is listed in a Base List 2360 of authorized programs. Base List 2360 may be maintained external to Organizational Network 2370. In response to determining that the program is listed in Base List 2360, a Learning Module 2330 may be configured to add the program to a Local List 2350.

In some exemplary embodiments, Authorization Checking Module 2320 may be configured to check whether a program intending to transmit an outgoing communication is listed in Local List 2350, prior to checking whether the program is listed in Base List 2360. In response to determining that the program is not listed in Local List 2350, Authorization Checking Module 2320 may check whether the program is listed in Base List 2360.

In some exemplary embodiments, in response to Authorization Checking Module 2320 determining that the program is not listed in Local List 2350, the program may be prevented from transmitting the outgoing communication. In some exemplary embodiments, the program may be reported using I/O Module 2305 to a firewall device (not shown), to an outgoing communication filter of Organizational Network 2370, to an administrator of Organizational Network 2370, or the like. In some exemplary embodiments, the program may be blocked prior to Authorization Checking Module 2320 checking whether the program is listed in the base list.

In some exemplary embodiments, a Deployment Module 2340 may be configured to deploy Local List 2350 over the devices within Organizational Network 2370. Local List 2350 may define a security configuration of Organizational Network 2370.

In some exemplary embodiments, Deployment Module 2340 may be configured to send Local List 2350 to a firewall device (not shown) of Organizational Network 2370. The firewall device may be configured to prevent programs that are not listed in Local List 2350 from transmitting outgoing communications within Organizational Network 2370.

Additionally or alternatively, Deployment Module 2340 may be configured to provide Local List 2350 to an outgoing communication filter (not shown). The outgoing communication filter may be utilized to perform selective blocking of communications of programs within Organizational Network 2370. The outgoing communication filter may be configured to prevent programs that are not listed in Local List 2350 from transmitting outgoing communications within Organizational Network 2370.

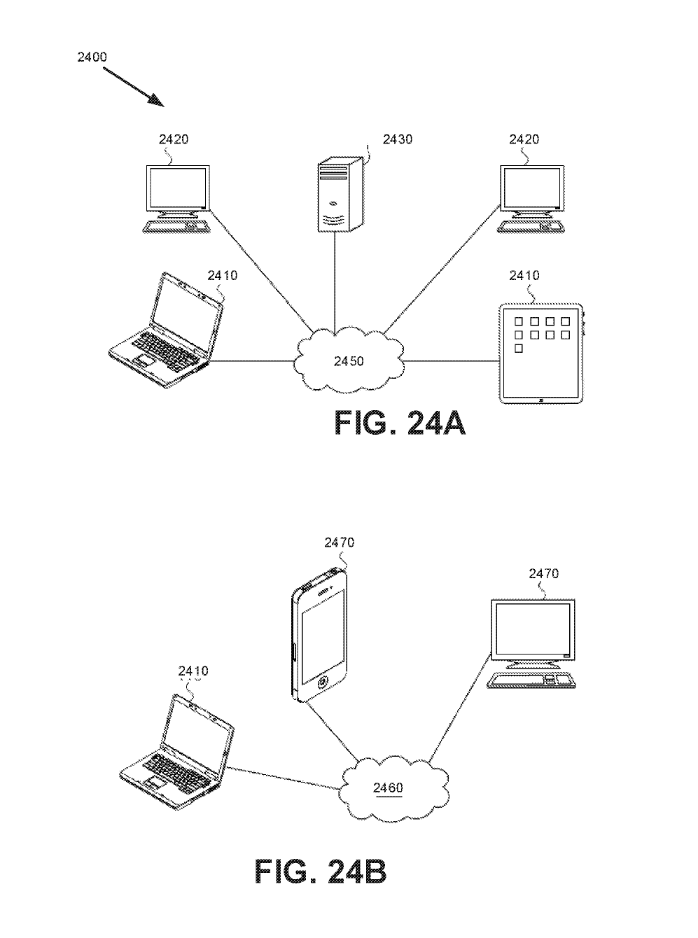

Referring now to FIG. 24A showing a computer network in which the disclosed subject matter is used, in accordance with some exemplary embodiments of the subject matter.

In some exemplary embodiments, a Computer Environment 2400 may comprise a plurality of computing devices, such as 2410, 2420, 2430 that are connected via a Network 2450. Devices 2410, 2420, 2430 may be interconnected to one another, either by common access to a server (e.g., Server 2430) or directly, such as through using a network switch, a hub, or the like.

In some exemplary embodiments, Network 2450 may be an intranet network of an organization. Network 2450 may be connected to an external network, such as the Internet (not shown). In some cases, Network 2450 is connected to the external network by a router, switch, server or the like, which may or may not be configured to provide some security measures to prevent malicious activity. In one embodiment, the switch comprises a firewall that prevents access of undesired entities.

Computers 2410, such as a laptop computer, a tablet computer, a smartphone, or the like, may be devices that are connected to Network 2450 temporarily. For example, Computer 2410 may be a BYOD device of an employee and connected to Network 2450 at the beginning of the work day and removed therefrom at the end of the workday. Additionally, or alternatively, Computer 2410 may be a computer owned by the organization and intended to be used in the organization and outside of the organization, such as in the field.

Computers 2420 may be stationary and generally statically and permanently connected to Network 2450. For example, Computer 2420 may be a desktop workstation located within the premises of the organization and not intended to being disconnected and used elsewhere.

Server 2430 may be a computerized server tasked with monitoring and protecting the security of Network 2450. In some exemplary embodiments, IT professional may define an organizational policy, such as defining a whitelist of authorized programs, authorized uses of programs, a blacklist of unauthorized programs, or the like. Additionally, or alternatively, the policy may be automatically defined. Sever 2430 may publish and distribute the policy to computers connected to Network 2450. Additionally, or alternatively, Server 2430 may publish and update an encryption key to be used for security-related operation. The encryption key may be modified periodically, such as every about one second, about one minute, about one hour, or the like.

In some exemplary embodiments, computers connected to Network 2450 may be configured to communicate using scrambled ports. Authorized outgoing communications, such as packets issued by authorized programs or under authorized conditions, may be handled and their port may be scrambled, such as using a transformation function. The transformation function may utilize shared parameters such as the whitelist, encryption key, or the like, so as to achieve the same results on different computers. As the encryption key may change periodically, the transformation function may yield different results for the same port at different times. The ports of unauthorized communications may not be scrambled, and they may be transmitted via the original port. Additionally, or alternatively, the content of the packets may be encrypted. In some exemplary embodiments, computers connected to Network 2450 may be configured to descramble the ports of any incoming communication, using an inverse function of the transformation function. Hence, the ports of authorized communications may be scrambled at transmission and descrambled at reception, yielding the original port, while the ports of unauthorized communications are only descrambled at receptions, and therefore received at a wrong port on the receiving end. In some exemplary embodiments, scrambling and descrambling may be performed by a port scrambling agent, which may be implemented in software, hardware, combination thereof, or the like.

In some exemplary embodiments, communications in an organization's network may go through a firewall. The firewall may not be configured to handle port scrambling/descrambling. In such case, the port scrambling agent may determine that the packet is directly transmitted to a firewall and avoid port scrambling of such packet. Additionally, or alternatively, a receiving device receiving a packet directly from a firewall, may avoid performing port descrambling on the received packet.

In some exemplary embodiments, the port scrambling agent may be configured to avoid scrambling when transmitting packets towards specific devices, such as sending packets towards an Voice Over IP (VoIP) telephone, a printer, a network-connected time clock, or other devices which utilize the network connection but for which an agent is not installed. Additionally, or alternatively, the port scrambling agent may be configured to avoid descrambling ports of packets received from such devices.

Additionally, or alternatively, as such simple devices may not be configured to execute an agent (e.g., as they may not support execution of third-party programs, may not include an Operating System, or the like), a hardware agent may be connected to the device via wired connection. The hardware agent may process incoming sent to the device and outgoing messages sent from the device and provide the port scrambling and descrambling capabilities. The hardware agent may process incoming messages, descramble the ports and transmit the modified communication, with the descrambled port, to the device. Additionally, or alternatively, communications transmitted by the device may be processed by the hardware agent and their ports may be selectively scrambled, if they match the organizational policy.

However, Computer 2410 may be removed from Network 2450 and connected to other networks, such as Network 2460 of FIG. 24B, where Devices 2470 are connected. As an example, Network 2460 may be a public Wi-Fi network, a home LAN network, a wired LAN network at a hotel or conference center, or the like. As Device 2470 may not utilize port scrambling agents, if Computer 2410 would scramble the ports of incoming and outgoing communications, Computer 2410 may not be able to communicate with the devices connected to Network 2460. In addition, as Computer 2410 may not have access to Server 2430 and may not be able to receive the periodically modifiable encryption key, while being connected to Network 2460 and disconnected from Network 2450.

In some exemplary embodiments, the port scrambling agent of Computer 2410 may detect that Computer 2410 is not connected to Network 2450, such as for example, based on detection of lack of connectivity to Server 2430, and change its operation mode. Instead of scrambling ports of all authorized outgoing messages and descrambling ports of all incoming messages, the port scrambling agent may scramble the ports of unauthorized outgoing communications only. The port scrambling agent may rely on the fact that other devices do not descramble ports of incoming messages, and hence outgoing communications whose ports are scrambled may be received at unintended ports and disregarded by the receiving end.

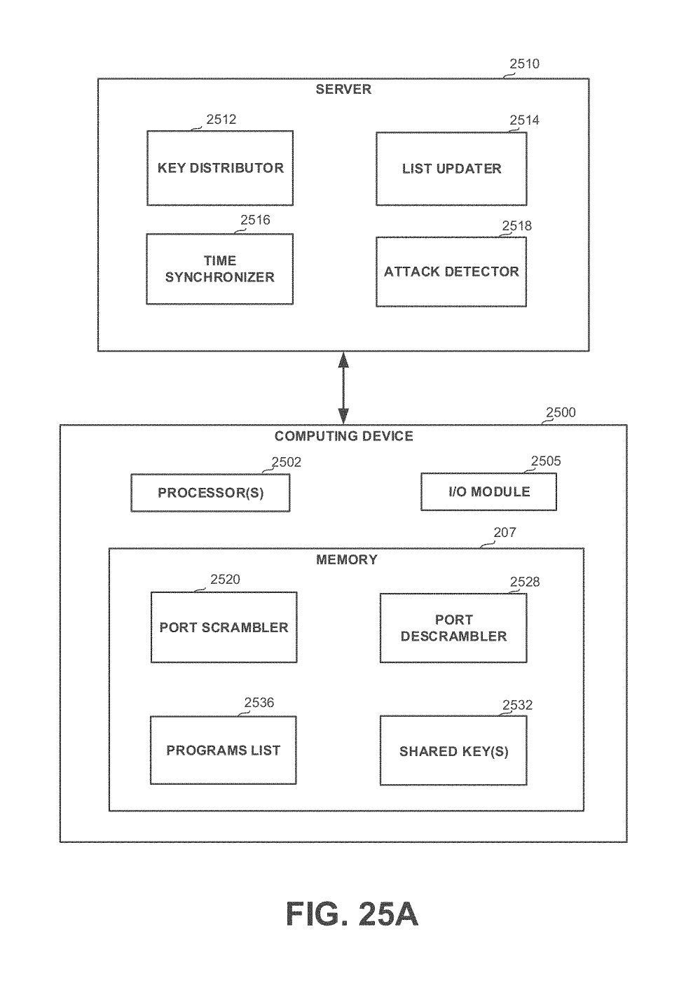

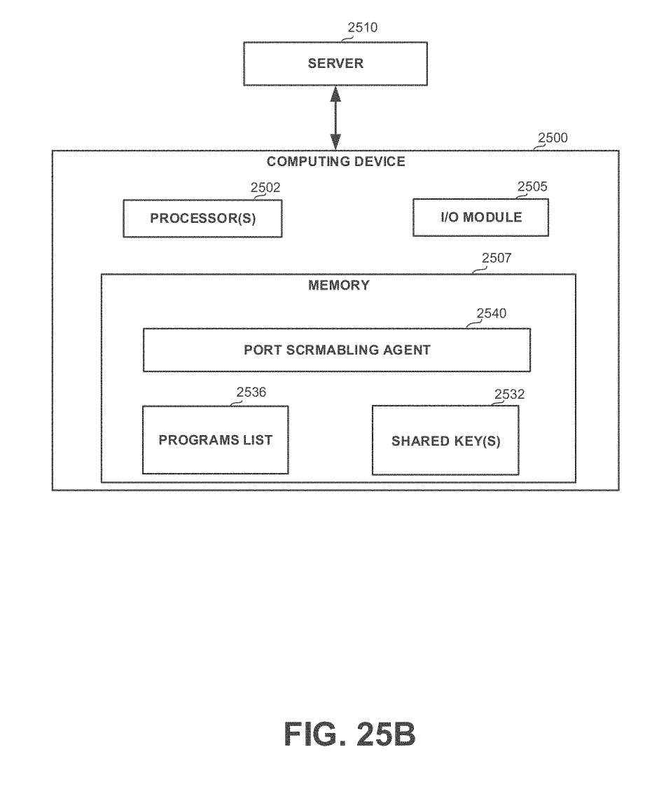

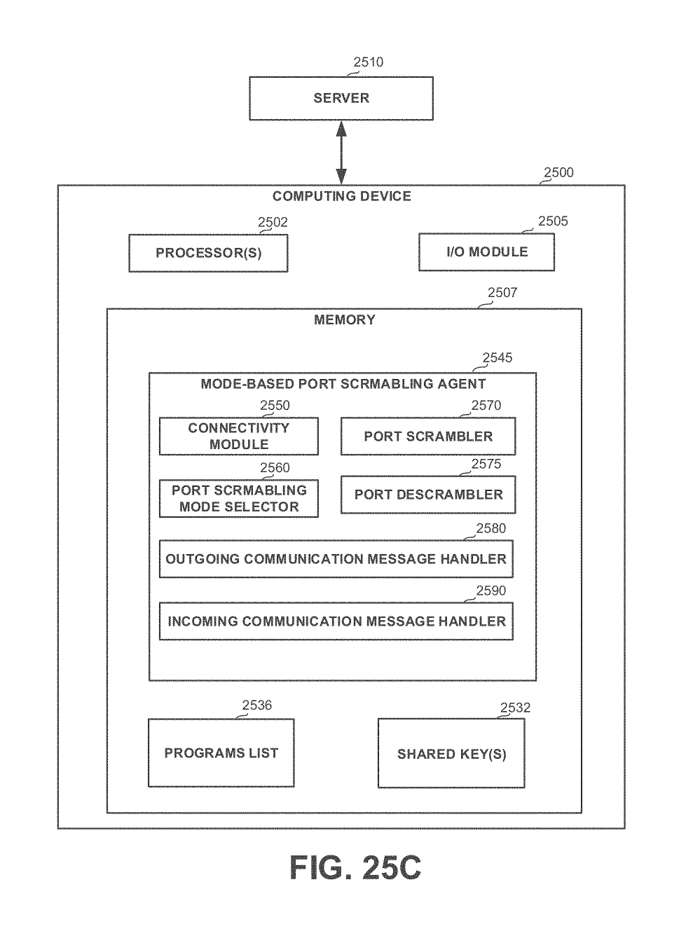

Referring now to FIG. 25A showing a block diagram of a system in accordance with some exemplary embodiments of the disclosed subject matter. The system comprises a Computing Device 2500, such as 2410, 2420 of FIG. 24A, and may be configured to perform selective port scrambling, in accordance with the disclosed subject matter. In some exemplary embodiments, the system further comprises a Server 2510, such as Server 2430 of FIG. 24A, which may be in communication with Computing Device 2500 via any suitable communication channel, such as an Ethernet switch connection or the like.

In some exemplary embodiments, Computing Device 2500 may comprise one or more Processor(s) 2502. Processor 2502 may be a Central Processing Unit (CPU), a microprocessor, an electronic circuit, an Integrated Circuit (IC) or the like. Processor 2502 may be utilized to perform computations required by Computing Device 2500 or any of its subcomponents.

In some exemplary embodiments of the disclosed subject matter, Computing Device 2500 may comprise an I/O Module 2505. The I/O Module 2505 may be utilized to provide an output to and receive input from a user. Additionally, or Alternatively, I/O Module 2505 may be utilized to provide output to and receive input from Server 2510 or another Computing Device 2500 in communication therewith, such as another one of Devices 2410, 2420 of FIG. 24A.

In some exemplary embodiments, Computing Device 2500 may comprise a Memory 2507. Memory 2507 may be a hard disk drive, a Flash disk, a Random-Access Memory (RAM), a memory chip, or the like. In some exemplary embodiments,

Memory 2507 may retain program code operative to cause Processor 2502 to perform acts associated with any of the subcomponents of Computing Device 2500.

Memory 2507 may comprise one or more components as detailed below, implemented as executables, libraries, static libraries, functions, or any other executable components.

Memory 2507 may comprise Port Scrambler 2520 which may comprise or be in communication with a Programs List 2536 and one or more Shared Key(s) 2532. Port Scrambler 2520 may be configured to selectively apply a port scrambling function on port numbers associated with outgoing communications. Port Scrambler 2520 may apply the port scrambling function responsive to receiving a request to transmit an outgoing communication from an application program listed on Programs List 2536 (and executed by Computing Device 2500). Port Scrambler 2520 may use Shared Key(s) 2532 as a parameter of the port scrambling function. Port Scrambler 2520 may obtain a scrambled port number by applying the port scrambling function on the port number identifying the destination of the outgoing communication. Port Scrambler 2520 may direct the outgoing communication to a destination identified by the scrambled port number.

Memory 2507 may comprise Port Descrambler 2528 which may comprise or be in communication with Shared Key(s) 2532. Port Descrambler 2528 may be configured to apply a port descrambling function on port numbers associated with incoming communications to Computing Device 2500. The port descrambling function may be an inverse function of the port scrambling function applied by Port Scrambler 2520. Port Descrambler 2528 may use Shared Key(s) 2532 as a parameter of the port descrambling function. Port Descrambler 2528 may receive an incoming communication at a port identified by a scrambled port number. Port Descrambler 2528 may obtain a descrambled port number (e.g., original port number) by applying the port descrambling function on the scrambled port number. In some exemplary embodiments, Port Descrambler 2528 may perform the descrambling on all incoming communications regardless of their origin. Port Descrambler 2528 may redirect the incoming communication to a port identified by the descrambled port number. Port Descrambler 2528 may issue a notification to Server 2510 in case that the descrambled port number is not assigned to any application program currently executing on Computing Device 2500.

Similarly to Computing Device 2500, Server 2510 may comprise Processor(s) (not shown), I/O Module (not shown) and Memory (not shown).

Server 2510 may comprise a Key Distributor 2512 for generating and distributing Shared Key(s) 2532 among a plurality of computing devices, such as Computing Device 2500, in a computer network environment such as Computer Environment 2400 of FIG. 24A. Key Distributor 2512 may distribute Shared Key 2532 to Computing Device 2500 using Public Key Infrastructure (PKI) cryptography. Shared Key 2532 may comprise a fixed encryption key. Additionally or alternatively,

Shared Key 2532 may comprise a time-dependent encryption key, replaced periodically and valid for a limited time duration. In some exemplary embodiments, Shard Key(s) 2532 may comprise three keys: a time dependent key that is updated periodically, a fixed key that uniquely identifies the organization in which the system of FIG. 25 is deployed, and a key which depends on Programs List 2536, such as a hashing of Programs List 2536.

Server 2510 may comprise a List Updater 2514 for maintaining and updating Programs List 2536 among the plurality of computing devices in the network environment. List Updater 2514 may provide credentials enabling verification of the content of Programs List 2536 by Computing Device 2500, for example by applying a hash function on Programs List 2536 and digitally signing the result. The credentials may also be used for the scrambling or descrambling process, as one of the Shared Key(s) 2532, that is distributed by Key Distributor 2512.

Server 2510 may comprise a Time Synchronizer 2516 for synchronizing system clocks among the plurality of computing devices in the network environment, in case that one or more of the Shared Key(s) 2532 distributed by Key Distributor 2512 are time-dependent.

Server 2510 may comprise an Attack Detector 2518, configured for tracking and analyzing traffic in the computer network environment in order to detect possible security attacks and outbreaks. Attack Detector 2518 may receive and analyze notifications from Computing Device 2500 concerning incoming communications for which the descrambled port number is not assigned to an application program.

In some exemplary embodiments, Key Distributor 2512, List Updater 2514, Time Synchronizer 2516 and Attack Detector 2518 may be deployed on one or more separate servers. In one embodiment, each of the above is deployed on a stand-alone and separate server.

In some exemplary embodiments, Server 2510 may monitor communication in the network, identify transmission to invalid ports, analyze such transmission to detect potential malicious activity and mitigate risk from such activities. In some exemplary embodiments, the disclosed subject matter may utilize a server such as disclosed in U.S. Pat. No. 9,794,277, entitled “MONITORING TRAFFIC IN A COMPUTER NETWORK”, filed Dec. 27, 2016, which is hereby incorporated by reference in its entirety for all purposes without giving rise to disavowment.

FIG. 25B shows a block diagram of a system in accordance with some exemplary embodiments of the disclosed subject matter. Computing Device 2500 may be a device that is intended to continuously and permanently be connected to Network 2450, such as devices that are intended to remain in the premises of the organization. It is noted that the device may be removed from the premises from time to time, such as for technical support, upgrading, or the like. However, the device may not be intended to be taken as is and used in other networks, such as may be the case in BYOD devices, laptops, or the like.

Port Scrambling Agent 2540 may be configured to scramble and descramble ports of incoming and outgoing communications, in accordance with the disclosed subject matter, such as using Port Scrambler 2520 and Port Descrambler 2528 of FIG. 25A.

FIG. 25C exemplifies a Computing Device 2500 which is intended to be used in other networks as well as the organizational network, Network 2450. For example, Computing Device 2500 of FIG. 25C may be Computer 2410 which may at times be connected to the organizational network (e.g. 2450 of FIG. 24A) and at other times connected to other networks (e.g. 2460 of FIG. 24B).

Mode-Based Port Scrambling Agent 2545 may be configured to provide the functionality of Port Scrambling Agent 2540 in one mode of operation and other functionalities in other modes of operation.

In some exemplary embodiments, Connectivity Module 2550 may be configured to determine connectivity of Computing Device 2500 to the network where port scrambling is implemented (e.g., 2450 of FIG. 24A). In some exemplary embodiments, connectivity may be determined based on connectivity to the Server 2510. For example, if Server 2510, which is configured to distribute the keys (e.g., Key Distributor 2512) is not reachable, Computing Device 2500 may determine that it does not operate within the organizational network, and that other devices in the network do not descramble ports of incoming communications and do not scramble ports of authorized communications.

Port Scrambling Mode Selector 2560 may be configured to select port scrambling mode based on the connectivity determined by Connectivity Module 2550. In case the Computing Device 2500 is connected to the network, a first mode, also referred to as authorized scrambling mode, is selected. Otherwise, a second mode, also referred to as prohibited scrambling mode, is selected.

In some exemplary embodiments, under the authorized scrambling mode, ports of all incoming communications are descrambled and ports of authorized communications are descrambled. Under such mode, it may be assumed that other devices utilize the same mode, or that they employ a port scrambling agent that only operates in the authorized scrambling mode, such as Port Scrambling Agent 2540 of FIG. 25B.

In some exemplary embodiments, under the prohibited scrambling mode, ports of incoming communications may not be modified and incoming messages may be handled via their original ports. Additionally, or alternatively, outgoing communications may be scrambled only if they are determined to be prohibited.

Authorized communications, such as communications adhering to the defined policy, communications issued by authorized programs (e.g., listed in the whitelist or not listed in the blacklist), may be transmitted without port manipulation. Ports of outgoing unauthorized communications may be scrambled to ensure that they are not received at their intended port on the receiving end.

Port Scrambler 2570 may be configured to scramble ports, such as using a transformation function. Port Descrambler 2575 may be configured to descramble ports, such as using an inverse transformation of the transformation function. Port Scrambler 2570 and Port Descrambler 2575 may be similar to 2520 and 2528, respectively.

In some exemplary embodiments, Outgoing Communication Message Handler 2580 may be configured to invoke Port Scrambler 2570 when scrambling of the ports of outgoing messages is desired. In some exemplary embodiments, in the authorized scrambling mode, Outgoing Communication Message Handler 2580 may be configured to invoke Port Scrambler 2570 only for outgoing communications that are deemed authorized. Additionally, or alternatively, in the prohibited scrambling mode, Outgoing Communication Message Handler 2580 may be configured to invoke Port Scrambler 2570 only for outgoing communications that are deemed unauthorized.

In some exemplary embodiments, Incoming Communication Message Handler 2590 may be configured to invoke Port Descrambler 2575 when descrambling of the ports of incoming messages is desired. In some exemplary embodiments, in the authorized scrambling mode, Incoming Communication Message Handler 2590 may be configured to invoke Port Descrambler 2575 for all incoming communications received by Computing Device 2500. Additionally, or alternatively, in the prohibited scrambling mode, Incoming Communication Message Handler 2590 may be configured to avoid invoking Port Descrambler 2575, and allow all incoming messages to be handled via their designated, original, port.

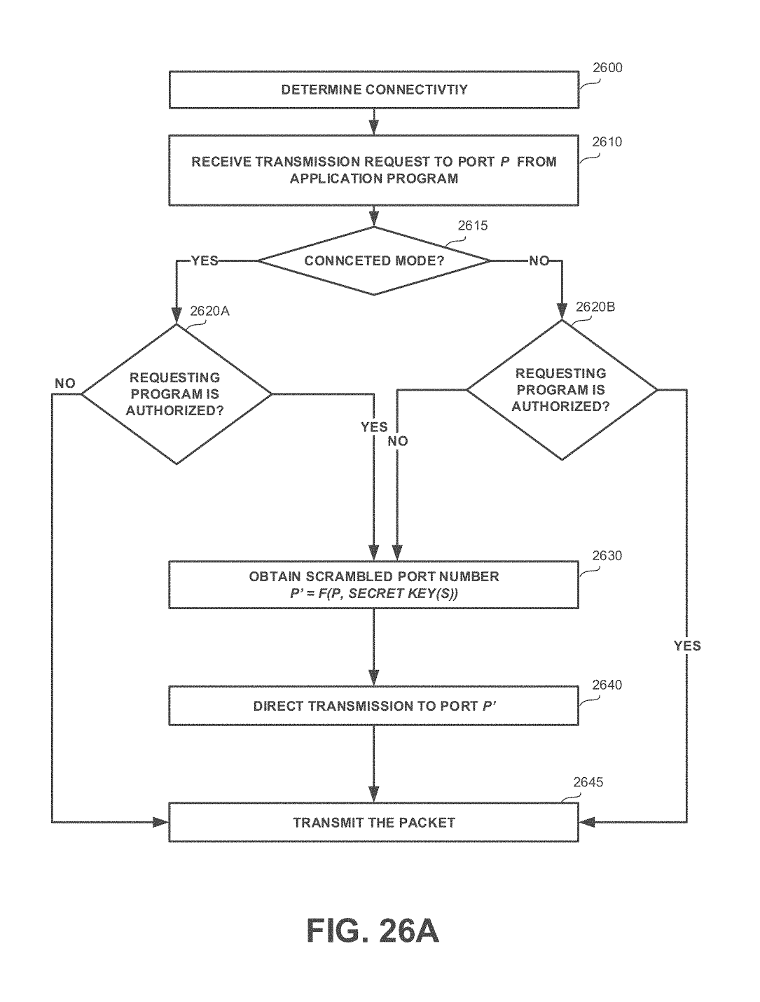

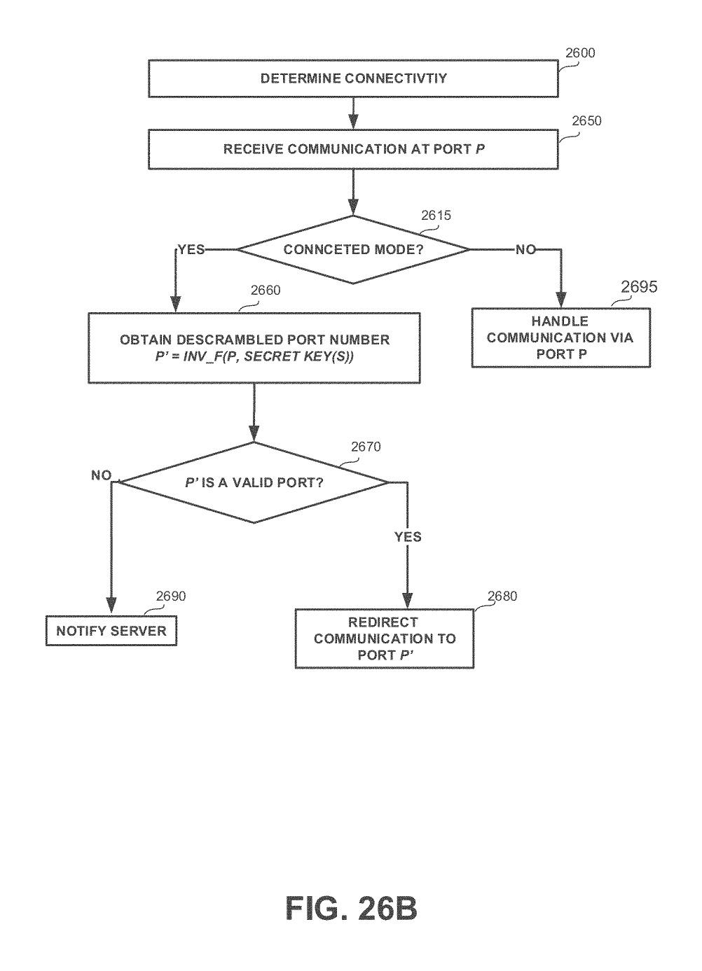

Referring now to FIG. 26A showing a flowchart diagram of a method in accordance with some exemplary embodiments of the disclosed subject matter.

On Step 2600, connectivity to the protected network may be determined. In some exemplary embodiments, connectivity may be determined based on whether the device is connected directly to the network, connected to a router, hub, or a similar networking device, of the network, or the like. Additionally, or alternatively, connectivity may be determined based on whether the device is connectable to a server distributing the shared encryption keys used by the port scrambling agents, such as 2430 of FIG. 24A.

On Step 2610, a request of an application program to transmit an outgoing communication may be received. The application program may be executed by a computerized apparatus, such as Computing Device 2500 of FIGS. 25A-25C. The outgoing communication may be designated to be received at a destination via a first port (denoted “P”). The destination may be a destination external to the computerized apparatus, e.g. another Computing Device 2500. As an example, the destination of a UDP packet may be provided as an IP address and a port (e.g., 192.168.1.52:80).

On Step 2615, a mode of operation may be determined based on the connectivity determination (2600). In case the device is connected to a protected network, Step 2620A may be performed. If the device is not connected to a protected network, Step 2620B may be performed.

On Step 2620A, a determination whether the requesting application program is authorized may be made. The determination may be accomplished by consulting a list of authorized programs, such as Programs List 2536 of FIG. 25A, by consulting a blacklist of unauthorized programs, or the like. In some exemplary embodiments, non-authorized programs may still operate in the computing device, however, in view of the disclosed subject matter, such programs may not be able to effectively communicate with other devices on the same network. Additionally, or alternatively, the determination may be whether the outgoing communication is authorized, such as based on the identity of the transmitting program, a chain of invocations, such as disclosed in U.S. patent application Ser. No. 15/464,4026, entitled PREVENTING UNAUTHORIZED OUTGOING COMMUNICATIONS, filed on Mar. 31, 2017, which is hereby incorporated by reference in its entirety without giving rise to disavowment, based on matching a template defining authorized structure and content of packets, or the like.

On Step 2630, a transformation function may be applied on an identifier of the first port to obtain an identifier of a second port. The transformation function may depend on at least one secret parameter shared among a plurality of computing devices in a computer network, such as Shared Key 2532 of FIG. 25A. The identifier of the first port may be obtainable by applying an inverse transformation on the identifier of the second port. The inverse transformation may depend on the at least one secret parameter, such that only devices sharing the at least one secret parameter may be able to apply the inverse transformation. The transformation function may be either a symmetric cryptography function, such as DES, AES, or the like, or an asymmetric cryptography function, such as RSA, El-Gammal, or the like.

In some exemplary embodiments, the scrambled port number may not be a port number which has a general known functionality, such as port numbers known as “common port numbers” which are published by the Internet Assigned Number Authority (IANA) or the like. As an example, the scrambled port may not be port 20-21 (used for FTP), port 22 (used for SSH), port 53 (used for DNS), port 80 (used for HTTP), port 443 (used for HTTPS) or the like. On Step 2630, in case the transformation function provides an excluded port, a next non-excluded port may be selected. Additionally, or alternatively, a list of excluded ports may include common port numbers or other port numbers which are constantly excluded. The list may also include port numbers which were used as scrambled ports in a previous time segment. For example, in case port 80 was scrambled to port 1579 during a first time segment, in a next time segment, when port 80 is scrambled to a different port number, all other ports may be excluded from being scrambled to port 1579 so as to avoid collision and confusion. In such an embodiment, a packet that is destined to port 1579 and is received in the second segment may be uniquely identified as a packet that was transmitted during the first time segment towards port 80.

On Step 2640, the outgoing communication may be directed to be transmitted via the second port. In the above given example in which the original address is 192.168.1.52:80 and in which port 80 is scrambled to port 1579, the outgoing communication may be transmitted to 192.168.1.52:1579.

On Step 2645, the outgoing communication may be transmitted, either via the original port P or the scrambled port P′, depending on whether the port was scrambled or not.

On Step 2620B, a determination whether the requesting application program is authorized may be made, similarly to determination made in Step 2620A. However, only if the communication is not deemed authorized, e.g., transmitted by an unauthorized program, the port is scrambled (2630) and the communication is transmitted via the scrambled port (2640-2645). Otherwise, in case the communication is deemed authorized (e.g., transmitted by a whitelisted program, not transmitted by a blacklisted program, adhering to predetermined rules regarding chain of program invocations, adhering to predetermined rules regarding packet content and structure, or the like), the packet is transmitted as is without modifying the port (2645).

In some exemplary embodiments, a content of the at least one secret parameter may be updated in each of the plurality of computing devices in the network. As a result, operation of the transformation function may be dynamically and automatically modified for all computing devices in the network. In particular, a subsequent request to transmit an outgoing communication to be received via the first port, may result in the application of the transformation function on Step 2630 yielding an identifier of a third port different from the second port. In some exemplary embodiments, the transformation function is modified without a user providing a modified definition thereof.

Referring now to FIG. 26B showing a flowchart diagram of a method in accordance with some exemplary embodiments of the disclosed subject matter.

On Step 2650, an incoming communication via a first port of a computerized apparatus, such as Computing Device 2500 of FIGS. 25A-25C, may be received. The incoming communication may be received from an external device via a computer network, such as Network 2450.

On Step 2615, based on the connectivity, a mode of operation may be determined. In case of a connected mode, Steps 2660-2690 may be performed. In such steps, the port of the incoming message may be descrambled, and the communication may be handled based on the validity of the descrambled port. In case the device is not connected to a protected network, Step 2695 may be performed. In such step, the message is handled as is without descrambling its port.

On Step 2660, an identifier of a second port may be obtained by applying an inverse transformation function on an identifier of the first port. The inverse transformation function may depend on at least one secret parameter shared among a plurality of computing devices in the computer network, such as Shared Key 2532 of FIG. 25A.

On Step 2670, a determination whether the second port is a valid port may be made. A valid port may be any port that is used by any of the programs in a list of authorized programs, such as Programs List 2536 of FIG. 25A. Additionally, or alternatively, a valid port may be any common port. Additionally, or alternatively, a valid port may be any port that is used by a program that is executed by the computerized apparatus.

On Step 2680, in case that the second port was determined to be a valid port on Step 2670, the incoming communication may be redirected to the second port. In some exemplary embodiments, subsequently, the incoming communication is received by a program and handled appropriately.

On Step 2690, in case that the second port was determined as not being a valid port on Step 2670, a corresponding notification may be issued to an entity in charge of tracking and analyzing network traffic for detecting attacks, such as Attack Detector 2518 at Server 2510 of FIG. 25. Additionally, or alternatively, the received communication may be dropped and disregarded.

In some exemplary embodiments, in the authorized scrambling mode, a communication issued by an application that is not part of the list of authorized programs, such as Programs List 2536 of FIG. 25A, is not scrambled as described in FIG. 26A and thus is not received and handled by the desired final destination at the receiving device, as depicted in FIG. 26B. As a result, any non-authorized program that is executed by a device on the network is unable to effectively communicate with other devices.

In some exemplary embodiments, in the authorized scrambling mode, an unauthorized application is incapable of effectively accessing an external network to report to a malicious user. In order to communicate with a device in the external network, the device first needs to communicate with a router, bridge, switch or a similar device referred to as a router, which connects the network to the external network. Such communication may also be performed based on scrambled ports. As a result, and as the communication initiated by the unauthorized application is not scrambled, the router dismisses the communication and does not act upon it.

On Step 2695, the received communication may be handled via its original port, P. The port may not be descrambled, and the original port may be used as the receiving port through which the communication message is processed.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer program product comprising a non-transitory computer readable medium retaining program instructions, wherein said computer program product comprising:
a connectivity module configured to determine connectivity of a computer executing the computer program product to a network managed by a server;
a port scrambling mode selector configured to select a port scrambling mode based on connectivity determination by said connectivity module, wherein a first mode is selected in response being connected to the network, wherein a second mode is selected in response to being disconnected from the network;
a port scrambler configured to compute a second port based on a first port, wherein the port scrambler utilizes a transformation function;
an outgoing communication message handler configured to identify an outgoing packet transmitted by a program via the first port and selectively invoke said port scrambler to cause the outgoing packet to be transmitted via the second port,
wherein in the first mode, said outgoing communication message handler is configured to invoke said port scrambler in response to the program being listed in a list of authorized programs, whereby, when the computer is connected to the network, outgoing communications issued by authorized programs are sent via scrambled ports and outgoing communications issued by non-authorized programs are sent via original ports; and
wherein in the second mode, said outgoing communication message handler is configured to invoke said port scrambler in response to the program not being listed in the list of authorized programs, whereby, when the computer is not connected to the network, outgoing communications issued by authorized programs are sent via original ports and outgoing communications issued by non-authorized programs are sent via scrambled ports.

2. The computer program product of claim 1, wherein the network comprises a plurality of computers, wherein each of the plurality of computer retains a shared secret parameter that is used by the transformation function in the first mode, wherein each of the plurality of computers is configured to apply an inverse of the transformation function on the second port and using the shared secret parameter, to obtain the first port.

3. The computer program product of claim 1, wherein the network comprises a plurality of computers, wherein the plurality of computers comprise a first portion and a second portion, wherein the first portion is configured to permanently operate in the first mode, wherein the second portion is configured to operate in the first mode in response to detecting connectivity to the network.

4. The computer program product of claim 1, wherein the list of authorized programs is received from the server.

5. The computer program product of claim 1, wherein the network is an organizational network, wherein the list of authorized programs is an implementation of organizational policy, whereby enforcing the organizational policy when the computer is connected to the organizational network in a first manner and enforcing the organizational policy when the computer is connected to another network in a second manner.

6. The computer program product of claim 1, wherein the computer is a mobile computer configured to be alternately utilized within an organizational network and within a home network, wherein the network is the organizational network, wherein said port scrambling mode selector is configured to select the first mode when the computer is connected to the organizational network, wherein said port scrambling mode selector is configured to select the second mode when the computer is connected to the home network.

7. The computer program product of claim 1, wherein said port scrambler is configured to apply the transformation function using an encryption key distributed by the server, wherein the encryption key is modified periodically and distributed to devices connected to the network, whereby port scrambling in the first mode is performed using an up-to-date encryption key, whereby port scrambling in the second mode is performed using a potentially out-of-date encryption key.

8. The computer program product of claim 1, wherein the server is configured to maintain the list and update computers connected to the network.

9. The computer program product of claim 1, further comprising:
a port descrambler configured to compute a fourth port based on a third port, wherein the port descrambling module utilizes an inverse transformation of the transformation function;
an incoming communication message handler configured to identify an incoming packet received via the third port,
wherein in the first mode, said incoming communication message handler is configured to invoke said port descrambler to cause the incoming packet to be handled through the third port, whereby, when the computer is connected to the network, incoming communications are received via descrambled ports; and
wherein in the second mode, said incoming communication message handler is configured to avoid invoking said port descrambler, whereby, when the computer is not connected to the network, incoming communications are received via their original ports.

10. A computer program product comprising a non-transitory computer readable medium retaining program instructions, wherein said computer program product comprising:
a connectivity module configured to determine connectivity of a computer executing the computer program product to a network managed by a server;
a port scrambling mode selector configured to select a port scrambling mode based on connectivity determination by said connectivity module, wherein a first mode is selected in response being connected to the network, wherein a second mode is selected in response to being disconnected from the network;
a port descrambler configured to compute a first port based on a second port, wherein the port descrambler utilizes an inverse transformation of a transformation function, wherein the transformation function is utilized by port scramblers invoked on computers connected to the network;
an incoming communication message handler configured to identify an incoming packet received via the second port and selectively invoke said port descrambler, based on the port scrambling mode determined by said port scrambling mode selector, to cause the incoming packet to be handled via the first port,
wherein said incoming communication message handler is configured to invoke said port descrambler in the first mode, whereby, when the computer is connected to the network, incoming communications are handled via descrambled ports; and
wherein said incoming communication message handler is configured to avoid invocation of said port descrambler in the second mode, whereby, when the computer is disconnected from the network, incoming communications are handler via original ports.

11. The computer program product of claim 10, wherein a plurality of computers that are connected to the network are configured to scramble ports of authorized communication packets and avoid scrambling ports of unauthorized communication packets, wherein the plurality of computers are configured to scramble ports using the transformation function.

12. The computer program product of claim 11, wherein the plurality of computers are configured to scramble the ports using the transformation function and based on a list of authorized programs, wherein said port descrambler is configured to utilize the list of authorized program when applying the inverse transformation.

13. The computer program product of claim 11, wherein the plurality of computers are configured to scramble the ports using the transformation function, based on a list of authorized programs and based on a shared encryption key that is modified periodically, wherein the computer is configured to retrieve the shared encryption key from the network when connected thereto.

14. The computer program product of claim 13, wherein the server is configured to distribute the shared encryption key to devices connected to the network.

15. A system comprising:
a server managing a network;
a plurality of devices that are connected to the network, wherein each of the plurality of devices comprise a port scrambling agent, wherein the port scrambling agent is configured to scramble ports of outgoing communications that are transmitted by authorized programs, wherein the port scrambling agent is configured to descramble ports of incoming communications;
a computer that is selectively connectable to the network;
wherein the computer comprising a mode-based port scrambling agent, wherein the mode-based port scrambling agent is configured to determine a port scrambling mode based on connectivity to the network, wherein said mode-based port scrambling agent is configured to determine a first mode when the computer is connected to the network, wherein said mode-based port scrambling agent is configured to determine a second mode when the computer is disconnected from the network;
wherein in the first mode, the mode-based port scrambling agent is configured to:
scramble ports of outgoing communications that are transmitted by authorized programs,
allow transmission of outgoing communications by unauthorized programs via original ports, and
descramble ports of incoming communications; and
wherein in the second mode, the mode-based port scrambling agent is configured to:
scramble ports of outgoing communications that are transmitted by unauthorized programs;
allow transmission of outgoing communications by authorized programs via original ports; and
avoid descrambling ports of incoming communications.

16. The system of claim 15, wherein said mode-based port scrambling agent is configured to determine network connectivity based on connectivity to the server.

17. The system of claim 15, wherein the server is configured to periodically distribute a shared encryption key to devices connected to the network, wherein said port scrambling agents and mode-based port scrambling agent are configured to utilize the shared encryption key in performing scrambling or descrambling of ports, whereby the mode-based port scrambling agent may not have available thereto an up-to-date shared encryption key when disconnected from the network.

18. The system of claim 15, wherein the server is configured to distribute a list of authorized programs, whereby organization policy of authorized programs is enforced on mobile devices that are operated when connected to other networks.

19. The system of claim 18, wherein said port scrambling agents and mode-based port scrambling agent are configured to utilize the list of authorized programs when scrambling or descrambling ports.
